(19) United States
(12) Patent Application Publication
(10) Pub. No.: US 2023/0405654 A1
(43) Pub. Date: Dec. 21, 2023

(54) METHOD FOR ENZYMATIC AND/OR MICROBIAL PROCESSING OF WASTE COMPRISING RECIRCULATION OF PROCESS WATER

(71) Applicant: Renescience A/S, Fredericia (DK)

(72) Inventors: Peter FRISTRUP, Fredericia (DK); Ilya MAKAROV, Fredericia (DK); Steen Gustav STAHLHUT, Fredericia (DK); Jorge Enrique Gonzalez LONDONO, Fredericia (DK)

(73) Assignee: Renescience A/S, Fredericia (DK)

(21) Appl. No.: 18/035,246

(22) PCT Filed: Nov. 1, 2021
(86) PCT No.: PCT/EP2021/080236

§ 371 Date: May 3, 2023

(30) Foreign Application Priority Data
Nov. 4, 2020 (EP) 20205654.5
Nov. 16, 2020 (EP) 20207700.4

(51) Int. Cl. B09B 3/65

(52) U.S. Cl. CPC B09B 3/65; B09B 2101/25

(57) ABSTRACT

The present invention relates to a method for continuous or batch processing of waste, such as municipal solid waste, subject to enzymatic and/or microbial degradation in a bioreactor resulting in a bioliquid and a solid fraction, which method comprises recirculation of process water obtained from downstream processing of said bioliquid and/or solid fraction. Water from external sources may also be added to the reactor in addition to the recirculation of process water.

### FIELD

The present invention relates to a method for continuous or batch processing of waste in a bioreactor resulting in a bioliquid, which method comprises recirculation of process water obtained from the downstream processing of said bioliquid. The waste can for instance be sorted or unsorted municipal solid waste (MSW) subject to enzymatic and/or microbial degradation in a continuous or batch bioreactor. The process water can for example be bioliquid, reject water obtained from an anaerobic digestion (AD) process, evaporation from digestate or wash water and any combinations thereof. Water from external sources may also be added to the reactor in addition to the recirculation of any process water.

### BACKGROUND

There is a great interest to employ methods in which the energy stored within waste comprising organic material is utilized to the fullest. Agricultural material/waste, household waste and municipal waste are examples of sources containing a high content of dry matter and a certain content of organic material, where it is of high interest to utilize the stored energy within the organic material instead of just disposing the waste. Considerable interest has arisen in development of efficient and environmentally friendly methods of processing solid waste, to maximize recovery of their inherent energy potential and, also, recovery of recyclable materials. One significant challenge in “waste to energy” processing has been the heterogeneous nature of waste, such as MSW.

The commonly used methods for treatment and subsequent disposal of waste such as household, agricultural or municipal waste include among others incineration, landfill, burning, dumping and composting, where the method of choice often depends on e.g. the content of organic material compared to the content of nonorganic material. However, these methods do not directly provide an optimum utilization of the energy stored within the organic material.

Pre-sorting may sometimes be provided by the consumers or by the waste station and this reduces the pollution released by e.g. incineration and simplifies the degradation of the organic waste into valuable end-products. However, pre-sorting may not be efficient in separating all non-biodegradable material such as metal and glass from the organic waste.

In methods, such as the one described below, wherein the organic contents of the waste are liquefied while maintaining the non-organic contents in their solid phase, and afterwards separate the solid and the liquid phases, pre-sorting may simplify the process but is not a necessity.

An environmentally friendly waste processing method is a biologically based method, such as the method currently applied by Renescience, wherein waste comprising organic matter, such as ordinary unsorted or sorted/partially sorted household waste, is mixed with water, enzymes and optionally microorganisms in order to dissolve all organic waste such as food waste, cardboard, paper, labels and similar, and turn it into a bio-liquid that can be used for production of for example biogas via an anaerobic digestion process. The liquefaction process wherein the waste is subjected to enzymatic and/or microbial treatment requires water in order to provide a bioliquid that can be used for further processing as an energy source. Moreover, the subsequent processing steps of the bioliquid and/or the solid fractions may also require addition of water depending on the features of the specific process.

The method according to the present invention is based on the method currently applied by Renescience and is suitable for processes wherein waste comprising organic matter has been subject to enzymatic degradation and/or microbial fermentation producing a bioliquid and various solid fractions. Examples of such waste treatment processes are disclosed in WO2006056838, WO2007036795, WO2011032557, WO2013185778, WO2014198274, WO2016030480, WO2016030472, WO2016050893, WO2017/174093, which is hereby expressly incorporated by reference in entirety.

Enzymatic treatment offers unique advantages over “autoclave” methods for liquefaction of degradable organic components. Using enzymatic liquefaction, processing of waste, such as MSW, can be conducted in a continuous manner, using comparatively cheap equipment and non-pressurized reactions run at comparatively low temperatures. In the context of the present invention liquefaction includes “to make fluid” and “to dissolve into water”.

Enzymatic liquefaction may sometimes require thermal pre-treatment to a comparatively high temperature of 120° C. or higher, in part to affect a “sterilization” of waste such as unsorted MSW and also so that degradable organic components can be softened and paper products “pulped.” However, high temperature pre-treatment can be actively detrimental, since this kills ambient microorganisms which are thriving in the waste. Thus, in a preferred embodiment the waste is not pre-treated at high temperature i.e. above 90° C. In one preferred embodiment the waste is mixed with pre-heated water to a temperature in the range of 60° C. to 75° C., preferably 70° C. or preferably around 70° C. This water is preferably fully supplied by re-circulated process water, such as water from dewatering the digestate i.e. reject water. Alternatively, or in addition the process water recirculated is clean condensate water.

In addition to improving “organic capture” from enzymatic treatment, concurrent microbial fermentation using any combination of lactic acid bacteria, or acetate-, ethanol-, formate-, butyrate-, lactate-, pentanoate- or hexanoate- producing microorganisms, “pre-conditions” the bioliquid so as to render it more efficient as a substrate for further processing, such as biomethane production. Microbial fermentation produces bioliquid having a generally increased percentage of dissolved compared with suspended solids, relative to bioliquid produced by enzymatic liquefaction alone. Higher chain polysaccharides are generally more thoroughly degraded due to microbial “pre-conditioning”. Concurrent microbial fermentation and enzymatic treatment degrades biopolymers into readily usable substrates and, further, achieves metabolic conversion of primary substrates to short chain carboxylic acids such as glucose, xylose, arabinose, lactate, acetate and/or ethanol. The conversion of the organic matter in the waste according to a process of the invention normally at least include lactic acid producing bacteria. The resulting bioliquid comprising a high percentage of sugars and other soluble degradation products provides a biomethane substrate, a substrate suitable for anaerobic digestion for the production of biogas. A bioliquid comprising a higher amount of acids will contribute to a faster anaerobic degradation process.

Anaerobic digestion is a series of biological processes in which microorganisms break down biodegradable material in the absence of oxygen. One of the end products is biogas, which can be combusted to generate electricity and heat, or can be processed into renewable natural gas and transportation fuels. A range of anaerobic digestion technologies exists in the state of the art for converting waste, such as municipal solid waste, municipal wastewater solids, food waste, high strength industrial wastewater and residuals, fats, oils and grease (FOG), and various other organic waste streams into biogas. Many different anaerobic digester systems are commercially available, and the skilled person will be familiar with how to apply and optimize the anaerobic digestions process. The metabolic dynamics of microbial communities engaged in anaerobic digestion are complex. In typical anaerobic digestion (AD) for production of methane biogas, biological processes mediated by microorganisms achieve four primary steps—hydrolysis of biological macromolecules into constituent monomers or other metabolites; acidogenesis, whereby short chain hydrocarbon acids and alcohols are produced; acetogenesis, whereby available nutrients are catabolized to acetic acid, hydrogen and carbon dioxide; and methanogenesis, whereby acetic acid and hydrogen are catabolized by specialized archaea to methane and carbon dioxide. Apart from the production of valuable output, AD also produces a digestate, sometimes called “raw effluent” or “AD effluent”. These terms can be used interchangeably and refers to the waste product from anaerobic digestion. The digestate comprises both solids and liquids and these fractions may be used for various purposes. In a preferred embodiment the liquid digestate may be hygienized e.g. by heating to 60 to 75° C., preferably 65° C. to 70° C. or above 70° C. for 60-80 minutes, preferably 60-70 minutes, preferably about 60 minutes e.g. to prevent pathogenic microbes to pass on from the AD digestion. Solid-liquid separations can for instance be done by decantation, centrifugation and/or sedimentation. In a preferred embodiment the liquid digestate, which may be hygienized as described above, is dewatered e.g. through a decanter centrifuge, which produce reject water, which is re-circulated into the process according to the invention. In case the of a hygienization of liquid digestate the reject water resulting from a solid-liquid separation of the digestate will be about 70° C. and could be used in the pre-treatment of the waste as described above. Usually, the liquid digestate has alkaline pH, and comprises mainly water, but also dry suspended solids and dissolved matter such as salts. “Process water” is defined as the liquid fraction obtained after one or more solid-liquid separations in a process downstream of the enzymatic and/or microbial treatment of waste, such as water resulting from dewatering of digestate from an AD process, which is also defined as “reject water”. Thus, process water comprises reject water. Process water may comprise various salts, dissolved matter and live microorganisms. Preferably the process water is reject water obtained from an anaerobic digestion (AD) process, evaporation from digestate or wash water.

Recirculation of process water in waste treatment processes as such have been applied in various treatment process.

EP3415472B1 discloses anaerobic digestion of organic matter wherein the digestion effluent from the digester is separated into a fiber fraction and a liquid fraction, and wherein each fraction may be recirculated into the digester.

WO 2020/03194 A1 discloses recirculation of digestate flow wherein pH and electric conductivity is controlled by an algorithm in order to maintain pH at 5.2-5.7 in the digester.

U.S. Pat. No. 10,118,851B2 discloses anaerobic digestion of biologic waste matter. In a first step, waste is mixed with liquid and is subjected to AD. In the second step, the digestate is dewatered by pressing followed by another separation step and finally recirculation of the separated liquid effluent into the first AD step.

WO2015/004146 discloses an anaerobic digestion process wherein the effluent may be recirculated.

The above documents relate to recirculation of water from AD processes. None of the documents describe methods wherein recirculation of process water, which is water originating from an enzymatic waste treatment process, such as an reject water obtained from anaerobic digestion, relates to recirculation of the process water back into a previous step wherein the previous step is subjecting waste, such as MSW to enzymatic and/or microbial treatment in a bioreactor.

The present invention relates to a method wherein process water from an enzymatic and/or microbial liquefaction processing of waste followed by subsequent downstream processing of the bioliquid is recirculated into the bioreactor. The process water can be recirculated into the bioreactor optionally without any hygienization. In the present method, the amount of water from external sources such as tap water and water from natural sources needed in the liquefaction process of waste comprising organic matter can be reduced meaning the spared tap water is available for other purposes in nature and in society.

### SUMMARY OF THE INVENTION

The present invention is a method for continuous or batch processing of waste in a bioreactor, wherein process water from one or more downstream processes is recirculated into the bioreactor. The advantages of recirculating water include but is not limited to distribution of enzymes into the MSW, mechanical flushing of organics into bioliquid, dissolvement of organics dried onto surfaces, salt dilution and/or transfer of organics and salts out of the waste undergoing treatment in the bioreactor.

The process water is obtained from one or more downstream process steps. For instance, the process water can be bioliquid collected directly from the enzymatic and/or microbial liquefaction process or the process water can be obtained from other downstream processes such as from an anaerobic digestion (AD) process, washing steps of solid waste or process water obtained by evaporation derived from various downstream processes. The downstream processes may be utilising the bioliquid produced in said bioreactor for biogas production or for other energy derivable products. In one embodiment, the process water is reject water obtained from an anaerobic digestion (AD) process, evaporation from digestate or wash water. Water from external sources may also be added to the reactor in addition to the recirculation of any process water.

The method of the invention is a method for continuous or batch processing of waste comprising:
a) subjecting waste to an enzymatic and/or microbial treatment in a bioreactor
b) subjecting the treated waste from step a) to one or more separation step(s), whereby a bioliquid and a solid fraction is provided;
c) subjecting said bioliquid and/or solid fraction to downstream processing providing process water;
d) adding the process water obtained from step c) and optionally water from an external water source to the bioreactor in step a).

For a liquefaction process that runs continuously at a pH that meets the optimal enzymatic and microbial conditions, the pH is normally around between pH 2-6.5 in the bioreactor. It has been found here that recirculation of the process water obtained from step c) or a fraction thereof meets these requirements in general but that the best conditions seem to be met if the pH of the process water to be recirculated into the reactor is of a similar pH, preferably a between pH 3.5 to 6. The pH of the process water will depend on the process it is derived from. Thus, in some embodiments it is preferred to adjust the pH to between 3.5 and 6 before recirculating the process water into the bioreactor. For example, if the process water is reject water obtained from an anaerobic digestion process it will normally have a pH around 8 to 9. If basic reject water from an AD process is to be recirculated into the bioreactor, it is preferred that pH of the reject water is adjusted to a pH between 3.5 to 6.0 prior to being recirculated, to ensure that the pH of the liquefaction process in the bioreactor is remains at an optimum level below 6.5, preferably below 5.5. Alternatively, repetitive pH adjustments in the bioreactor after steady state conditions have been established is preferred, or if no adjustment of the pH of the process water e.g. reject water prior to adding it into the bioreactor is made the process water may be added in batches or on continuously to the bioreactor. In one embodiment of the invention the process water is added to step a) in batches, such that pH in the reactor is between pH 3.5-6.

In some embodiment the process water may have to undergo hygienization at 70° C. for 60 minutes. The process water added to the process of the invention will then be 60-70° C. and could be used directly in pre-treating the waste as described above.

The waste can be any kind of waste comprising at least some organic matter and can be sorted or unsorted. Waste such as municipal solid waste is particularly useful because it comprises both organic matter and live microorganisms that may contribute to the combined enzymatic and microbial degradation. Water from external sources may optionally be added to the bioreactor in addition to the process water. Water from external sources may be water obtained from natural sources such as rivers, lakes and ponds; water reservoirs; tap water; and any combination thereof. Means that further stimulate the enzymatic and microbial degradation of waste may be added. Such means include enzyme compositions; feed for the microorganisms such as carbohydrates; addition of microorganisms such as lactic acid producing bacteria; temperature regulations; mixing or rotation devices.

The method according to the present invention can be performed within a single waste processing plant comprising one or more bioreactors and/or one or more downstream process reactors, such as AD digesters that are part of the same waste treatment loop; or the process water may be obtained from one or more different and possibly independent enzymatic and/or microbial waste processing and/or biogas production sites.

It is shown herein that process water can be recirculated from downstream processes into the bioreactor while keeping the bioliquid production process in the bioreactor in a steady state wherein both the enzymatic and microbial processes are active and the retention time and accordingly cost are optimized. Preferably the process water has a pH between 3.5 and 6 when being recirculated into the bioreactor to avoid a delaying impact on the enzymatic and/or microbial liquefaction process in the bioreactor. The examples disclosed herein shows that both the enzymatic activity and the activity of the microorganisms producing the valuable organic acids in the bioliquid required as feed to the AD biogas production is upheld at a continuous rate in the bioreactor when process water such as reject water is added to the bioreactor. Whereas the pH optimum of enzymatic compositions that are added to the waste are known beforehand, the pH optimum for the enzymes derived from the natural microbial flora of the waste is unknown. Also, whereas the pH optimum of the microbial blends being added to the waste is known beforehand, the identity of the natural occurring microorganisms in the microbial flora of the waste and thus the pH optimum of these organisms are unknown and will vary depending on the natural microbial flora of the waste being processed.

### BRIEF DESCRIPTION OF FIGURES

FIG. 1: 1a is a schematic drawing of steps in a waste treatment process and recirculation of process water comprising step a), b), c) and d) according to the invention. 1b is a schematic drawing of an example of a downstream process.

FIG. 2: Graph showing pH as a function of fermentation time.

FIG. 3: Graph showing pH as a function of fermentation time, reject water added with or without pH adjustment.

FIG. 4: Graph showing pH as a function of fermentation time, sequential removal of material from the fermenter followed by addition of reject water.

FIG. 5: Graph showing pH as a function of fermentation time, addition of reject water. FIG. 6: Bar chart showing the proportion of lactic acid producing bacteria of the total amount of bacteria during fermentation with addition of reject water.

FIGS. 7a to 7d: Pie charts showing the proportion of the most dominant species of lactic acid producing bacteria of the total amount of bacteria during fermentation with addition of reject water.

FIGS. 8a to 8d: Pie charts showing the proportion of specific species of lactic acid producing bacteria during fermentation with addition of reject water.

FIG. 9: Bar chart showing the proportion of archaea of the total amount of bacteria during fermentation with addition of reject water.

FIG. 10: Methane yield as a function of time.

FIG. 11: pH profile the fermentation of MSW model substrate in a fermenter with the addition of NH₄HCO₃ and ammonia.

FIG. 12. Distribution of the lactic acid bacteria and other bacterial species over the course of the fermentation of MSW model substrate in a rotating horizontal reactor with addition of reject water and glucose.

### DEFINITIONS

As used herein, the following terms have the following meaning:

“About” as used herein, usually with reference to a quantitative number or range, may refer to +/−1, 2, 5 or even 10% in relative terms of the number or range referred to. In the context of the present invention, the terms “about”, “around”, “approximately” or the symbol “˜” can be used interchangeably and are meant to comprise variations generally accepted in the field, e.g. comprising analytical errors and the like.

The term “comprising” is to be interpreted as specifying the presence of the stated parts, steps, features, components, or the like, but does not exclude the presence of one or more additional parts, steps, features, components etc. For example, a composition comprising a chemical compound may thus comprise additional chemical compounds.

It can differ in one or more atoms, functional groups, or substructures, which are replaced with other atoms, groups, or substructures. A structural analogue can be imagined to be formed, at least theoretically, from the other compound.

“Batch” refers to any defined amount of waste delivered from a specified geographic area to the waste plant. The amount of waste in a “batch” and the size of the geographic area will vary from plant to plant and depend of the specific renovation-collecting system and the specific size of the plant, such as a large scale plant. Each batch may be treated separately in each of step a), b) and c) of the present method or several batches may be treated continuously or at least having overlapping retention times at one or more step(s). Typically, a batch will be the amount of waste loaded into the waste plant by a single truck which usually comprises between 15-20 m3 waste disposal per load. Several batches from trucks may be collected, stored and entered into the treatment plant as one large batch. In such circumstances, the batch will usually comprise between 40-6000 m3 waste.

“Batch process” The treatment can be carried out as a batch process or series of batch processes. The treatment can be carried out as a fed batch or continuous process, or series of fed batch or continuous processes, where the municipal solid waste material is fed gradually to, for example, a treatment solution containing an enzyme composition. The treatment may be a “continuous process” in which an MSW material and an enzyme composition are added at different intervals throughout the treatment and the hydrolysate is removed at different intervals throughout the treatment. The removal of the hydrolysate may occur prior to, simultaneously with, or after the addition of the cellulosic material and the cellulolytic enzymes composition.

“Bioreactor” refers to any manufactured or engineered device or system that supports a biologically active environment. A bioreactor may be a vessel in which a chemical process is carried out which involves organisms or biochemically active substances derived from such organisms. This process can either be aerobic or anaerobic. These bioreactors may be cylindrical or not, ranging in size from liters to cubic meters, and are often made of stainless steel. For the purpose of the present invention, “bioreactor” comprises any facility, container or environment providing the appropriate conditions to perform the present invention.

“Bioliquid” is the liquefied and/or saccharified degradable components obtained by enzymatic treatment of waste comprising organic matter. Bioliquid also refers to the liquid fraction obtained by enzymatic and/or microbial treatment of waste comprising organic matter once separated from non-fermentable solids. Bioliquid comprises water and organic substrates such as protein, fat, galactose, mannose, glucose, xylose, arabinose, lactate, acetate, ethanol and/or other components, depending on the composition of the waste (the components such as protein and fat can be in a soluble and/or insoluble form). Bioliquid comprises also fibers, ashes and inert impurities. The resulting bioliquid comprising a high percentage of solubles, provides a substrate for gas production, a substrate suitable for anaerobic digestion e.g. for the production of biogas.

“Cellulolytic background composition (CBC) or Cellulolytic Enzyme Blend” means an enzyme composition comprising a mixture of two or more cellulolytic enzymes. The CBC may comprise two or more cellulolytic enzymes selected from: i) an Aspergillus fumigatus cellobiohydrolase I; (ii) an Aspergillus fumigatus cellobiohydrolase II; (iii) an Aspergillus fumigatus beta-glucosidase or variant thereof; and (iv) a Penicillium sp. GH61 polypeptide having cellulolytic enhancing activity; or homologs thereof. The CBC may further comprise one or more enzymes selected from: (a) an Aspergillus fumigatus xylanase or homolog thereof, (b) an Aspergillus fumigatus beta-xylosidase or homolog thereof; or (c) a combination of (a) and (b) (as described in further detail in WO 2013/028928). The major activities of the CBC may comprise: endo-1,4-beta-glucanases (E.C. 3.2.1.4); endo-1,4-beta-xylanases (E.C. 3.2.1.8); endo-1,4-beta-mannanase (E.C. 3.2.1.78), beta-mannosidase (E.C 3.2.1.25), whereas other enzymatic activities may also be present in the CBC such as activity from glucanases, glucosidases, cellobiohydrolase I cellobiohydrolase II; beta-glucosidase; beta-xylosidase; beta-L-arabinofuranosidase; amyloglucosidase; alpha-amylase; acetyl xylan esterase. The CBC may be any CBC described in WO 2013/028928 (the content of which is hereby incorporated by reference). The CBC may be from T. reesei. The CBC may be from Myceliophtora thermophilae. The CBC may be Cellic® CTec3 obtainable from Novozymes A/S (Bagsvaerd, Denmark). Cellulolytic enzyme activity can be determined by measuring the increase in production/release of sugars during hydrolysis of a cellulosic material by cellulolytic enzyme(s) under the following conditions: 1 -50 mg of cellulolytic enzyme protein/g of cellulose in pre-treated corn stover (PCS) (or other pre-treated cellulosic material) for 3-7 days at a suitable temperature such as 40° C.-80° C., e.g., 40° C., 45° C., 50° C., 55° C., 60° C., 65° C., 70° C., 75° C., or 80° C., and a suitable pH, such as 4-9, e.g., 4.0, 4.5, 5.0, 5.5, 6.0, 6.5, 7.0, 7.5, 8.0, 8.5, or 9.0, compared to a control treatment without addition of cellulolytic enzyme protein.

“Commercially available cellulase preparation optimized for biomass conversion” refers to a commercially available mixture of enzyme activities which is sufficient to provide enzymatic treatment of biomass such as lignocellulosic biomass and which usually comprises endocellulase (endoglucanase), exocellulase (exoglucanase), endoxylanase, acetyl xylan esterase, xylosidase and/or beta-glucosidase activities. The term “optimized for biomass conversion” refers to a product development process in which enzyme mixtures have been selected and/or modified for the specific purpose of improving yields and/or reducing enzyme consumption in treatment of biomass to fermentable sugars. A commercially available cellulase preparation optimized for biomass conversion can be used, such as one that is e.g. provided by GENENCOR™ (now DuPont), DSM or NOVOZYMES™. Usually, such compositions comprise cellulase(s) and/or hemicellulase(s), such as one or more of exoglucanases, endoglucanases, endoxylanases, xylosidases, acetyl xylan esterases and beta-glucosidases, including any combination thereof. Such enzymes can e.g. be isolated from fermentations of genetically modified Trichoderma reesei, such as, for example, the commercial cellulase preparation sold under the trademark ACCELLERASE TRIO™ from DuPont (and/or GENENCOR). A commercially available cellulase preparation optimized for biomass conversion that can be used is provided by NOVOZYMES™ and comprises exoglucanases, endoglucanases, endoxylanases, xylosidases, acetyl xylan esterases and beta-glucosidases, such as, for example, the commercial cellulase preparations sold under either of the trademarks Cellic® CTec2 or Cellic® CTec3 from NOVOZYMES™.

The term “Cellulase(s)” is meant to comprise one or more enzymes capable of degrading cellulose and/or related compounds. Cellulase is any of several enzymes commonly produced by fungi, bacteria, and protozoans that catalyse cellulolysis, the decomposition of cellulose and/or related polysaccharides. Cellulase can also be used for any mixture or complex of various such enzymes, that act serially or synergistically to decompose cellulosic material. Cellulases break down the cellulose molecule into monosaccharides (“simple sugars”) such as beta-glucose, and/or shorter polysaccharides and oligosaccharides. Specific reactions may comprise hydrolysis of the 1,4-beta-D-glycosidic linkages in cellulose, hemicellulose, lichenin, and cereal beta-D-glucans. Several different kinds of cellulases are known, which differ structurally and mechanistically. Synonyms, derivatives, and/or specific enzymes associated with the name “cellulase” comprise endo-1,4-beta-D-glucanase (beta-1,4-glucanase, beta-1,4-endoglucan hydrolase, endoglucanase D, 1,4-(1,3,1,4)-beta-D-glucan 4-glucanohydrolase), carboxymethyl cellulase (CMCase), avicelase, celludextrinase, cellulase A, cellulosin AP, alkali cellulase, cellulase A 3, 9.5 cellulase, and pancellase SS.

Cellulases can also be classified based on the type of reaction catalysed, where endocellulases (EC 3.2.1.4) randomly cleave internal bonds at amorphous sites that create new chain ends, exocellulases or cellobiohydrolases (EC 3.2.1.91) cleave two to four units from the ends of the exposed chains produced by endocellulase, resulting in tetra-, tri-or disaccharides, such as cellobiose. Exocellulases are further classified into type I—that work processively from the reducing end of the cellulose chain, and type II—that work processively from the nonreducing end. Cellobiases (EC 3.2.1.21) or beta-glucosidases hydrolyse the exocellulase product into individual monosaccharides. Oxidative cellulases depolymerize cellulose by radical reactions, as for instance cellobiose dehydrogenase (acceptor). Cellulose phosphorylases depolymerize cellulose using phosphates instead of water.

Chemical oxygen demand (COD) is an indicative measure of the amount of oxygen that can be consumed by reactions in a measured solution. It is commonly expressed in mass of oxygen consumed over volume of solution which in SI units is milligrams per litre (mg/L). A COD test can be used to easily quantify the amount of organics in water. The most common application of COD is in quantifying the amount of oxidizable pollutants found in surface water (e.g. lakes and rivers) or wastewater. COD is useful in terms of water quality by providing a metric to determine the effect an effluent will have on the receiving body, much like biochemical oxygen demand (BOD).

The term “Hemicellulase(s)” is meant to comprise one or more enzymes capable and/or contributing to breaking down hemicellulose, one of the major components of plant cell walls. Some of the main polysaccharides that constitute hemicellulose are believed to be xylan, arabinoxylan, xyloglucan, glucuronoxylan and glucomannan. In the context of the present invention, the term “hemicellulase(s)” is meant to comprise: xylanase(s), xylosidase(s), arabinoxylanase(s), xyloglucanase(s), glucoronoxylanase(s), glucomannanase(s), and/or esterase(s), including any combination thereof.

The term “Xylanase(s)” is meant to comprise one or more enzymes capable of degrading xylan and/or related compounds. Xylanase is any of several enzymes produced e.g. by microorganisms such as yeast that catalyse decomposition of xylan and/or related polysaccharides. Xylanase can also be used for any mixture or complex of various such enzymes that act serially or synergistically to decompose xylanosic material. Synonyms, derivatives, and specific enzymes associated with the name “xylanase” may comprise EC 3.2.1.8, endo-(1->4)-beta-xylan 4-xylanohydrolase, endo-1,4-xylanase, endo-1,4-beta-xylanase, beta-1,4-xylanase, endo-1,4-beta-D-xylanase, 1,4-beta-xylan xylanohydrolase, beta-xylanase, beta-1,4-xylan xylanohydrolase, beta-D-xylanase and/or xylosidase capable of degrading xylan, such as beta-1,4-xylan into xylose, thus contributing to breaking down hemicellulose, one of the major components of plant cell walls.

“Xylosidase” as used herein is intended to comprise the enzyme xylan 1,4-beta-xylosidase (E.C. 3.2.1.37) which is also named xylobiase, beta-xylosidase, exo-1,4-beta-D-xylosidase or 4-beta-D-xylan xylohydrolase. This enzyme catalyses the hydrolysis of (1-4)-beta-D-xylans removing successive D-xylose residues from the non-reducing termini of the substrate, e.g. hemicellulose and the disaccharide xylobiose. One unit of beta-xylosidase is defined as 1.0 μmole of p-nitrophenolate anion produced per minute at 40° C., pH 5 from 1 mM p-nitrophenyl-beta-D-xyloside in 100 mM sodium citrate containing 0.01% TWEEN® 20.

The term “Arabinoxylanase(s)” is meant to comprise one or more enzymes capable of degrading arabinoxylan and/or related compounds, comprising e.g. glucuronoarabinoxylan endo-1,4-beta-xylanase (EC 3.2.1.136), feraxan endoxylanase, feraxanase, endoarabinoxylanase, glucuronoxylan xylohydrolase, glucuronoxylanase, glucuronoxylan xylanohydrolase, glucuronoarabinoxylan 1,4-beta-D-xylanohydrolase), and glucuronoarabinoxylan 4-beta-D-xylanohydrolase. Glucurono-arabinoxylan 4-beta-D-xylanohydrolase is believed to endohydrolyse (1->4)-beta-D-xylosyl links in some glucuronoarabinoxylans. It also believed that this enzyme possesses a high activity towards feruloylated arabinoxylans. (Nishitani, K .; Nevins, D. J. (1988). “Enzymic analysis of feruloylated arabinoxylans (Feraxan) derived from Zea mays cell walls. I. Purification of novel enzymes capable of dissociating Feraxan fragments from Zea mays coleoptile cell wall”. Plant Physiol. 87: 883-890.)

The term “Xyloglucanase(s)” is meant to comprise one or more enzymes capable of degrading xyloglucan and/or related compounds, comprising e.g. xyloglucan-specific endo-beta-1,4-glucanase (EC 3.2.1.151), which is an enzyme that is believed to catalyse the chemical reaction: xyloglucan+H₂O→xyloglucan oligosaccharides. This enzyme belongs to the family of hydrolases, specifically those glycosidases that hydrolyse O- and S-glycosyl compounds. The systematic name of this enzyme class is [(1->6)-alpha-D-xylo]-(1->4)-beta-D-glucan glucanohydrolase. Other names in common use may include XEG, xyloglucan endo-beta-1,4-glucanase, xyloglucanase, xyloglucanendohydrolase, XH, and 1,4-beta-D-glucan glucanohydrolase.

The term “Glucuronoxylanase(s)” is meant to comprise one or more enzymes capable of degrading glucuronoxylan and/or related compounds.

The term “Glucomannanase(s)” is meant to comprise one or more enzymes capable of degrading glucomannanase and/or related compounds.

The term “Esterase(s)” is meant to comprise one or more enzymes capable of splitting an ester in an acid and an alcohol. Examples of esterases comprise acetylesterases and feroyl esterase.

The term “Acetylesterase(s)” is meant to comprise an enzyme capable of splitting off acetyl groups. An acetylesterase (EC 3.1.1.6) is an enzyme that catalyses the chemical reaction: acetic ester+H₂O→alcohol+acetate. This enzyme belongs to the family of hydrolases, specifically those acting on carboxylic ester bonds. The systematic name of this enzyme class is acetic-ester acetylhydrolase. Other names in common use include C-esterase (in animal tissues), acetic ester hydrolase, chloroesterase, p-nitrophenyl acetate esterase, and Citrus acetylesterase.

The terms “Feroyl esterase(s)” and “Feruloyl esterase(s)” can be used interchangeably, and is/are meant to comprise an enzyme that catalyses the chemical reaction feruloyl-(poly-, oligo-, or mono-) polysaccharide+H₂O→ferulic acid+(poly-, oligo-, or mono-)saccharide. Feroyl esterase belongs to the family of hydrolases, specifically those acting on carboxylic ester bonds. The systematic name of this enzyme class is feruloyl esterase (EC 3.1.1.73); other names may include ferulic acid esterase (FAE), hydroxycinnamoyl esterase, hemicellulase accessory enzyme, and cinnamoyl ester hydrolase (cinnAE).

Suitable enzymes, such as cellulases, hemicellulase(s) including xylanases, and or esterases, can be expressed in suitable hosts using methods known in the art. Such enzymes are also commercially available, either in pure form or in enzyme cocktails. Specific enzyme activities can be purified from commercially available enzyme cocktails, again using methods known in the art—see e.g. Sørensen et al. (2005) “Efficiencies of designed enzyme combinations in releasing arabinose and xylose from wheat arabinoxylan in an industrial fermentation residue” (Enzyme and Microbial Technology 36 (2005) 773-784), where a Trichoderma reesei beta-xylosidase is purified from Celluclast (Finizym), and further commercial enzyme preparations are disclosed.

Conducting a treatment/process “at” a dry matter level refers to the dry matter content of the feedstock at the start of said treatment, unless indicated otherwise. Likewise, conducting a treatment/process “at” a pH refers to the pH of the aqueous content of the biomass at the start of said treatment, unless indicated otherwise.

In the context of the present invention, the term “pH- and/or temperature-adjusted” is meant to comprise pH and/or temperature adjustments in order to allow an enzymatic treatment and/or fermentation to take place under suitable pH and/or temperature conditions.

“Dry matter” also appearing as “DM”, refers to total solids, both soluble and insoluble, and effectively means “non-water content.” Dry matter content is measured by drying at between 40 and 120° C., preferably between 50 and 105° C., until constant weight is achieved.

“Pre-treatment” commonly refers to the use of water, either as hot liquid, vapour steam or pressurized steam comprising high temperature liquid or steam or both, to “cook” biomass, at temperatures of 120° C. or higher, either with or without addition of acids or other chemicals. In the context of the present invention, “hydrothermal pre-treatment” is meant to comprise methods, unit operations and/or processes relating to softening lignocellulosic biomass by the use of temperature and water, and usually, also, pressure, aiming at providing a pre-treated biomass suitable for enzymatic digestion. Pre-treatment in context of the present invention may be the step of mixing the waste with about 70° C.water (preferably recirculated) prior to (alternatively subsequent or simultaneously with) liquefaction of the waste with enzymes and/or microorganisms.

“Solid/liquid separation” refers to an active mechanical process, and/or unit operation(s), whereby liquid is separated from solid by application of some force through e.g. pressing, centrifugation, sedimentation, decanting or the like. Commonly, a solid/liquid (s/l) separation provides a liquid and solid fraction.

In the context of the present invention, unless indicated otherwise, “%” indicates % weight/weight (w/w).

An “effective amount” of one or more isolated enzyme preparations is an amount where collectively the enzyme preparation used achieves sufficient solubilization of waste to provide a solution comprising a high percentage of sugars and other soluble degradation products, a substrate suitable for anaerobic digestion e.g. for the production of biogas. The effective amount can be determined by use of a solubilization test as described herein.

“Solubilization test” is a test applied in order to find out how much of a given enzymatic composition should be added to the waste for sufficient enzymatic treatment. A solubilization test of the selected enzyme composition on MSW model substrate can be applied to identify an optimum enzymatic solubilization process. The solubilization of the waste, such as municipal solid waste, can be determined by applying the below testing method:

### Solubilization Laboratory Test I

A model substrate consisting of 41% mixed food waste of vegetable origin, 13% mixed food waste of animal origin and 46% mixed cellulosic waste is shredded, mixed and milled several times until homogeneous, passed through a 3 mm screen, divided into smaller portions and stored frozen at≤−18° C.

A set of pre-tared 50 mL centrifuge tubes, each containing 1.500±0.010 g TS (Total Solids at 60° C.) of the above-mentioned model substrate in a 50 mM Sodium acetate buffer pH 4.50±0.05, are added various amounts of the enzyme to test (typically 5-60 mg EP/g TS of model substrate) for a final total weight of 20.000±0.025 g in each tube. The tubes are closed with tight fitting lids and the reaction mixtures are incubated at 50±1° C.for 24 hours±10 minutes with agitation by inverting the test tubes (end-over-end) at 10.0±0.5 revolutions per minute.

Immediately after finished incubation the tubes are centrifuged at 2100±10 G for 10 minutes, and immediately after centrifugation (and within less than 5 minutes) the supernatant is decanted into another set of pre-tared tubes. The first set of tubes (including lids), with the residual undissolved model substrate, and the second set of tubes, with the decanted supernatant containing the solubilized model substrate, are weighed on a 4 decimal analytical balance and then left to dry at 60±1° C.for 6 days in a well-ventilated drying cabinet.

After drying the tubes (including lids) are weighed again, the TS amounts in pellet and supernatant are determined and the mass balance is calculated as:

Mass balance %=((TS pellet+TS supernatant−TS Enzyme)/TS model substrate)*100%

The mass balance based on TS model substrate (1.500±0.010 g), to assure for no loss of material and proper drying, will typically be in the interval of 95-105%.

Based on the Total amount and TS amount of the decanted supernatant, TS % in the decanted supernatant is calculated as:

TS %=(TS decanted supernatant/Total decanted supernatant)*100%

Finally, the solubilization is calculated as:

Solubilization %=(((TS %*Residual water/(1−TS %))−TS Enzyme)/TS model substrate)*100%

By calculating solubilization based on TS % of the decanted supernatant and the Residual water amount (weight of decanted supernatant and residual wet pellet subtracted weight of the empty tubes and TS of model substrate), the liquid phase that is trapped in the centrifugation pellet will also be accounted for.

A graph of solubilization versus enzyme dose will show the characteristics of enzyme efficacy (maximum solubilization at high enzyme dosages) and enzyme potency (dose required for obtaining a certain level of solubilization).
Enzyme efficacy may typically be 35-70% solubilization, depending on the model substrate composition and the enzyme composition to test. Dose in use may typically be defined to obtain 85-95% of the efficacy.

The current invention appears well suited for industrial applications, including large-scale industrial applications. In some embodiments, methods of the invention are practiced using at least about 100, 200, 500 kg waste per hour. In some embodiments, at least 1, 5, 10, 15, 20, 25, 50, or 100 tons (t) waste can be processed per h.

In the context of the present invention, the term “anaerobic digestion” is meant to comprise biological processes in which microorganisms break down biodegradable material in the absence of oxygen. One of the end products may be biogas, which can e.g. be combusted to generate electricity and/or heat. Biogas can also be used, either directly or after upgrading, as renewable natural gas and/or transportation fuels. Biogas can be injected into a natural gas and/or biogas grid.

In the context of the present invention, the term “anaerobic digestion system” refers to a fermentation system comprising one or more digesters operated under controlled aeration conditions in which methane gas is produced in each of the reactors comprising the system. Methane gas is produced to the extent that the concentration of metabolically generated dissolved methane in the aqueous phase of the fermentation mixture within the “anaerobic digestion system” is saturated at the conditions used and methane gas is emitted from the system. The “anaerobic digestion system” may be a fixed filter system. A “fixed filter anaerobic digestion system” refers to a system in which an anaerobic digestion consortium is immobilized, optionally within a biofilm, on a physical support matrix.

The terms “fermenter” and “digester” can be used interchangeably. “Digester” is commonly used for anaerobic digestions, often in the context of biogas production.

Likewise, the terms “fermentation” and “digestion” can be used interchangeably. “Digestion” is commonly used for anaerobic digestions, often in the context of biogas production.

In the context of the present invention, the term “digestate” or “AD effluent” is defined as the residual output from an anaerobic digestion (AD) used for biogas production. Anaerobic digesters sustainably treat organic waste from municipal, industrial, and/or agricultural operations with microorganisms under anaerobic conditions for production of biogas. Usually, the “digestate” has alkaline pH, and comprises mainly water, but also suspended solids and dissolved matter such as salts which may include both inorganic salts and organic salts.

“Reject water” is defined as the liquid fraction obtained after one or more solid-liquid separations of the AD digestate and is accordingly the term applied to denote process water obtained from an AD process. The one or more solid liquid separations can comprise one or more of decantation, centrifugation, filtering, flocculation, pressing and sedimentation. Like the AD digestate, reject water has an alkaline pH, and comprises dissolved matter, such as salts which may include both inorganic salts and organic salts. Reject water may also comprise some suspended matter and live microorganisms from the AD process. Such water may be subject to hygienization and/or other purification steps in accordance with national requirements e.g. Animal Byproduct legislation (the APB) prior to being released from the AD plant.

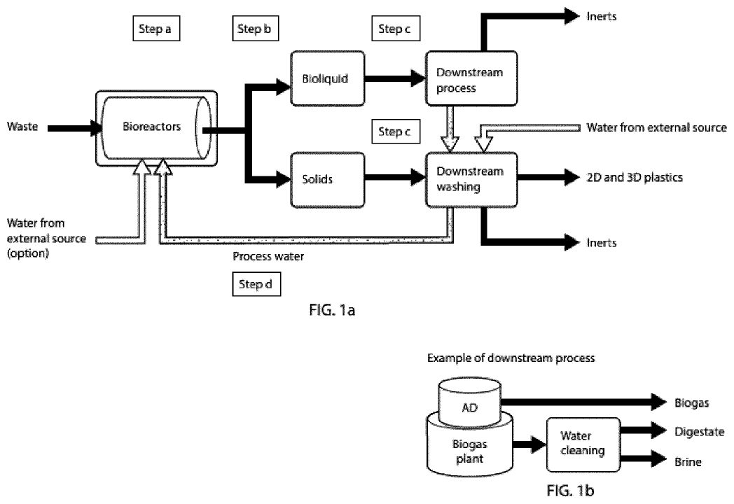

“Wash water” is defined as any water stream used for washing of any solid fraction obtained after solid-liquid separation of the bioreactor effluent. Examples of wash water are water used for washing of the 2D fraction (flat materials such as textiles, plastic film, undigested cardboard) and/or the 3D fraction (metals and solid plastic), the wash water used for washing the 2D and 3D fractions may be the reject water from dewatering the digestate, as illustrated in FIG. 1a. However, the spent wash water from the washing units may be used as process water in the bioreactors. As this water is of low pH and contain the washed-off organics and left-over enzymes, the pH adjusting acid consumption, the bioreactor process and e.g. biogas yield will benefit from the re-use of spent wash water in the bioreactors. Other examples of wash water are water used for washing of inerts, metals and/or plastics. Wash water can in one embodiment be diluted bioliquid.

“Water from external sources” includes water obtained from any source wherein said water has not previously been subjected to any steps in an enzymatic and/or microbial waste treatment process. Thus, water from external sources comprise tap water, wastewater that has not been subjected to an enzymatic and/or microbial waste treatment process, and water from natural sources.

“Water from natural sources” is water obtained from natural sources such as rivers, lakes and ponds.

“Hygienization” refers to a process that reduces certain microbial activity. Various hygienization processes applied by national or regional authorities for reducing or eliminating the microbial content in waste is for example described and compared in Liu X., Lendormi T., Lanoiselle J .-L., 2018, A review of hygienization technology of biowastes for anaerobic digestion: effect on pathogen inactivation and methane production, Chemical Engineering Transactions, 70, 529-534.

The term “pH-adjusted process water” is meant to comprise process water after a pH adjustment step, usually after addition of acid to provide a less alkaline pH.

“Process water” Process water may comprise water that is recycled from an industrial process, wherein e.g. waste undergo an enzymatic and/or microbial treatment, such as a process according to the present invention including wash water, reject water and bioliquid. Process water is of lower quality than drinking water such as in terms of e.g. any one of organic and/or inorganic salt(s), microbial organisms/plate counts, suspended solids, DM, and/or pH, including any combination thereof. Process water may be adjusted in terms of mineral/salt content, pH and the like. Process water includes bioliquid, reject water and wash water as described above. In one embodiment process water is water that is not external water, e.g. tap water.

“Tap water” is defined as any type of fresh water including municipal water, water from rainwater-collecting cisterns, water from village pumps or town pumps and water carried from streams, rivers, or lakes.

In the context of the present invention, the term “lactic acid producing bacteria” comprises both bacteria of the lactic acid bacteria order “LAB” where the currently accepted taxonomy is based on the List of Prokaryotic names with Standing in Nomenclature (LPSN)—an online database that maintains information on the naming and taxonomy of prokaryotes, following the taxonomy requirements and rulings of the International Code of Nomenclature of Bacteria. The phylogeny of the order is based on 16S rRNA-based LTP release 106 by ‘The All-Species Living Tree’ Project. In addition to bacteria belonging to the LAB order, the term “lactic acid producing bacteria” used herein also comprises bacteria that do not belong to the LAB order, but that are nevertheless capable of producing lactic acid.

“Solubles” refers to the degradation products obtained from the enzymatic and/or microbial treatment of waste, sometimes referred to as microbial metabolites. The solubles are accordingly present in the bioliquid and normally is a mixture of substrates such as protein, fat, galactose, mannose, glucose, xylose, arabinose, lactate, acetate, ethanol and/or other components, depending on the composition of the waste (the components such as protein and fat can be in a soluble and/or insoluble form). The solubles/microbial metabolites provide a substrate for gas production, a substrate suitable for anaerobic digestion e.g. for the production of biogas.

“Waste” comprises, sorted and unsorted, municipal solid waste (MSW), agriculture waste, hospital waste, industrial waste, e.g., waste fractions derived from industry such as restaurant industry, food processing industry, general industry; waste fractions from paper industry; waste fractions from recycling facilities; waste fractions from food or feed industry; waste fraction from the medicinal or pharmaceutical industry; waste fractions from hospitals and clinics, waste fractions derived from agriculture or farming related sectors; waste fractions from processing of sugar or starch rich products; contaminated or in other ways spoiled agriculture products such as grain, potatoes and beets not exploitable for food or feed purposes; or garden refuse.

“Municipal solid waste” (MSW) refers to waste fractions which are typically available in a city, but that need not come from any municipality per se, i.e., MSW refers to every solid waste from any municipality but not necessarily being the typical household waste—could be waste from airports, universities, campus, canteens, general food waste, among others. MSW may be any combination of one or more of cellulosic, plant, animal, plastic, metal, or glass waste including, but not limited to, any one or more of the following: Garbage collected in normal municipal collections systems, optionally processed in a central sorting, shredding or pulping device, such as e.g., a Dewaster® or a reCulture®; solid waste sorted from households, including both organic fractions and paper rich fractions; Generally, municipal solid waste in the Western part of the world normally comprise one or more of: animal food waste, vegetable food waste, newsprints, magazines, advertisements, books, office paper, other clean paper, paper and carton containers, other cardboard, milk cartons and alike, juice cartons and other carton with alu-foil, kitchen tissues, other dirty paper, other dirty cardboard, soft plastic, plastic bottles, other hard plastic, non-recyclable plastic, yard waste, flowers etc., animals and excrements, diapers and tampons, cotton sticks etc., other cotton etc., wood, textiles, shoes, leather, rubber etc., office articles, empty chemical bottles, plastic products, cigarette buts, other combustibles, vacuum cleaner bags, clear glass, green glass, brown glass, other glass, aluminium containers, alu-trays, alu-foil (including tealight candle foil), metal containers (-Al), metal foil (-Al), other sorts of metal, soil, rocks, stones and gravel, ceramics, cat litter, batteries (button cells, alkali, thermometers etc.), other non-combustibles and fines.

The word “Renescience” refers to a company under Ørsted, a Danish founded provider of energy solutions. Renescience applies an enzymatic and/or microbial waste processing technology for treating waste comprising organic matter and turning the liquefied organics from the waste into energy.

### DETAILED DESCRIPTION

With the present invention, it has surprisingly been found that process water such as bioliquid, wash water and reject water obtained from AD processes, can be re-used as a source of water in a bioreactor wherein waste is subject to enzymatic and/or microbial degradation. This reduces the amount of water otherwise required in the enzymatic and/or microbial degradation of the waste. It is shown herein that the process water need not necessarily be subject to hygienization prior to being added into a bioreactor. If the process water e.g. reject water has been subjected to hygienization, this water, which is about 70° C., may preferably be recycled and mixed with the waste prior to liquefaction. In order for the liquefaction process to proceed continuously in the bioreactor, it has been found that the pH in the bioreactor is preferably within pH 2 to 6.5, such as between 3.5 and 6, or between 3 and 5. The pH in the bioreactor can be monitored continuously or discontinuously. Thus, in one embodiment the pH of the reject water is adjusted to between 3.5 and 6 by addition of acid and/or by reducing the ammonium content The process water may be added together with or mixed with water from external sources such as tap water/purified water.

It is shown herein that during combined enzymatic and microbial treatment of waste with addition of tap water (pH 7) and without any regulation of the pH in the bioreactor, acidification is observed during the first 24 hours. It was found that the acidification in these experiments were mainly due to the formation of lactic acid. After about 24 hours pH was found to drop to about 4.8 and the production rate of lactic acid decreased significantly. After 48 hrs the production of lactate halted.

It was found herein that the pH in the bioreactor wherein the pH had stabilised at around 4.8 increased when reject water from an AD process was added to the bioreactor. This increase in pH had a negative impact on the enzymatic and/or microbial liquefaction of the waste and led to bioliquid with fewer organic acids and hence of a poorer quality for further processing into valuable energy sources. As also shown herein, several smaller additions of reject water, waste and enzymes was found to be a faster way to achieve the pH of around 4.8. Without being bound by a specific theory, it is believed that faster acidification was achieved by adding smaller additions of reject water and is the result of mainly two factors: 1) there is already an established lactic acid community when the reject water is added. 2) the presence of bioliquid with low pH limits the pH increase due to the addition of the reject water, which in turn allows the enzymes to function more efficiently in the conversion of the added MSW. Accordingly, in a preferred embodiment of the invention the process water is added in batches to keep pH within pH 3.5-6 if no adjustment of the pH of the process water is made prior to adding it into the bioreactor, in order to provide a continued production of solubles.

The reject water from dewatering digestate mainly comprises archaea when it is entered into the bioreactor without prior hygienization. This is not a problem for the liquefaction process if the lactic acid bacteria can outcompete the archaea population entering the bioreactor. It is shown here that when reject water is entered into the bioreactor, the lactic acid population declines but subsequently re-establishes whereas the archaea population declines steadily upon entry into the bioreactor. Thus, the use of non-hygienized process water such as reject water, comprising e.g. archaea, does not inhibit the liquefaction process.

In conclusion, the disclosed examples demonstrate that process water, such as reject water which is a waste product from anaerobic digestion comprising, inter alia, a significant amount of salts and archaea, can be used successfully instead of external water, in the enzymatic and/or microbial conversion of organic matter in waste such as carbohydrate(s) to solubles such as organic acids, e.g. lactic acid, acetic acid and succinic acid. Consequently, it is now possible to conduct an enzymatic and/or microbial treatment of waste on a commercial scale, where a significant fraction of the water is recycled, thus reducing the overall water consumption of the process.

The method of the invention is a method for continuous or batch processing of waste comprising:
a) subjecting waste to an enzymatic and/or microbial treatment in a bioreactor
b) subjecting the treated waste from step a) to one or more separation step(s), whereby a bioliquid and a solid fraction is provided;
c) subjecting said bioliquid and/or solid fraction to downstream processing providing process water;
d) adding the process water obtained from step c) and optionally water from an external water source to the bioreactor in step a).

The method according to the first aspect of the present invention can be performed within a single waste processing plant comprising one or more bioreactors and/or one or more downstream processing steps such as AD digesters that are part of the same waste treatment loop; or the process water may be obtained from one or more different and possibly independent waste processing and/or biogas production sites.

### Step a)

The enzymatic and/or microbial treatment of the waste in step a) is performed in a reactor, here denoted a bioreactor. The treatment is performed by adding one or more enzymes and by the bacteria present in the waste. Optionally, standard, cultivated, or manipulated yeast, bacteria, or any other microorganism capable of converting the organic matter present in the waste into compositions suitable for subsequent biogas production in an anaerobic digestion process may be added to the bioreactor. The enzymes are supplied in either native form or in form of microbial organisms expressing the enzymes. Depending on the dry matter content of the waste, water will usually have to be added to the process. In the context of the present invention at least part of such added water will be recycled water e.g. process water.

The enzymatic and/or microbial treatment in step a) may be performed by adding one or more enzymes, supplied in either native form and/or in form of microbial organisms giving rise to the expression of such enzymes; and/or by the bacteria present in the waste and/or optionally by adding standard, cultivated, or manipulated yeast, bacteria, or any other microorganism capable of converting the organic matter present in the waste into organic acids or other compositions, such as lactic acid, 3-hydroxypropionic acid (3-HPA), 1,4-butanediol (BDO), butanedioic acid (succinic acid), ethane-1,2-diol (ethylene glycol), butanol or 1,2-propanediol (propylene glycol), suitable for subsequent biogas production in an anaerobic digestion process.

In one embodiment, the method of the invention is a method wherein said enzymatic and/or microbial treatment in step a) is performed by adding enzymes, supplied in either native form or in form of microbial organisms giving rise to the expression of such enzymes, and/or by the bacteria present in the waste and optionally by adding standard, cultivated, or manipulated yeast, bacteria, or any other microorganism capable of producing biochemicals, ethanol, or biogas.

Microorganisms that may be added to the bioreactor in step a) include yeasts, and/or fungi and/or bacteria.

Other microorganisms that may be added to the bioreactor in step a) include bacteria that can efficiently ferment hexose and pentose including but not limited to cellobiose, glucose, xylose and arabinose to short chain organic acids including but not limited to citric acid, lactic, formic acid, acetic acid, butyric acid, valeric acid, isovaleric acid and propionic acid as well as alcohols including but not limited to ethanol.

Other microorganisms that may be added to the bioreactor in step a) include fermenting organisms such as Bacillus sp., e.g. Bacillus coagulans; Candida sp., such as C. sonorensis, C. methanosorbosa, C. diddensiae, C. parapsilosis, C. naedodendra, C. blankii, C. entomophilia, C. brassicae, C. pseudotropicalis, C. boidinii, C. utilis, and C. scehatae; Clostridium sp., such as C. acetobutylicum, C. thermocellum, and C. phytofermentans; Escherichia sp., such as E. coli, especially E. coli strains that have been genetically modified to improve the yield of ethanol, bioethanol or lactic acid; Geobacillus sp .; Hansenula sp., such as Hansenula anomala; Klebsiella sp., such as K. oxytoca; Kluyveromyces sp., such as K. marxianus, K. lactis, K. thermotolerans, and K. fragilis; Schizosaccharomyces sp., such as S. pombe; Thermoanaerobacter sp., such as Thermoanaerobacter saccharolyticum; and Zymomonas sp., such as Zymomonas mobilis. Lactobacillus sp., e.g. Lactobacillus delbrueckii subsp. Bulgaricus, Lactobacillus ultunensis, Lactobacillus senmaizukei, Lactobacillus equicursoris, Lactobacillus tucceti, Lactobacillus brantae, Lactobacillus parakefiri, Lactobacillus crispatus, Lactobacillus intermedius, Lactobacillus mucosae, Lactobacillus agili,s Lactobacillus equi, Lactobacillus delbrueckii, Lactobacillus frumenti, Lactobacillus letivazi, Lactobacillus thailandensis, Lactobacillus helveticus, Lactobacillus apis, Lactobacillus acidifarinae, Lactobacillus gallinarum, Lactobacillus kalixensis, Lactobacillus hayakitensis Lactobacillus gastricus, Lactobacillus homohiochii, Lactobacillus guizhouensis, Lactobacillus intestinalis, Lactobacillus hilgardii, Lactobacillus iners, Lactobacillus brevis, Lactobacillus fermentum, Lactobacillus oris, Lactobacillus coleohominis, Lactobacillus panis, Lactobacillus acidophilus, Lactobacillus ruminis, Lactobacillus suebicus, Lactobacillus pobuzihii, Lactobacillus similis, Lactobacillus rhamnosus, Lactobacillus manihotivorans, Lactobacillus nodensis, Lactobacillus aviaries, Lactobacillus vaginalis, Lactobacillus namurensis, Lactobacillus rossiae, Lactobacillus buchneri, Lactobacillus jensenii, Lactobacillus parabrevis, Lactobacillus equigenerosi, Lactobacillus oligofermentans, Lactobacillus farciminis, Lactobacillus johnsonii, Lactobacillus parabuchneri, Lactobacillus parabuchneri, Lactobacillus hamsteri, Lactobacillus pentosus, Lactobacillus bobalius, Lactobacillus Alimentarius, Lactobacillus crustorum, Lactobacillus pontis, Lactobacillus salivarius, Lactobacillus taiwanensis Lactobacillus antri, Lactobacillus siliginis, Lactobacillus kitasatonis, Lactobacillus camelliae, Lactobacillus secaliphilus, Lactobacillus ingluviei, Pediococcus spp., Fructobacillus pseudoficulneus, Lactobacillus gigeriorum, Pediococcus sp., e.g. Pediococcus argentinicus, Pediococcus stilesii, Pediococcus cellicola, Streptococcus spp., Alkalibacterium spp., Leuconostoc spp., Enterococcus spp., Tetragenococcus sp., e.g. Tetragenococcus doogicus, Weissella spp., Streptococcus fryi, Oenococcus spp., Enterococcus cecorum, Vagococcus teuberi, Streptococcus bovis, Lactobacillus faeni, Pediococcus acidilactici, Leuconostoc carnosum, Lactobacillus japonicus, Trichococcus spp., Weissella minor, Weissella salipiscis, Facklamia, Vagococcus, Enterococcus camelliae, Streptococcus infantarius, Aerococcus viridans, Lactococcus fujiensis, Alkalibacterium subtropicum, Weissella viridescens, Lactobacillus amylolyticus, Facklamia tabacinasalis, Streptococcus dentirousetti, Streptococcus vestibularis, Desemzia incerta, Pediococcus parvulus, Streptococcus dentapri, Granulicatella elegans, Enterococcus columbae, Aerococcus urinaeequi, Pediococcus siamensis, Weissella soli, Aerococcus spp., Enterococcus rotate, Streptococcus milleri, Carnobacterium inhibens, Streptococcus ursoris, Desemzia spp., Vagococcus penaei, Streptococcus castoreus, Enterococcus asini, Enterococcus lactis, Weissella paramesenteroides, Melissococcus spp., Vagococcus fluvialis, Lactobacillus versmoldensis, Streptococcus gallinaceus, Enterococcus hawaiiensis, Leuconostoc palmae, Pediococcus inopinatus, Tetragenococcus spp., Facklamia languida, Lactococcus spp., Abiotrophia defective, Weissella thailandensis, Facklamia hominis, Lactobacillus paracasei, Streptococcus halichoeri, Streptococcus equinus, Enterococcus gilvus, Enterococcus inusitatus, Streptococcus alactolyticus, Enterococcus aquimarinus, Carnobacterium mobile, Streptococcus parasanguinis, Streptococcus tigurinus, Streptococcus luteciae, Granulicatella adiacens, Lactococcus sp., e.g. Lactococcus raffinolactis, Carnobacterium maltaromaticum, Enterococcus avium, Streptococcus peroris, Streptococcus plurextorum, Lactobacillus vaccinostercus, Streptococcus troglodytae, Tetragenococcus solitaries, Weissella hanii, Carnobacterium spp., Lactococcus garvieae, Lactococcus lactis, Streptococcus lactarius, Marinilactibacillus psychrotolerans, Carnobacterium funditum, Leuconostoc mesenteroides, Leuconostoc pseudomesenteroides, Enterococcus haemoperoxidus, Enterococcus gallinarum, Enterococcus italicus, Aerococcus christensenii, Streptococcus didelphis, Streptococcus orisratti, Alkalibacterium iburiense, Lactobacillus collinoides, Trichococcus flocculiformis, Aerococcus sanguinicola Lactobacillus amylovorus, Leuconostoc gelidum, Leuconostoc gasicomitatum, Granulicatella spp., Leuconostoc kimchi, Leuconostoc argentinum, Streptococcus sanguinis, Streptococcus pseudopneumoniae, Weissella koreensis, Fructobacillus spp., Leuconostoc garlicum, Weissella cibaria, Leuconostoc citreum, Lactobacillus zymae, Fructobacillus fructosus, Leuconostoc inhae, Lactobacillus reuteri, Lactobacillus hammesii, Lactobacillus nantensis, Lactobacillus paralimentarius, Streptococcus thermophilus, Leuconostoc lactis, Weissella confuse, Lactobacillus acetotolerans, Lactobacillus otakiensis, Fructobacillus ficulneus, Lactobacillus kefiri, Lactobacillus zeae, Lactobacillus casei, Lactobacillus plantarum, Lactobacillus pantheris, Marinilactibacillus piezotolerans, Lactobacillus acidipiscis, Lactobacillus malefermentans, Lactobacillus gasseri, Lactobacillus parafarraginis, Carnobacterium gallinarum, Vagococcus carniphilus, Streptococcus parauberis, Lactobacillus sanfranciscensis, Carnobacterium divergens, Streptococcus oralis, Streptococcus infantis, Enterococcus casseliflavus, Streptococcus oligofermentans, Lactobacillus kefiranofaciens, Streptococcus australis, Pediococcus claussenii, Alkalibacterium psychrotolerans, Enterococcus durans, Vagococcus salmoninarum, Vagococcus lutrae, Enterococcus faecalis Carnobacterium viridans, Lactobacillus kisonensis, Pediococcus pentosaceus, Enterococcus mundtii, Enterococcus sulfureus, Enterococcus silesiacus, Lactobacillus kimchi, Fructobacillus tropaeol,i Abiotrophia spp., Streptococcus anginosus, Pediococcus ethanolidurans.

The fermenting microorganisms may have been genetically modified to provide the ability to ferment pentose sugars, such as xylose utilizing, arabinose utilizing, and xylose and arabinose co-utilizing microorganisms.

The fermenting organisms may comprise one or more polynucleotides encoding one or more cellulolytic enzymes, hemicellulolytic enzymes, and accessory enzymes described herein.

The microorganisms present in the waste or added to the bioreactor, may produce fermentable sugars and organic acid or other compositions, such as lactic acid, 3-hydroxypropionic acid (3-HPA), 1,4-butanediol (BDO), butanedioic acid (succinic acid), ethane-1,2-diol (ethylene glycol), butanol or 1,2-propanediol (propylene glycol), that may be used as feed in a subsequent anaerobic digestion process. These organic acids or other compositions further include acetate, propionate and butyrate. Waste that is suitable for treatment normally comprises, at least, lactic acid producing bacteria.

When microorganisms are added and/or the waste is inoculated prior to the enzymatic and/or microbial degradation in step a) one or more species of lactic acid producing bacteria can be used.

It will be readily understood by one skilled in the art that a bacterial preparation used for inoculation may comprise a community of different organisms. One or more naturally occurring bacteria which exist in any given geographic region and which are adapted to thrive in waste, such as MSW, from that region, can be used. As is well known in the art, lactic acid producing bacteria are ubiquitous and will typically comprise a major component of any naturally occurring bacterial community within waste, such as MSW.

In a preferred embodiment, the microbial treatment in step a) is performed by a microbial composition wherein the majority of the living microorganisms are lactic acid producing bacteria including e.g. Bacillus coagulans.

The microbial treatment in step a) may be performed by a microbial composition wherein at least 10%, 15%, 20%, 25%, 30%, 35%, 40%, 45%, 50%, 55%, 60%, 65%, 70%, 75%, 80%, 85%, 90%, 95% or 99% of the living microorganisms are lactic acid producing bacteria.

The treatment step a) may comprise contacting the waste with live lactic acid bacteria and/or other microorganisms including fermenting organisms such as Bacillus coagulans concentration of approximately 1×10⁵CFU/ml, 1×10⁶CFU/ml, 1×10⁷CFU/ml, 9×10⁷CFU/ml 1.0×10⁸ or 1.0×10⁹CFU/ml. When these microorganisms are added to the waste, these should be added at a concentration of at least 1×10⁵CFU/ml, 1×10⁶CFU/ml, 1×10⁷CFU/ml, 9×10⁷CFU/ml, 1.0×10⁸, 1.0×10⁹ or 1.0×10¹⁰CFU/ml. In a preferred embodiment these microorganisms are added to and/or present in the waste at a concentration of 1×10⁶CFU/ml to 9×10⁶CFU/ml. In a preferred embodiment these microorganisms are already present in the waste and no additional microorganisms are added.

In one embodiment of the method of the invention, the treatment in step a) comprises contacting the waste with a live lactic acid bacteria concentration of at least 1.0×10⁶, 1.0×10⁷, 1.0×10⁸ or 1.0×10⁹ CFU/L.

In one embodiment of the method of the invention, the treatment in step a) comprises adding microorganisms to the waste at a concentration of 1.0×10⁶, 1.0×10⁷, 1.0×10⁸, 1.0×10⁹ or 1.0×10¹⁰ CFU/L.

The treatment step a) may comprise addition of cellulase activity by inoculation with one or more microorganism(s) that exhibits extracellular cellulase activity.

In step a) the waste may be treated with an enzyme composition. Suitable enzyme compositions are well known in the art and are commercially available e.g. such as cellulolytic background composition.

In order to find out how much enzyme of a given enzymatic composition may be added, a solubilization test of the enzyme composition on model waste may be applied to provide an optimum enzymatic solubilization process.

It is not only the amount of enzymes to be added at the initiation of the process that can be determined by a solubilization test. A solubilization test can also be applied when determining the total enzymatic performance including enzyme optionally added to the bioreactor in step d) as being comprised in the process water. Regardless of whether the enzymes are added as fresh enzymes to the waste or as “re-usable” enzymes comprised in process water or as mixtures of fresh and re-used enzymes, the enzyme efficacy in the reactor may typically be 35-70% solubilization of model substrate in the laboratory assay, depending on the model substrate composition and the enzyme composition being tested.

When added to the process the cellulolytic background composition (CBC) may comprise a commercial cellulolytic enzyme preparation. Examples of commercial cellulolytic enzyme preparations suitable for use in the method according to the present invention include but is not limited to, for example, CELLIC® CTec (Novozymes A/S), CELLIC® CTec2 (Novozymes A/S), CELLIC® CTec3 (Novozymes A/S), CELLUCLAST® (Novozymes A/S), NOVOZYM™ 188 (Novozymes A/S), SPEZYME™ CP (Genencor Int.), ACCELLERASE™ TRIO (DuPont), FILTRASE® NL (DSM); METHAPLUS® S/L 100 (DSM), ROHAMENT™ 7069 W (Röhm GmbH), or ALTERNAFUEL® CMAX3™ (Dyadic International, Inc.).

When the enzyme composition comprises further enzymatic activity apart from the activities present in the CBC, such enzyme activity may be added from individual sources or together as part of enzyme blends. Suitable blends include but are not limited to the commercially available enzyme compositions Cellulase PLUS, Xylanase PLUS, BrewZyme LP, FibreZyme G200 and NCE BG PLUS from Dyadic International (Jupiter, FL, USA) or Optimash BG from Genencor (Rochester, NY, USA).

The CBC may comprise the following enzymatic activities:
Cellobiohydrolase I:
Endo-1,4-beta-glucanase
Beta-glucosidase
Endo-1,4-beta-xylanase
Beta-xylosidase
Beta-L-arabinofuranosidase
Amyloglocosidase
Alpha-amylase
Acetyl xylan esterase

The cellulolytic enzyme preparation may be added in an amount effective from about 0.5 to about 10 wt. % of solids, e.g., about 1 to about 5 wt. % of solids when the waste has a composition corresponding to the MSW model substrate (41% of fraction I (food waste of plant origin), 13% of fraction II (food waste of animal origin) and 46% of fraction III (cartons, paper, wood and textiles)), which mimics the organic fraction of MSW from Northern European households. In MSW from other geographic areas, the composition of the MSW may not match the model substrate and in such case, the enzymatic performance should be tested on suitable model substrate by applying solubility test such as the test disclosed herein order to identify the amount of enzyme required to obtain sufficient solubilization.

Other enzymes which may be added e.g. in addition to the CBC are listed below.

Examples of bacterial endoglucanases that can be used in the enzymatic degradation processes in step a) include, but are not limited to one or more of: Acidothermus cellulolyticus endoglucanase (WO 91/05039; WO 93/15186; U.S. Pat. No. 5,275,944; WO 96/02551; U.S. Pat. No. 5,536,655; WO 00/70031; WO 05/093050), Erwinia carotovara endoglucanase (Saarilahti et al., 1990, Gene 90: 9-14), Thermobifida fusca endoglucanase III (WO 05/093050), and Thermobifida fusca endoglucanase V (WO 05/093050).

Examples of fungal endoglucanases that can be used in the enzymatic degradation process in step a) include, but are not limited to one or more of: Trichoderma reesei endoglucanase I (Penttila et al., 1986, Gene 45:253-263, Trichoderma reesei Cel7B endoglucanase I (GenBank:M15665), Trichoderma reesei endoglucanase II (Saloheimo et al., 1988, Gene 63:11-22), Trichoderma reesei Cel5A endoglucanase II (GenBank:M19373), Trichoderma reesei endoglucanase III (Okada et al., 1988, Appl. Environ. Microbiol. 64:555-563, GenBank:AB003694), Trichoderma reesei endoglucanase V (Saloheimo et al., 1994, Molecular Microbiology 13:219-228, GenBank:Z33381), Aspergillus aculeatus endoglucanase (Ooi et al., 1990, Nucleic Acids Research 18:5884), Aspergillus kawachii endoglucanase (Sakamoto et al., 1995, Current Genetics 27:435-439), Fusarium oxysporum endoglucanase (GenBank:L29381), Humicola grisea var. thermoidea endoglucanase (GenBank:AB003107), Melanocarpus albomyces endoglucanase (GenBank:MAL515703), Neurospora crassa endoglucanase (GenBank:XM_324477), Humicola insolens endoglucanase V, Myceliophthora thermophila CBS 117.65 endoglucanase, Thermoascus aurantiacus endoglucanase I (GenBank:AF487830), Trichoderma reesei strain No. VTT-D-80133 endoglucanase (GenBank:M15665), and Penicillium pinophilum endoglucanase (WO 2012/062220) and endoglucanases produced by Aspergillus niger.

Examples of cellobiohydrolases that can be used in the enzymatic degradation processes in step a) include, but are not limited to one or more of: Aspergillus aculeatus cellobiohydrolase II (WO 2011/059740), Aspergillus fumigatus cellobiohydrolase I (WO 2013/028928), Aspergillus fumigatus cellobiohydrolase II (WO 2013/028928), Chaetomium thermophilum cellobiohydrolase I, Chaetomium thermophilum cellobiohydrolase II, Humicola insolens cellobiohydrolase I, Myceliophthora thermophila cellobiohydrolase II (WO 2009/042871), Penicillium occitanis cellobiohydrolase I (GenBank:AY690482), Talaromyces emersonii cellobiohydrolase I (GenBank:AF439936), Thielavia hyrcanie cellobiohydrolase II (WO 2010/141325), Thielavia terrestris cellobiohydrolase II (CEL6A, WO 2006/074435), Trichoderma reesei cellobiohydrolase I, Trichoderma reesei cellobiohydrolase II, and Trichophaea saccata cellobiohydrolase II (WO 2010/057086).

Examples of beta-glucosidases that can be used in the enzymatic degradation processes in step a) include, but are not limited to one or more of: beta-glucosidases from Aspergillus aculeatus (Kawaguchi et al., 1996, Gene 173:287-288), Aspergillus fumigatus (WO 2005/047499), Aspergillus niger (Dan et al., 2000, J. Biol. Chem. 275:4973-4980), Aspergillus oryzae (WO 02/095014), Penicillium brasilianum IBT 20888 (WO 2007/019442 and WO 2010/088387), Thielavia terrestris (WO 2011/035029), and Trichophaea saccata (WO 2007/019442).

Other useful endoglucanases, cellobiohydrolases, and beta-glucosidases are disclosed in numerous Glycosyl Hydrolase families using the classification according to Henrissat, 1991, Biochem. J. 280:309-316, and Henrissat and Bairoch, 1996, Biochem. J. 316:695-696.

Any “Auxiliary Activity 9 polypeptide” or “AA9” polypeptide can be used as a component of the enzyme composition.

Examples of AA9 polypeptides that can be used in the enzymatic degradation processes in step a) include, but are not limited to one or more of: AA9 polypeptides from Thielavia terrestris (WO 2005/074647, WO 2008/148131, and WO 2011/035027), Thermoascus aurantiacus (WO 2005/074656 and WO 2010/065830), Trichoderma reesei (WO 2007/089290 and WO 2012/149344), Myceliophthora thermophila (WO 2009/085935, WO 2009/085859, WO 2009/085864, WO 2009/085868, and WO 2009/033071), Aspergillus fumigatus (WO 2010/138754), Penicillium pinophilum (WO 2011/005867), Thermoascus sp. (WO 2011/039319), Penicillium sp. emersoni (WO 2011/041397 and WO 2012/000892), Thermoascus crustaceous (WO 2011/041504), Aspergillus aculeatus (WO 2012/125925), Thermomyces lanuginosus (WO 2012/113340, WO 2012/129699, WO 2012/130964, and WO 2012/129699), Aurantiporus alborubescens (WO 2012/122477), Trichophaea saccata (WO 2012/122477), Penicillium thomii (WO 2012/122477), Talaromyces stipitatus (WO 2012/135659), Humicola insolens (WO 2012/146171), Malbranchea cinnamomea (WO 2012/101206), Talaromyces leycettanus (WO 2012/101206), and Chaetomium thermophilum (WO 2012/101206), and Talaromyces thermophilus (WO 2012/129697 and WO 2012/130950).

Examples of proteases that can be used in the enzymatic degradation processes in step a) may be derived from the genus Bacillus, such as e.g. Bacillus amyloliquefaciens such as e.g. the protease encoded by SEQ ID NO:1 as disclosed in WO17076421, or a protease having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to SEQ ID NO: 1 as disclosed in WO17076421.

Examples of lipases that can be used in the enzymatic degradation processes in step a) may be derived from the genus Thermomyces sp. such as e.g. Thermomyces lanuginosus such as e.g. the lipase encoded by SEQ ID NO: 2 as disclosed in WO17076421 (or a lipase having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to SEQ ID NO: 2 as disclosed in WO17076421) or a lipase derived from the genus Humicola sp. such as e.g. Humicola insolens.

Examples of beta-glucanases that can be used in the enzymatic degradation processes in step a) may be derived from a member of the genus Aspergillus such as e.g. Aspergillus aculeatus such as e.g. the beta-glucanase encoded by the sequence encoded by SEQ ID NO: 4 as disclosed in WO17076421 or homologs thereof (e.g., a beta-glucanase having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to SEQ ID NO: 4 as disclosed in WO17076421).

Examples of pectate lyases that can be used in the enzymatic degradation processes in step a) may form part of a multicomponent enzyme composition comprising pectate lyase, xylanase and cellulase activities such as e.g. Novozym 81243™.

Examples of mannanases that can be used in the enzymatic degradation processes in step a) may be an amylase may be an alpha-amylase derived from the genus Rhizomucor such as e.g. Rhizomucor pusillus such as e.g. the alpha-amylase encoded by SEQ ID NO: 5 as disclosed in WO17076421or homologs thereof (e.g., an alpha-amylase having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to SEQ ID NO: 5 as disclosed in WO17076421).

The enzymatic treatment of the biodegradable parts of the waste optionally concurrently with microbial fermentation according to step a) may be performed at a temperature above 20° C. and up to 75° C. resulting in liquefaction and/or saccharification of biodegradable parts of the waste and accumulation of sugars and other soluble degradation products.

The method according to treatment step a) may be performed at a temperature between 20 and 75° C., 30° C. and 70° C., 40° C. and 65° C., 45° C. and 65° C.

In a preferred embodiment of the method of the invention, the treatment step a) is performed at a temperature between 20 and 75° C., 30° C. and 70° C., 40° C. and 60° C., 45 and 55° C., or around 50° C.

One preferred temperature range is the optimal temperature for most current suitable enzyme compositions, that is between 50° C.-56° C., such as 53° C. Another preferred temperature range is the temperature optimum of other suitable enzyme compositions, that is between 55° C.-57° C.

It can be advantageous to adjust the temperature of the waste such as MSW prior to initiation of enzymatic treatment. As is well known in the art, cellulases and other enzymes typically exhibit an optimal temperature range. While examples of enzymes isolated from extreme thermophilic organisms are certainly known, having optimal temperatures on the order of 60° C. or even 70° C., enzyme optimal temperature ranges typically fall within the range 35° C. to 55° C. Enzymatic treatment may be conducted within the temperature range 30° C. to 35° C., or 35° C. to 40° C., or 40° C. to 45° C., or 45° C. to 50° C., or 50° C.to 55° C., or 55° C. to 60° C., or 60° C.to 65° C., or 65° C. to 70° C., or 70° C. to 75° C.

As used herein, the temperature to which waste such as MSW is heated is the highest average temperature of waste such as MSW achieved within the reactor. The highest average temperature may not necessarily be maintained for the entire period. The heating reactor may comprise different zones such that heating occurs in stages at different temperatures. Heating may be achieved using the same reactor in which enzymatic treatment is conducted. The object of heating is simply to render the majority of cellulosic waste and a substantial fraction of the plant waste in a condition optimal for enzymatic treatment. To be in a condition optimal for enzymatic treatment, waste should ideally have a temperature and water content appropriate for the enzyme activities used for enzymatic treatment.

It can be advantageous to agitate during heating to achieve evenly heated waste. Agitation further achieves the introduction of mechanical energy to create shear forces in the waste and the waste mix. Agitation can comprise free-fall mixing, such as mixing in a reactor having a chamber that rotates along a substantially horizontal axis or in a mixer having a rotary axis lifting the waste such as MSW or in a mixer having horizontal shafts or paddles lifting the waste such as MSW. Agitation can comprise one or more of shaking, stirring or conveyance through a transport screw conveyor. The agitation may continue after waste such as MSW has been heated to the desired temperature.

The bioreactor in step a) may be adapted to process more than 1; 5; 10; 15; 20; 25; 30; 35; 40; 45; or 50 t waste/h.

The method of the invention can be applied at any plant scale. It has been tested in small scale at laboratory tests, in medium scale at test plants and at large scale waste processing plants. In one embodiment, the filling volume of the bioreactor in step a) is larger than 10, 50, 100, 150, 200, 250, 300, 350, 400, 450 or 500 m³ during operation and can be much larger, such as 6000 m³ and is suitable plants that process more than 5, 10, 15, 20, 25, 30, 35, 40, 45 or 50 tons of waste per hour.

The waste, e.g. MSW, may have a Dry Matter (DM) content in the range 10%-90%; 20%-85%; 30%-80%; 40%-75%; 50%-70%; or 55%-65% (w/w); and/or around 10%; 15%; 20%; 25%; 30%; 35%; 40%; 45%; 50%; 55%; 60%; 65%; 70%; 75%; 80%; 85%; or 90% (w/w). The amount of water added in step a) depends on the amount of dry matter of the waste, when the dry matter content is low the need of adding water to the process of step a is also low. When the dry matter content is above XX % addition of water to process a) is needed. Addition of water to process of step a) may always be beneficial, and usually, addition of water to the process of step a) is necessary, due to the dry matter content in the waste. In the context of the present invention at least part of the water added to step a) is process water.

In one embodiment of the invention the amount of dry matter content is above 60%, such as at least 70%, such as at least 75%, such as at least 80%, such as at least 85%, such as at least 90%, such as at least 95%, such as at least 97%, such as at least 98% or even such as at least 99% dry matter.

The dry matter may be measured as follows: prepare crucibles by adding 1.5 g of mineral based (heat resistant) litter e.g. cat litter. Heat in fumace for 1 hour at 550° C. then allow to cool to 200° C. before transferring the crucibles into a desiccator filled with silica gel using metal tongues. Allow to cool to room temperature. Weigh the crucible W_{crucible} and add 25 g of sample and reweigh and note the weight Wₛₐₘₚₗₑ. Place crucible on a suitable tray and place in the preheated oven and heat at 105° C. for 24 hours. Take crucibles from the oven and return them into the desiccator. When cooled to room temperature weigh crucible plus contents and note the weight W_{dry}. Dry matter (DM) is calculated as DM=((W_{dry}−W_{crucible}/Wₛₐₘₚₗₑ−W_{crucible})*100).

The DM content of the waste may be determined at different points in time. The DM content of the waste may be measured or assessed (i) before entry into the bioreactor in step a), such as in the waste pit or transfer station; (ii) at the onset of said enzymatic and/or microbial treatment of the waste entering the bioreactor in step a); and/or (iii) before provision of the bioliquid obtained in step a) through one or more solid/liquid separation step(s).

Thus, the DM content of the waste may be measured or assessed at one or more of the following points in time: (i) before entry into the bioreactor in step a); ii) at the onset of said enzymatic and/or microbial treatment of the waste entering the bioreactor in step a); (iii) before provision of the bioliquid obtained in step a) through one or more solid/liquid separation step(s).

As a practical matter, notwithstanding some variability in the composition of the waste being processed, it is convenient to add a relatively constant mass ratio of water (which includes aqueous solution) in step a). For instance, when the waste to be treated is municipal solid waste (MSW) it will be convenient to add between 0.8 and 1.8 kg water per kg MSW, or between 0.5 and 2.5 kg water per kg MSW, or between 1.0 and 3.0 kg water per kg MSW. As a result, the actual non-water content of the waste (or MSW) during processing may vary within the appropriate range.

In order for the enzymatic and/or microbial liquefaction of the waste in the bioreactor in step a) to provide a bioliquid comprising an optimum amount of short chain carboxylic acids and sugars such as glucose, xylose, arabinose, lactic acid/lactate, acetic acid/acetate and/or ethanol, the pH in the bioreactor should generally remain within a pH range of between pH 3-6.5.

### Step b)

Step b) is a separation step where the bioliquid is separated from the non-degradable solid waste fractions. Clean and efficient use of the degradable component of waste, such as MSW, combined with recycling typically requires some method of sorting or separation to separate degradable from non-degradable material. The separation in step b) may be performed by any means known in art, such as in a ballistic separator, washing drums and/or hydraulic presses. In one embodiment the separation is performed before the enzymatic treatment. Separation of liquid and solids can e.g. be done in different presses (such as screw and/or piston presses) or e.g. using a simpler sieve function. A ballistic separator is typically used to separate the solids into 2D and 3D fractions and only secondarily a liquid separation.

Step b) can be conducted one or more times before, during or after enzymatic and/or microbial treatment in a bioreactor, wherein said step b) while being conducted during the enzymatic and/or microbial treatment may, in one embodiment, occur after said enzymatic treatment but prior to said microbial treatment in a bioreactor.

Separation of liquefied and/or saccharified, fermentable parts of the waste from non-fermentable solids can be achieved by a variety of means. Using one separation operation or a combination of at least two different separation operations, including but not limited to screw press operations, ballistic separator operations, vibrating sieve operations, or other separation operations known in the art may be applicable.

The separation is typically performed by one or more separation steps means, which could be exemplary performed by those of one or more ballistic separator(s), sieve(s), washing drum(s), presses and/or hydraulic press(es). The one or more separation means separate the waste such as MSW treated with enzyme and/or microbial action, into the bioliquid, a fraction of 2D materials non-biodegradable (flat materials such as textiles, plastic film, undigested cardboard), and a fraction of 3D materials (including metals and solid plastic). Inert material, which is sand and glass is typically removed e.g. sieved from the bioliquid. Metals are typically removed from all mentioned fractions. The process water obtained from one or more of these downstream processing of the solid waste derived from step a) i.e. the wash water obtained from the washing drums can be recirculated into step a) in the method according to the present invention.

### Step c)

In Step c), the bioliquid and/or the solid fraction(s) obtained in step b) is processed further. The bioliquid is normally processed further for being applicable for use in methods for providing energy or biochemicals, such methods including thermo-chemical conversion of the solubilized waste to electricity, heat, methanol, hydrogen, dimethyl ether, petrol, bio-diesel and/or bio-chemical conversion of the solubilized waste to biogas, hydrogen, bio-ethanol, bio-diesel and the like.

The one or more solid fraction(s) exiting the bioreactor are normally subjected to one or more washing steps prior to any subsequent reuse processes of the solid waste.

The 2D fraction of the solid fraction obtained in step b) can be further separated into recyclables and/or residuals such as SRF (Solid Recovered Fuel), RDF (Refused Derived Fuel) and/or inerts. The 3D fraction can also be further separated into recyclables and/or residuals such as metals, 3D plastic and/or RDF.

The 3D fraction (such as cans and plastic bottles) does not bind large amounts of bioliquid, so a single washing step is often sufficient to clean the 3D fraction. The 2D fraction (textiles and foils as examples) typically binds a significant amount of bioliquid. Therefore, the 2D fraction is typically pressed using e.g. a screw press, washed and pressed again to optimize the recovery of bioliquid and to obtain a cleaner and drier 2D fraction.

Wash water is any water stream used for washing of any solid fraction obtained after the solid-liquid separation in step b). Examples of wash water are water used for washing of the 2D fraction and/or the 3D fraction. Other examples of wash water are water used for washing of inerts, metals and/or plastics. Wash water can also be diluted bioliquid obtained from step a) in the method according to the present invention. In one embodiment, the wash water is water used for washing the 2D and/or the 3D fractions.

In a preferred embodiment of the method of the invention, the downstream processing in step c) is a washing process of solid waste such as washing of the 2D solid waste fraction or of the 3D solid waste fraction. The water from different downstream washing processes of solid waste may be joined to provide the process water as shown in FIG. 1a.

In another preferred embodiment of the method of the invention, the downstream processing in step c) is an evaporation process wherein water from dewatering the digestate (e.g. resulting from an AD process) or from another downstream process is evaporated and collected. The process water e.g. reject water or wash water treated in an evaporator system will result in a clean water condensate and a nutrient rich liquid termed Brine. The clean water, which is also according to the definition of the invention process water, may be reused for washing recovered material in the 2D and 3D mechanical waste treatment stages or may be recirculated back to the reactor.

In another preferred embodiment of the invention, the downstream processing in step c) is a collection of the bioliquid or a part of the bioliquid obtained in step b).

In one preferred embodiment the further processing of bioliquid in step c) is anaerobic digestion (AD). Anaerobic digestion (AD) is a series of biological processes in which microorganisms break down biodegradable material in the absence of oxygen. One of the end products is biogas, which can be combusted to generate electricity and/or heat, or can be processed into renewable natural, biomethane gas and/or transportation fuels. A range of anaerobic digestion technologies exists in the state of the art for converting waste, such as municipal solid waste, municipal waste water solids, food waste, high strength industrial wastewater and residuals, fats, oils and grease (FOG), and various other organic waste streams into biogas. Many different anaerobic digester systems are commercially available, and the skilled person will be familiar with how to apply and optimize the anaerobic digestions process. The metabolic dynamics of microbial communities engaged in anaerobic digestion are complex.

In typical anaerobic digestion (AD) for production of methane biogas, biological processes mediated by microorganisms achieve four primary steps—hydrolysis of biological macromolecules into constituent monomers or other metabolites; acidogenesis, whereby short chain hydrocarbon acids and alcohols are produced; acetogenesis, whereby available nutrients are catabolized to acetic acid, hydrogen and carbon dioxide; and methanogenesis, whereby acetic acid and hydrogen are catabolized by specialized archaea to methane and carbon dioxide. The hydrolysis step is typically rate-limiting and dependent on the biomass type. In the bioliquid it is the methanogens that limits the processing rate. From AD is furthermore obtained digestate, comprising a solid fraction and a liquid fraction (reject water).

It is well known in the art, that the conversion of biodegradable organic material e.g., in waste into CH₄ and CO₂ during the enzymatic and/or microbial treatment followed by anaerobic digestion process is facilitated by three major groups of microorganisms. The fermenting microorganisms converts the organic material to short-chain fatty acids (such as lactic acid) through hydrolysis by e.g. extracellular enzymes and subsequent fermentation of the hydrolyzed products. Other products of the fermentation process are acetic acid, alcohols, CO₂ and H₂. The end products from the fermenting and the acidogenic bacteria (lactic acid, formic acid, acetic acid, and H₂) are converted to CH₄ and CO₂ by methane producing microorganisms. The methane producing microorganisms comprise microorganisms belonging to the archaea domain.

When the further processing in step c) is anaerobic digestion, the anaerobic digestion may comprise one or more digesters operated under controlled aeration conditions, eliminating or minimizing the available oxygen, in which methane gas is produced in each of the digesters comprising the system. The AD reactor(s) can, but need not, be part of the same waste processing plant as the bioreactor in step a) and can, but need not, be connected to the bioreactor in step a). Moreover, the AD process may be in the form of a fixed filter system. A fixed filter anaerobic digestion system is a system in which an anaerobic digestion consortium is immobilized, optionally within a biofilm, on a physical support matrix.

In a preferred embodiment of the method of the invention, the downstream processing in step c) is anaerobic digestion providing an anaerobic digestion effluent, resulting in reject water from dewatering the digestate.

Since the process water may comprise microorganisms, it may be desirable to sanitize the process water prior to re-circulating the process water into the bioreactor in step a). This may for instance be the case if the process water is obtained from a digestate i.e. reject water where the microbial flora is different from the microbial flora in the bioreactor.

In one embodiment of the method of the invention, the process water obtained in step c) is subject to hygienization before being subjected to step d).

Additionally, the process water may be added to the reactor in batches to keep pH within 3.5-6.

In one embodiment of the method of the invention, the process water obtained in step c) is added in step a) in batches, such that pH in the reactor is between pH 3.5-6.

Hygienization is any process decimating the concentration of reference organisms by at least 6 decades and can also achieved by means of thermal treatment, filtering, ultraviolet treatment, electrification, treatment at 50° C. for more than one hour, among other means. The Animal By-product Protocol (EU Regulation No 142/2011) describes hygienization at 70° C.for 60 minutes.

In one embodiment, the method of the invention comprises a hygienization step wherein the process water obtained in step c) is subjected to hygienization. In a preferred embodiment, the hygienization comprises treatment of process water at a temperature in the range of 60° C.to 75° C., preferably 70° C. or preferably around 70° C. for at least one hour, preferably for 60-80 minutes, preferably 60-70 minutes or preferably about 60 minutes.

Due to the amount of salt in the digestate and due to the presence of microbial organisms in the digestate, it was expected that addition of reject water would primarily possess a negative impact on the enzymatic and/or microbial treatment in the bioreactor. However, surprisingly process water which comprise reject water has shown not to diminish the liquefaction process in the reactor and therefore such water can be recycled continuously during the process of the invention.

### Step d)

In step d) the process water obtained from step c) and optionally water from an external water source is added to the bioreactor in step a).

Water from an external water source may be mixed with the process water prior to the addition into the bioreactor or the process water and the water from an external source may be added separately at the same time or at different points in time and the addition may be continuous or at different frequencies and volumes depending on the amount of waste and the composition of the waste in the bioreactor.

Water from external sources includes water obtained from any source wherein said water has not previously been subjected to any steps in an enzymatic and/or microbial waste treatment process.

Thus, water from external sources comprise tap water, wastewater that has not been subjected to an enzymatic and/or microbial waste treatment process, and water from natural sources such as rivers and lakes.

In one embodiment of the method of the invention, the external water in step d) is selected from natural sources such as rivers, lakes and ponds; water reservoirs; tap water; and any combination thereof.

The pH of the process water and optionally water from an external source can optionally be adjusted by any known means such as by the addition of acid or base if the pH of the process water is not within the optimum pH range of the liquefaction process in step a).

In one embodiment, the pH of the process water is adjusted by adding acid until pH of the process water is between pH 3.5-6, such as pH 3.5, pH 4, pH 4.5, pH 5, pH 5.5 and pH 6 or any pH value in between these pH values.

Any acid could be used to adjust pH. Preferably, the acid is an organic acid since such acids are less likely to accumulate water soluble salts in the recirculation loop.

The pH of the process water could be adjusted to pH 3.5-6 by addition of a base if the pH of the process water and optionally water from an external source is below pH 3.

When the process water is provided by an AD process, then the pH of the process water, i.e. the reject water can be adjusted by reduction of the ammonia concentration. Reduction of the ammonia concentration could be the only pH adjustment or reduction of the ammonia concentration could be in addition to adjusting the pH by the addition of an acid.

The means for reducing the ammonia concentration could be any suitable means available in the art.

In one embodiment of the method of the invention, the downstream processing in step c) is an anaerobic digestion process and the pH of the reject water is adjusted by addition of acid and/or by reducing the ammonium content prior to being added to the bioreactor in step a). The ammonium content can for instance be reduced by means of evaporation or by using specialized ammonium extraction equipment.

In some embodiments of the present invention, the process water and optionally water from one or more external sources is continuously entered into a bioreactor with ongoing enzymatic and/or microbial treatment of waste.

In other embodiments of the present invention, the process water and optionally water from one or more external sources is discontinuously entered into a bioreactor with ongoing combined enzymatic and microbial treatment of waste. That is, the process water and optionally water from an external source is entered into the bioreactor when required optionally subject to the monitored pH in the bioliquid present in the bioreactor. In one embodiment of the invention the process water is added to step a) in batches, such that pH in the reactor is between pH 3.5-6. Thus, even when adding process water, the pH is kept within the optimum range of pH 3.5-6.

As will be readily understood by one skilled in the art, the capacity to render solid components into a liquid slurry is increased with increased water content. For instance, effective pulping of paper and cardboard, which comprise a substantial fraction of MSW in some countries, is typically improved where water content is increased. Water content provides a medium in which the microbial preparation can propagate and which dissolves metabolites. Furthermore, enzyme activities may exhibit diminished activity when treatment is conducted under conditions with low water content. For example, cellulases typically exhibit diminished activity in treatment mixtures that have non-water content higher than about 10% by weight. In the case of cellulases, which degrade paper and cardboard, an effectively linear inverse relationship has been reported between substrate concentration and yield from the enzymatic reaction per gram substrate, see Kristensen et al. 2009.

The waste to be processed, such as e.g. MSW, may, in a preferred embodiment, have a non-water content of between above 10% or more and below 45%. In another preferred embodiment, the waste to be processed may have a water content of 40-85%. Waste such as MSW may often comprise a considerable amount of water. However, the water content may be adjusted in order to achieve appropriate non-water content.

In one embodiment of the method of the invention, the flow rate of the addition of process water and optionally water from an external source in step d) into the bioreactor in step a) is essentially constant and/or essentially proportional, to the amount of waste, having between 1:1 and 3:1 of water:waste proportion.

In situations where the downstream process in step c) is an AD process providing a digestate or an alkaline fraction thereof, the reject water, resulting from dewatering the digestate, will comprise microorganisms involved in the AD process.

It has surprisingly been found here, that adding process water comprising reject water obtained in step c), wherein the reject water has not been subject to hygienization prior to entry into a bioreactor in step a) did not abolish the continued liquefaction process.

Thus, in some embodiments of the method according to the present invention, the reject water obtained in step c) comprises methanogenic microorganisms, such as archaea, from the anaerobic digestion.

Likewise, in some embodiments of the method according to the present invention, the reject water has not been subjected to a hygienization step prior to adding process water comprising the reject water obtained in step c) to the bioreactor in step d).

In some embodiments of the method according to the present invention, the methanogenic microorganisms comprised in the reject water obtained in step c) is exterminated upon adding the process water comprising the reject water obtained in step c) to the enzymatic and/or microbial treatment in step d).

The process water and optionally water from an external source, may be added to a bioreactor in step d) at different points in time either continuously or discontinuously before and/or during the enzymatic and/or microbial treatment of waste. Preferably, the treatment in step a) is at a steady state when the process water and optionally water from an external source is entered into the bioreactor in step d).

In one embodiment of the method according to the invention, process water and optionally water from an external source, is added to said bioreactor in step d) before the enzymatic and/or microbial treatment of the waste is initiated.

In another embodiment of the method according to the invention, process water and optionally water from an external source, is added to said bioreactor in step d) during the enzymatic and/or microbial treatment of the waste.

In yet another embodiment of the method according to the invention, process water and optionally water from an external source, is added to said bioreactor in step d) before and during the enzymatic and/or microbial treatment of the waste.

One skilled in the art will readily be able to determine an appropriate quantity of water content, to add to waste in adjusting water content in a bioreactor wherein enzymatic and/or microbial degradation is taking place, such as in step a) of the present invention. Typically, as a practical matter, notwithstanding some variability in the composition of the waste being processed, it is convenient to add a relatively constant mass ratio of water (which includes aqueous solution). For instance, when the waste to be treated is municipal solid waste (MSW) it will be convenient to add between 0.8 and 1.8 kg water per kg MSW, or between 0.5 and 2.5 kg water per kg MSW, or between 1.0 and 3.0 kg water per kg MSW. As a result, the actual non-water content of the waste (or MSW) during processing may vary within the appropriate range, e.g. between above 10% or more and below 45%.

In one embodiment of the method according to the present invention, the flow rate of process water and optionally water from an external source into the bioreactor in step d) is essentially constant and/or essentially proportional to the amount of waste entering said bioreactor.

The amount of wash water, bioliquid or tap water/purified water that is added to the bioreactor together with or in addition to process water obtained in step c), depend both on the compositions of the waste such as the dry matter content and the ratio of organic matter to inorganic or non-biodegradable matter and on the salt and microbial content of the process water. Thus, in embodiments of the method according to the present invention, more than 1.0, 2.5, 5, 10, 15, 20, 25, 30, 35, 40, 45, 50, 55, 60, 65, 70, 75, 80, 85, 90, 95, or 98% (w/w) of the water added to said waste in step d) is process water, optionally including water from an external source.

The ratio between the process water obtained in step c) to water from an external source will have to be optimized to the specific waste and composition of process water. However, this should be possible for the skilled person using routine tests for determining the DM of the waste and for determining the salt concentration of the process water and the level of microbial activity in the process water. Thus, in embodiments of the method according to the present invention, the ratio of process water obtained in step c) to water from an external source is in the range of 0.01-0.1; 0.1-0.25; 0.25-0.50; 0.50-1.0; 1.0-2.0; 2.0-4.0; 4.0-6.0; 6.0-8.0; 8.0-10; 10-20, 20-40; 40-60; 60-80; or 90-100.

The dry matter (DM) content of the process water obtained in step c) entered into the bioreactor in step d) depends on the specific separation steps performed in step b) and on the content of insoluble matter of the process water prior to entry into the bioreactor. In the method according to the present invention it is preferred that the process water obtained in step c) has a DM content (w/w %) of 1.0 or more; 1.5 or more; 2.0 or more; 2.5 or more; 3.0 or more; 3.5 or more; 4.0 or more; 4.5 or more; 5.0 or more; 5.5 or more; 6.0 or more; 6.5 or more; 7.0 or more; 7.5 or more; or 8.0 or more.

Similarly, the salt content of the process water obtained in step c) entered into the bioreactor in step d) depends on the composition of the waste treated in step a), on the specific washing and separation steps applied and on the content of insoluble matter of the process water prior to entry into the bioreactor. In the method according to the present invention the process water obtained in step c) may have an organic salt content and/or an inorganic salt content (w/w %) of 1.5 or less; 3 or less; 4.5 or less; 6 or less; 7.5 or less; 9 or less; 10.5 or less; 12 or less; 13.5 or less; 15 or less; 16.5 or less; 18 or less; 19 or less; 19.5 or less; or 20 or less.

In the method according to the present invention, the process water obtained in step c) may comprise salts such as one or more of ammonium, nitrate, nitrite, phosphate, chloride, sodium, potassium, sulfate, iron, calcium, carbonate, bicarbonate, magnesium or other salts.

In one embodiment, in the method according to the present invention, the process water obtained in step c) comprises one or more of the following elements: up to 3800 mg-N/kg-FW ammonia/ammonium; up to 4700 mg-N/kg-FW nitrogen; up to 280 mg-P/kg-FW phosphorus; up to 3300 mg/kg-FW water soluble chlorine; up to 3300 mg/kg-FW water soluble sodium; up to 2900 mg/kg-FW potassium; up to 430 mg/kg-FW sulphur; up to 590 mg/kg-FW iron: up to 6000 mg/kg-FW calcium; up to 3 mg/kg-FW nickel; up to 3 mg/kg-FW lead; up to 3 mg/kg-FW zinc.

In another embodiment, in the method according to the present invention, the process water obtained in step c) comprises one or more of the following elements: up to 8000 mg-N/kg-FW ammonia/ammonium; up to 10000 mg-N/kg-FW nitrogen; up to 600 mg-P/kg-FW phosphorus; up to 7000 mg/kg-FW water soluble chlorine; up to 7000 mg/kg-FW water soluble sodium; up to 6000 mg/kg-FW potassium; up to 900 mg/kg-FW sulphur; up to 1200 mg/kg-FW iron: up to 12000 mg/kg-FW calcium; up to 6 mg/kg-FW nickel; up to 6 mg/kg-FW lead; up to 6 mg/kg-FW zinc.

The method according to the present invention has proven effective both in small scale experiments where the bioreactor in step a) is small as well as in large scale waste processing reactors. Accordingly, in one embodiment of the method according to the invention, the filling volume of the bioreactor in step a) is larger than 10; 50; 100; 150; 200; 250; 300; 350; 400; 450; or 500 m³ during operation.

In one embodiment of the method according to the invention, the bioreactor in step a) is adapted to process more than 5; 10; 15; 20; 25; 30; 35; 40; 45; or 50 t waste/h.

In one embodiment of the method according to the invention, wherein the waste, e.g. MSW, has a DM content in the range 10-90; 20-85; 30-80; 40-75; 50-70; or 55-65% (w/w); and/or around 10; 15; 20; 25; 30; 35; 40; 45; 50; 55; 60; 65; 70; 75; 80; 85; or 90% (w/w).

The DM content of the waste may be determined at different points in time. In the method according to the present invention, the DM content of the waste may be measured or assessed (i) before entry into the bioreactor in step a); (ii) at the onset of said combined enzymatic and microbial treatment of the waste entering the bioreactor in step a); and/or (iii) before provision of the bioliquid obtained in step a) through one or more solid/liquid separation step(s).

In one embodiment, the DM content of the waste is measured or assessed (i) before entry into the bioreactor in step a).

In one embodiment, the DM content of the waste is measured or assessed (ii) at the onset of said enzymatic and/or microbial treatment of the waste entering the bioreactor in step a).

In one embodiment, the DM content of the waste is measured or assessed (iii) before provision of the bioliquid obtained in step a) through one or more solid/liquid separation step(s).

In one embodiment, the DM content of the waste is measured or assessed at one or more of the following points in time: (i) before entry into the bioreactor in step a); ii) at the onset of said enzymatic and/or microbial treatment of the waste entering the bioreactor in step a); (iii) before provision of the bioliquid obtained in step a) through one or more solid/liquid separation step(s).

In one embodiment of the method according to the invention, reject water obtained in step c) or an alkaline fraction thereof, is provided by the use of a digester such as disclosed in WO2016/050893 or WO2017/174093.

### Waste

Any waste comprising a mixture of biodegradable and non-biodegradable material could be used in the method of the invention.

In one embodiment, in the method according to the present invention, the waste comprises both biodegradable and non-biodegradable material.

In preferred embodiments of the method according to the present invention, said waste is selected from one or more of unsorted municipal solid waste, centrally sorted municipal solid waste, source sorted municipal solid waste from households, municipal solid waste processed by shredding or pulping, organic fractions and paper rich fractions, Refuse-Derived-Fuel fractions and municipal solid waste wherein the biodegradable material in said waste comprises a combination of one or more items selected from: food residues, paper, cardboard, and fines.

Relevant types of mono- and/or polysaccharide containing waste that is suitable for being processed by the enzymatic and/or microbial treatment in step a) according to the present invention may include:

Waste fractions derived from households such as e.g.:
Unsorted municipal solid waste (MSW)
MSW processed in some central sorting, shredding or pulping device such as e.g. Dewaster® or reCulture®
Solid waste sorted from households, including both organic fractions and paper rich fractions
RDF (Refuse-Derived-Fuel) fractions

Waste fractions derived from the industry such as e.g.:
General industry waste fractions containing paper or other organic fractions now being treated as household waste
Waste fraction from paper industry, e.g. from recycling facilities
Waste fractions from food and feed industry
Waste fraction from the medicinal industry

Waste fractions derived from agriculture or farming related sectors such as e.g.:
Waste fractions from processes including sugar or starch rich products such as potatoes and beet
Contaminated or in other ways spoiled agriculture products such as grain, potatoes and beet not exploitable for food or feed purposes
Garden refuse
Manure, or manure derived products

Waste fractions derived from municipal, county or state related or regulated activities such as e.g.:
Sludge from wastewater treatment plants
Fiber or sludge fractions from biogas processing
General waste fractions from the public sector containing paper or other organic fractions.

In one embodiment, the dry matter content of the mono- and/or polysaccharide containing waste fraction in the enzymatic treatment and fermentation processes in step a) is above 20%, such as 20-100%, such as 20-50%, such as 20-45%, such as 20-40% and such as 20-80% and also such as 80-100%, preferably 90-100%, most preferably about 95%.

Waste, such as MSW, is typically heterogeneous. Statistics that provide firm basis for comparisons between countries concerning composition of waste materials are not widely known. Standards and operating procedures for correct sampling and characterization remain unstandardized. Indeed, only a few standardized sampling methods have been reported. At least in the case of household waste, the composition exhibits seasonal and geographical variation, even over small distances of 200-300 km. As a general rule, the dry weight of modern urban waste from Western Europe typically comprises on the order of from 10 to 25% by weight of “vegetable and food waste”. In China, in contrast, the relative proportions of “food waste” are typically increased by a factor of at least two relatives to MSW from Western Europe.

Municipal solid waste may, in particular, comprise one or more of kitchen putrescible, garden putrescible, paper, card, plastics, miscellaneous combustible and non-combustible matters, textiles, glass, ceramics, metals, and electronic devises. Generally, municipal solid waste in the Western part of the world normally comprise one or more of: animal food waste, vegetable food waste, newsprints, magazines, advertisements, books and phonebooks, office paper, other clean paper, paper and carton containers, other cardboard, milk cartons and alike, juice cartons and other carton with alu-foil, kitchen tissues, other dirty paper, other dirty cardboard, soft plastic, plastic bottles, other hard plastic, non-recyclable plastic, yard waste, flowers etc., animals and excrements, diapers and tampons, cottonsticks etc., other cotton etc., wood, textiles, shoes, leather, rubber etc., office articles, empty chemical bottles, plastic products, cigarette buts, other combustibles, vacuum cleaner bags, clear glass, green glass, brown glass, other glass, aluminium containers, alu-trays, alu-foil (including tealight candle foil), metal containers (—Al), metal foil (—Al), other sorts of metal, soil, rocks, stones and gravel, ceramics, cat litter, batteries (button cells, alkali, thermometers etc.), other non-combustibles and fines.

The waste that can be processed in the present invention may be sorted or unsorted.

In one embodiment, the waste subject to combined enzymatic and microbial treatment in step a) is unsorted waste, such as unsorted MSW.

In another embodiment, the waste subject to combined enzymatic and microbial treatment in step a) is sorted MSW.

In a preferred embodiment of the present invention, the waste subject to enzymatic and/or microbial treatment in step a) is MSW.

Typically, unsorted MSW may comprise organic waste, including one or more of food and kitchen waste; paper- and/or cardboard-containing materials; recyclable materials, including glass, bottles, cans, metals, and certain plastics; burnable materials; and inert materials, including ceramics, rocks, and debris.

Waste subject to enzymatic and/or microbial treatment in step a) such as MSW, can be source-separated organic waste comprising predominantly fruit, vegetable and/or animal waste. A variety of different sorting systems may be applied to MSW, for instance source sorting, where individual households dispose of different waste materials separately. Source sorting systems are currently in place in some municipalities in Austria, Germany, Luxembourg, Sweden, Belgium, the Netherlands, Spain and Denmark. Alternatively, industrial sorting systems may be applied at the large-scale plant prior to subjecting the waste to the combined enzymatic and microbial treatment. Means of mechanical sorting and separation may include any methods known in the art including but not limited to the systems described in US2012/0305688; WO2004/101183; WO2004/101098; WO2001/052993; WO2000/0024531; WO1997/020643; WO1995/0003139; CA2563845; U.S. Pat. No. 5,465,847.

In one embodiment of the method according to the present invention, the waste subject to enzymatic and/or microbial treatment in step a) is derived from or comprises any one or more of waste from household, industry, agriculture, farming, county, or state activities.

In one embodiment of the method according to the present invention, the waste subject to enzymatic and/or microbial treatment in step a) comprises 10-100% biodegradable material on a dry basis. In another embodiment of the method according to the present invention, the waste subject to enzymatic and/or microbial treatment in step a) comprises 10-20% biodegradable material on a dry basis, 20-30% biodegradable material on a dry basis,
30-40% biodegradable material on a dry basis, 40-50% biodegradable material on a dry basis,
50-60% biodegradable material on a dry basis, 60-70% biodegradable material on a dry basis,
70-80% biodegradable material on a dry basis, 80-90% biodegradable material on a dry basis,
90-100% biodegradable material on a dry basis, or any combination of these intervals.

In one embodiment of the method according to the present invention, the waste subject to enzymatic and/or microbial treatment in step a) comprises 20-30% biodegradable material on a dry basis.

In one embodiment of the method according to the present invention, the waste subject to enzymatic and/or microbial treatment in step a) comprises 10-100% biodegradable material on a wet basis.

In one embodiment of the method according to the present invention, the waste subject to enzymatic and/or microbial treatment in step a) comprises 25-60% such as 35-50% biodegradable material on a wet basis.

In one embodiment of the method according to the present invention, the waste subject to enzymatic and/or microbial treatment in step a) is selected from one or more of unsorted municipal solid waste, centrally sorted municipal solid waste, source sorted municipal solid waste from households, municipal solid waste processed by shredding or pulping, organic fractions and paper rich fractions, Refuse-Derived-Fuel fractions.

In one embodiment of the method according to the present invention, the biodegradable material in waste subject to enzymatic and/or microbial treatment in step a) comprises a combination of one or more items selected from: food residues, paper, cardboard, and fines.

In one embodiment of the method according to the present invention, the waste subject to enzymatic and/or microbial treatment in step a) is sorted municipal solid waste not comprising items selected from one or more of the following: domestic appliances, glass, ceramics, batteries, newsprints, magazines, advertisements, books, plastics, fabrics, textiles, yard waste, electrical and electronic equipment, chemicals, pharmaceuticals, metals.

In one embodiment of the method according to the present invention, one or more of the following groups of items are removed from the waste prior to the enzymatic and/or microbial treatment in step a): leaves, grasses, wood, fabrics, stones, plastics, metals.

In one embodiment of the method according to the present invention, the waste subject to enzymatic and/or microbial treatment in step a) is selected from one or more of general industry waste fractions containing paper or other organic fractions, waste fractions from paper industry or recycling facilities, waste fractions from food and feed industry, waste fractions from the medicinal industry.

In one embodiment of the method according to the present invention, the waste subject to enzymatic and/or microbial treatment in step a) is selected from one or more of agriculture or farming, waste fractions from processes of sugar or starch rich products, contaminated or spoiled agricultural products not exploitable for food or feed purposes, manure, manure derived products.

In one embodiment of the method according to the present invention, the waste subject to enzymatic and/or microbial treatment in step a) is selected from one or more of waste fractions derived from municipal, county or state related or regulated activities, sludge from waste water treatment plants, fiber or sludge fractions from biogas processing, general waste fractions from the public sector containing paper or other organic fractions.

To summarize, it is shown herein that in order to keep the bioliquid production from waste in a steady state wherein both the enzymatic and/or microbial processes are active and the retention-time and accordingly cost are optimized, process water and optionally water from external sources can added to the bioreactor. This is surprising because the difference between using tap water (as is normally done in the combined enzymatic and microbial liquefaction of waste) and process water such as reject water obtained from an digestate which comprises a large amount of salts, other solubles and live microorganisms, was expected to be huge. However, the examples disclosed herein surprisingly shows that both the enzymatic activity and the activity of the microorganisms producing the valuable organic acids required as feed to for instance an AD biogas production is upheld in the bioreactor when process water is added to the bioreactor.

### Numbered Embodiments

Relevant embodiments of the current invention may also be found in the following section, termed “numbered embodiments”.

1. A method for continuous or batch processing of waste comprising:
a) subjecting waste to an enzymatic and/or microbial treatment in a bioreactor
b) subjecting the treated waste from step a) to one or more separation step(s), whereby a bioliquid and a solid fraction is provided;
c) subjecting said bioliquid and/or fraction to downstream processing providing process water;
d) adding the process water obtained from step c) and optionally water from an external water source to the bioreactor in step a).

2. Method according to embodiment 1, wherein the downstream processing in step c) providing said process water is selected from one or more of an anaerobic digestion process, washing of a solid waste fraction, evaporation and collection of bioliquid.

3. Method according to embodiment 1, wherein the process water is from an anaerobic digestion process and/or washing of a solid waste fraction.

4. Method according to the previous embodiments wherein, the pH of the process water obtained in step c) is adjusted to between 3.5 and 6 prior to step c).

5. Method according to the previous embodiments, wherein the downstream processing in step c) is an anaerobic digestion process providing reject water.

6. Method according to embodiment 5, wherein the pH of the reject water is adjusted to between 3.5 and 6 by addition of acid and/or by reducing the ammonium content.

7. Method according to embodiment 5 or 6 wherein the process water obtained from said anaerobic digestion process is subject to hygienization before being subjected to step 8. Method according to the previous embodiments, wherein process water is added to step a) in batches, such that pH in the reactor is between pH 3.5-6.

9. Method according to the previous embodiments, wherein the external water in step d) is selected from water obtained from natural sources such as rivers, lakes and ponds; water reservoirs; tap water, and any combination thereof.

10. Method according to the previous embodiments, wherein the filling volume of the bioreactor in step a) is larger than 10, 50, 100, 150, 200, 250, 300, 350, 400, 450 or 500 m³ during operation and wherein it is adapted to process more than 5, 10, 15, 20, 25, 30, 35, 40, 45 or 50 tons of waste per hour.

11. Method according to previous embodiments wherein said waste is selected from one or more of unsorted municipal solid waste, centrally sorted municipal solid waste, source sorted municipal solid waste from households, municipal solid waste processed by shredding or pulping, organic fractions and paper rich fractions, Refuse-Derived-Fuel fractions and municipal solid waste wherein the biodegradable material in said waste comprises a combination of one or more items selected from: food residues, paper, cardboard, and fines.

12. Method according to the previous embodiments wherein said enzymatic and/or microbial treatment in step a) is performed by adding enzymes, supplied in either native form or in form of microbial organisms giving rise to the expression of such enzymes, and/or by the bacteria present in the waste and optionally by adding standard, cultivated, or manipulated yeast, bacteria, or any other microorganism capable of producing biochemicals, ethanol, or biogas.

13. Method according to the previous embodiments wherein the treatment in step a) comprises contacting the waste with a live lactic acid bacteria concentration of at least 1.0×10⁶, 1.0×10⁷, 1.0×10⁸ or 1.0×10⁹ CFU/L.

14. Method according to the previous embodiments, wherein the treatment in step a) comprises adding microorganisms to the waste at a concentration of 1.0×10⁶, 1.0×10⁷, 1.0×10⁸, 1.0×10⁹ or 1.0×10¹⁰ CFU/L.

15. Method according to the previous embodiments wherein treatment step a) is performed at a temperature between 20 and 75° C., 30° C.and 70° C., 40° C. and 60° C., 45 and 55° C., or around 50° C.

16. Method according to the previous embodiments wherein the flow rate of the addition of process water and optionally water from an external source in step d) into the bioreactor in step a) is essentially constant and/or essentially proportional, to the amount of waste, having between 1:1 and 3:1 of water:waste proportion.

17. Method according to previous embodiments wherein said waste is selected from one or more of unsorted municipal solid waste, centrally sorted municipal solid waste, source sorted municipal solid waste from households, municipal solid waste processed by shredding or pulping, organic fractions and paper rich fractions, Refuse-Derived-Fuel fractions and municipal solid waste wherein the biodegradable material in said waste comprises a combination of one or more items selected from: food residues, paper, cardboard, and fines.

18. The method according to the previous embodiments, wherein said enzymatic and/or microbial treatment in step a) is performed by adding enzymes, supplied in either native form or in the form of microbial organisms giving rise to the expression of such enzymes; and by the bacteria present in the waste and optionally by adding standard, cultivated, or manipulated yeast, bacteria, or any other microorganism capable of producing biochemicals, ethanol, or biogas.

19. The method according to any one of the preceding embodiments, wherein the treatment in step a) is accomplished by one or more species of lactic acid producing bacteria, acetate-producing bacteria, propionate-producing bacteria, or butyrate-producing bacteria, including any combination thereof.

20. The method according to any one of the preceding embodiments, wherein the treatment step a) comprises contacting the waste with a live lactic acid bacteria concentration of at least 1.0×10⁶, 1.0×10⁷, 1.0×10⁸ or 1.0×10⁹ CFU/L.

21. The method according to any one of the preceding embodiments, wherein the treatment step a) comprises addition of cellulase activity by inoculation with one or more microorganism(s) that exhibits extracellular cellulase activity.

22. The method according to any one of the preceding embodiments, wherein the treatment step a) is performed at a temperature between 20 and 75° C., 30° C.and 70° C., 40° C. and 60° C., 45 and 55° C., or around 50° C.

23. The method according to any one of the previous embodiments, wherein the microbial treatment in step a) is performed by a microbial composition wherein the majority of the living microorganisms are lactic acid producing bacteria.

24. The method according to any one of the previous embodiments, wherein the process water is obtained from a downstream AD process and comprises methanogenic microorganisms from the anaerobic digestion.

25. The method according to any one of the previous embodiments, wherein process water is obtained from a downstream AD process and has not been subjected to a hygienization step prior to step d).

26. The method according to any one of the previous embodiments wherein said process water and optionally water from an external source is added to said bioreactor in step d) before and/or during the combined enzymatic and microbial treatment of the waste in step a).

27. The method according to any one of the preceding embodiments, wherein one or more carbohydrates, such as one or more carbohydrate(s) selected from poly-, oligo-, di-, or monosaccharide(s), including any combination thereof is added to the bioreactor in step a) in addition to adding said process water and optionally water from an external source.

28. The method according to any one of the preceding embodiments, wherein the flow rate of process water and optionally the flow rate of water from an external water source into the bioreactor in step d) is added regularly or irregularly.

29. The method according to any one of the preceding embodiments, wherein more than 1.0, 2.5, 5, 10, 15, 20, 25, 30, 35, 40, 45, 50, 55, 60, 65, 70, 75, 80, 85, 90, 95, or 98% (w/w) of the water added to said waste in step a) is process water obtained in step c) 30. The method according to any one of the preceding embodiments, wherein the ratio of process water obtained in step c) to water from an external source in step d) is in the range of 0.01-0.1; 0.1-0.25; 0.25-0.50; 0.50-1.0; 1.0-2.0; 2.0-4.0; 4.0-6.0; 6.0-8.0; 8.0-10; 10-20, 20-40; 40-60; 60-80; or 90-100.

31. The method according to any one of the preceding embodiments, wherein process water obtained in step c) has a DM content (w/w %) of 1.0 or more; 1.5 or more; 2.0 or more; 2.5 or more; 3.0 or more; 3.5 or more; 4.0 or more; 4.5 or more; 5.0 or more; 5.5 or more; 6.0 or more; 6.5 or more; 7.0 or more; 7.5 or more; or 8.0 or more.

32. The method according to any one of the preceding embodiments, wherein the process water obtained in step c) has a salt content (w/w %) of 1.0 or more; 1.5 or more; 2.0 or more; 2.5 or more; 3.0 or more; 3.5 or more; 4.0 or more; 4.5 or more; 5.0 or more; 5.5 or more; or 6.0 or more; 6.5 or more; 7.0 or more; 7.5 or more; or 8.0 or more.

33. The method according to any one of the preceding embodiments, wherein the process water obtained in step c) comprises salts comprising one or more of ammonium, nitrate, nitrite, phosphate, chloride, sodium, potassium, sulfate, iron, calcium, nickel, lead and zinc.

34. The method according to any of the preceding embodiments, wherein the process water is obtained from an AD process providing an digestate comprising one or more of the following elements: up to 3800 mg-N/kg-FW ammonia/ammonium; up to 4700 mg-N/kg-FW nitrogen; up to 280 mg-P/kg-FW phosphorus; up to 3300 mg/kg-FW water soluble chlorine; up to 3300 mg/kg-FW water soluble sodium; up to 2900 mg/kg-FW potassium; up to 430 mg/kg-FW sulphur; up to 590 mg/kg-FW iron: up to 6000 mg/kg-FW calcium; up to 3 mg/kg-FW nickel; up to 3 mg/kg-FW lead; up to 3 mg/kg-FW zinc.

35. The method according to any one of the preceding embodiments, wherein the filling volume of the bioreactor in step a) is larger than 10; 50; 100; 150; 200; 250; 300; 350; 400; 450; or 500 m3 during operation.

36. The method according to any one of the preceding embodiments, wherein the bioreactor in step a) is adapted to process more than 5; 10; 15; 20; 25; 30; 35; 40; 45; or 50 tons of waste/h.

37. The method according to any one of the preceding embodiments, wherein the waste, e.g. MSW, has a DM content in the range 10-90; 20-85; 30-80; 40-75; 50-70; or 55-65% (w/w); and/or around 10; 15; 20; 25; 30; 35; 40; 45; 50; 55; 60; 65; 70; 75; 80; 85; or 90% (w/w).

38. The method according to any of the preceding embodiment, wherein the DM content of the waste is measured or assessed (i) before entry into the bioreactor in step a); (ii) at the onset of said combined enzymatic and microbial treatment of the waste entering the bioreactor in step a); and/or (iii) before provision of the bioliquid obtained in step a) through one or more solid/liquid separation step(s).

39. The method according to any one of the preceding embodiments, wherein the process water is obtained from an AD process using of one or more anaerobic digester(s) comprising attachment means for microbial biofilms, such as a device comprising a carrier matrix, such as a digester disclosed in WO2016050893 or WO2017/174093.

40. The method according to any one of the preceding embodiments, wherein the waste comprises both biodegradable and non-biodegradable material.

41. The method according to any one of the preceding embodiments, wherein said waste is unsorted or sorted municipal solid waste (MSW).

42. The method according to any one of the preceding embodiments, wherein said waste is derived from or comprises any one or more of waste from household, industry, agriculture, farming, county, or state activities.

43. The method according to any one of the preceding embodiments, wherein said waste comprises 10-100% biodegradable material on a dry basis.

44. The method according to any one of the preceding embodiments, wherein said waste comprises 20-30% biodegradable material on a dry basis.

45. The method according to any one of the preceding embodiments, wherein said waste comprises 10-100% biodegradable material on a wet basis.

46. The method according to any one of the preceding embodiments, wherein said waste comprises 25-60% such as 35-50% biodegradable material on a wet basis.

47. The method according to any one of the preceding embodiments, wherein said waste is selected from one or more of unsorted municipal solid waste, centrally sorted municipal solid waste, source sorted municipal solid waste from households, municipal solid waste processed by shredding or pulping, organic fractions and paper rich fractions, Refuse-Derived-Fuel fractions.

48. The method according to any one of the preceding embodiments wherein the biodegradable material in said waste municipal solid waste comprises a combination of one or more items selected from: food residues, paper, cardboard, and fines.

49. The method according to any one of the preceding embodiments wherein said waste is sorted municipal solid waste not comprising items selected from one or more of the following: domestic appliances, glass, ceramics, batteries, newsprints, magazines, advertisements, books, plastics, fabrics, textiles, yard waste, electrical and electronic equipment, chemicals, pharmaceuticals, metals.

50. The method according to any one of the preceding embodiments, wherein one or more of the following groups of items are removed from the waste prior to the combined enzymatic and microbial treatment in step a): leaves, grasses, wood, fabrics, stones, plastics, metals.

51. The method according to any one of the preceding embodiments, wherein said waste is selected from one or more of general industry waste fractions containing paper or other organic fractions, waste fractions from paper industry or recycling facilities, waste fractions from food and feed industry, waste fractions from the medicinal industry.

52. The method according to any one of the preceding embodiments, wherein said waste is selected from one or more of agriculture or farming, waste fractions from processes of sugar or starch rich products, contaminated or spoiled agricultural products not exploitable for food or feed purposes, manure, manure derived products.

53. The method according to any one of the preceding embodiments, wherein said waste is selected from one or more of waste fractions derived from municipal, county or state related or regulated activities, sludge from waste water treatment plants, fiber or sludge fractions from biogas processing, general waste fractions from the public sector containing paper or other organic fractions.

54. The method according to any one of the preceding embodiments, wherein said waste is subjected to pre-treatment prior to step a).

55. The method according to embodiment 54, wherein said pre-treatment is one or more of: acid hydrolysis, steam explosion, oxidation, extraction with alkali, extraction with ethanol, sorting, shredding, pulping, pressure, size fractionation, bag opening, free fall mixing, stirring or rotation.

56. The method according to any of embodiments 54 to 55, wherein sorted or unsorted MSW is size fractionated into fractions, providing a fraction with a size range of e.g. 0 to 60 cm, and/or providing an oversize fraction (bulk refuse refraction), such as a fraction comprising waste with a size exceeding 60 or more cm.

57. The method according to any of the previous embodiments wherein said pre-treatment is a non-pressurised pre-treatment for up to 120 min with a temperature ranging between 60-110° C. and a steam admission of up to 2 kg/kg dry matter.

58. The method according to any of the previous embodiments wherein the waste with a dry matter content above 20% is processed mechanically, e.g. by free fall mixing while subjected to pre-treatment and/or to step a).

### EXAMPLES

### General Methods and Materials Used in Examples

This part describes the general methods and materials used for the examples presented in this application. If deviated from the general methods and materials, this will be specified in the example. A schematic overview of the waste treatment process and the recirculation of the process water is shown in FIG. 1a. An example of a downstream process is shown in FIG. 1b. In the following examples, the process water from a downstream process being recirculated into the bioreactor was reject water obtained from an AD process as shown in FIG. 1b.

### Preparation of Municipal Solid Waste (“Model MSW”) Model Substrate

In the below examples wherein MSW model substrate was used, 50 kg “model MSW” was prepared in order to mimic the composition of real municipal solid waste. The model substrate was prepared essentially as disclosed in e.g. WO2016/030480.

The model substrate consisted of 3 fractions:
5-41% vegetable fraction (cf. Table 1)
13% protein/fat fraction (animal origin) (cf. Table 2) and
46% cellulosic fraction (cf. Table 3).

TABLE 1
Vegetable fraction of MSW model substrate
(for production of 50 kg model MSW)

| | % of vegetable fraction | Weight in kg |
|---|---|---|
| Onions | 7.5 | 1.538 |
| Carrots | 7.5 | 1.538 |
| Potatoes | 6.3 | 1.292 |
| Leeks | 4.4 | 0.902 |
| Salad | 3.2 | 0.656 |
| Frozen peas | 4.4 | 0.902 |
| Tomatoes | 3.2 | 0.656 |
| Cucumber | 3.2 | 0.656 |
| Red cabbage | 3.2 | 0.656 |
| Mushrooms | 3.2 | 0.656 |
| Oatmeal | 3.2 | 0.656 |
| Cornflakes | 4.4 | 0.902 |
| Apples, bananas, oranges, | 4.4 | 0.902 |
| lemons, pears | | |
| Remoulade | 3.2 | 0.656 |
| Ketchup | 3.2 | 0.656 |
| Rye bread | 6.3 | 1.292 |
| White bread | 9.5 | 1.948 |
| Cake | 3.2 | 0.656 |
| Flowers | 1 | 0.205 |
| Coffee grounds | 1 | 0.205 |
| Boiled rice | 3 | 0.615 |
| Boiled pasta | 3 | 0.615 |
| Celery | 3 | 0.615 |
| Brussels sprout, kale | 3.5 | 0.718 |
| Beans, lentils | 1 | 0.205 |
| Broccoli | 0.25 | 0.051 |
| Cauliflower | 0.25 | 0.051 |
| Green beans | 0.25 | 0.051 |
| Pineapple | 0.15 | 0.031 |
| SUM | 99.9 | 20.480 |

TABLE 2
Protein/fat fraction (animal origin) of MSW model substrate
(for production of 50 kg model MSW)

| | % of protein/fat fraction | Weight |
|---|---|---|
| | (animal origin) | in kg |
| Roasted pork | 6 | 0.388 |
| Dog/cat food | 6 | 0.388 |
| Liver pate | 5 | 0.323 |
| Salami | 5 | 0.323 |
| Mortadella | 5 | 0.323 |
| Liver sausage | 5 | 0.323 |
| Ham | 5 | 0.323 |
| Rolled sausage | 5 | 0.323 |
| Hotwings | 10 | 0.647 |
| Spareribs | 5.5 | 0.356 |
| Fat of animal origin with spices | 10 | 0.647 |
| Cheese | 4 | 0.259 |
| Ymer (soured whole milk) | 10 | 0.647 |
| Eggs | 3 | 0.194 |
| Shrimps | 3 | 0.194 |
| Herring | 5 | 0.323 |
| Ground beef | 1.5 | 0.097 |
| Chicken whole | 2 | 0.129 |
| Chicken filet | 4 | 0.259 |
| SUM | 100 | 6.467 |

TABLE 3
Cellulose fraction of MSW model substrate
(for production of 50 kg model MSW)

| | % of cellulose fraction | Weight in kg |
|---|---|---|
| Milk cartons | 30.0 | 6.9 |
| Newspapers | 8.0 | 1.8 |
| Magazines | 2.8 | 0.6 |
| Advertising materials | 9.7 | 2.2 |
| Phone books | 0.7 | 0.2 |
| Printing paper | 2.2 | 0.5 |
| Gift wrapping | 6.2 | 1.4 |
| Cardboard | 9.8 | 2.3 |
| Paper towel | 22.5 | 5.2 |
| Cotton pads | 1.7 | 0.4 |
| Wood | 1.2 | 0.3 |
| Textiles (dishtowels) | 5.3 | 1.2 |
| SUM | 100 | 23.0 |

### Enzymes

Cellic® CTec3™ was purchased from Novozymes A/S. Cellic® CTec3™ is a state-of-the-art cellulase and hemicellulase complex comprising GH61 compounds and beta-glucosidases. In addition, another enzyme composition with enzymatic activities similar to CTec3 was tested.

The amount of enzymatic composition to be added to the waste for sufficient enzymatic treatment was determined by a solubilization test, as in the definition “Solubilization test” described above.

It is believed that similar results would be obtained using other commercially available cellulase preparations optimized for biomass conversion, such as Cellic® CTec2™ (Novozymes A/S) and ACCELLERASE 1500™ (Genencor). Cellic® CTec2 and Cellic® CTec3 as well as ACCELLERASE® 1500 each contains endoxylanase activity over 200 U/g, xylosidase activity at levels over 85 U/g, B-L-arabinofuranosidase activity at levels over 9 U/g, amyloglucosidase activity at levels over 15 U/g, and alpha-amylase activity at levels over 2 U/g according to our assessment. Simpler isolated cellulase preparations may also be effectively used to practice methods of the invention.

### Reject Water

Reject water was provided as follows. As part of a feasibility study Dutch household waste was transported to Copenhagen and processed at the Renescience demonstration facility at Amager, Denmark. The waste was entered into a bioreactor with a length of 16 m and a diameter of 2.5 m resulting in a volume of 78.5 m³ for combined enzymatic and microbial treatment at 50° C. with a total load (waste+water) of 13.5 tons. The retention time in the bioreactor was 20.6 hours, the tap-water: MSW ratio was 1.9, and the enzyme dose was 0.97% w/w (Cellic® CTec3 purchased from Novozymes A/S). The produced bioliquid underwent treatment in a CSTR (Continued Stirred Reactor) at the Technical University of Denmark. The pilot-scale CSTR was a mobile SEAD anaerobic digester provided by VEOLIA/Biothane™. The SEAD anaerobic digester was a 500 Liter tank (Ø 0.6×2.1 m) where the biological anaerobic digestion took place. The contents of the AD-tank were mixed due to the reinjection of the biogas at the bottom of the reactor (230 L/h), and a recirculation pump (2-6 m3/h). The recirculated fraction of the digestate was reinjected through a nozzle, which applied shear forces and facilitated the disintegration of particulate matter. The Biothane SEAD digester was equipped with an internal vertical tubing from top to bottom of the digester. The inner tubing was perforated at the bottom and allowed circulation of digester content to spread throughout the digester tank.

The SEAD digester was equipped with on-line monitoring of pH and temperature and was connected to the feeding pump and the sampling outlet. The digestate was discharged by overflow to a settling tank (Ø 0.25×0.8 m) where sludge and water were passively separated. The lower fraction of the digestate in the settler tank was recycled back to the main digester tank, the supernatant was discharged by overflow. The feedstock was stored in a 100 Liter tank, which was constantly agitated. A 5 mm mesh prevented the introduction of too large particles into the feed tank.

The resulting digestate from the SEAD was stored frozen, then thawed and centrifugated to allow separation of solid digestate from the remaining reject water on a Thermo Scientific SL40R centrifuge (4700 rpm, 15 minutes, 4C) to precipitate most of the suspended solids like cells, remaining fibers and inorganics.

The pH of the thus obtained reject water was 8.35 and the alkalinity total was determined by manual titration of 50 ml sample of reject water with 5 mL of 1 M HCl to bring the pH of the resulting solution below 4. In industrial scale, the process should operate under conditions where the digestate and/or a fraction thereof such as reject water is re-circulated to the bioreactor. This will result in a higher concentration of salts and could also increase the alkalinity of the reject water. In order to obtain a reject water with higher salt concentrations a suitable amount of reject water were placed in a heated open vessel until the volume of the reject water had been reduced to about half of the initial volume. This was the reject water that was used in the following examples unless otherwise mentioned in the examples 1 to 5.

### Example 1: Liquefaction of MSW Model Substrate

### Model System for Waste Liquefaction

For the Lab scale experiments in Examples 1, 2, 3, 4, and 5, fermentations were performed in Sartorius™ 1 L or 5 L fermenters equipped with mechanical stirrer, heating mantle, cooling tower for exhaust gases and pH-meter. The filling degree of the fermenter comprising MSW model substrate, enzymes and water and/or reject water was approximately 80-90% (v/v). The temperature was kept at 50° C. using an electrical heating mantle and the stirring was 600 rpm except for the first hour where more vigorous stirring was used to initiate the solubilization (1200 rpm). The added components (solids and liquids) were not pre-heated prior to addition into the fermenter.

### Sample Acquisition

Samples of about 10 mL were withdrawn from the fermenters as indicated in the tables below and subjected to centrifugation to remove solids (3600 rpm for 10 minutes). The supernatant was subsequently heat-treated to inactivate the enzyme (100° C., 10 minutes). The samples were subsequently subjected to a second centrifugation (4000 rpm for 10 minutes) and filtered through a 0.2 μm PTFE filter (Phenex™) and subsequently subjected to HPLC analysis.

### HPLC Analysis

The concentrations of relevant compounds such as sugars, organic acids and ethanol were measured using an UltiMate 3000 HPLC (Thermo Scientific Dionex™) equipped with a refractive index detector (Shodex(R) RI-101) and a UV detector at 250 nm. The separation was performed on a Rezex RHM monosaccharide column (PhenomenexTM) at 80° C. with 5 mM H₂SO₄ as eluent at a flow rate of 0.6 ml/minute. The results were analyzed using the Chromeleon software program (Dionex™).

### Standard Liquefaction of MSW Model Substrate Using De-Ionized Water

Liquefaction of MSW model substrate was carried out using 166 g MSW model substrate, 1 L de-ionized water and 4 g Cellic® CTec3 (Novozymes A/S). First water and MSW model substrate was heated to 50° C. while stirring (300 rpm). Upon reaching the desired temperature, Cellic® Ctec3 was added (4 g) and the stirring increased to 1200 rpm for 5 minutes and thereafter to 900 rpm for 1 hour. After 1 hour stirring was decreased to 600 rpm until the end of the experiment. The content of glucose, xylose, lactate, acetate was measured using HPLC at time points 16, 24, 40, 48 and 64 as shown in Table 4.

TABLE 4
Data obtained using 166 g MSW model substrate,
4 g Cellic® CTec3 and de-ionized water (all in g/L).

| Time (h) | Glucose | Xylose | Lactate | Acetate | pH |
|---|---|---|---|---|---|
| 16 | 14.1 | 1.6 | 4.5 | 0.2 | 4.91 |
| 24 | 14.1 | 1.9 | 6.4 | 0.2 | 4.77 |
| 40 | 14.2 | 2.2 | 7.5 | 0.3 | 4.60 |
| 48 | 15.5 | 2.5 | 8.7 | 0.4 | 4.57 |
| 64 | 13.1 | 2.3 | 8.3 | 0.5 | 4.49 |

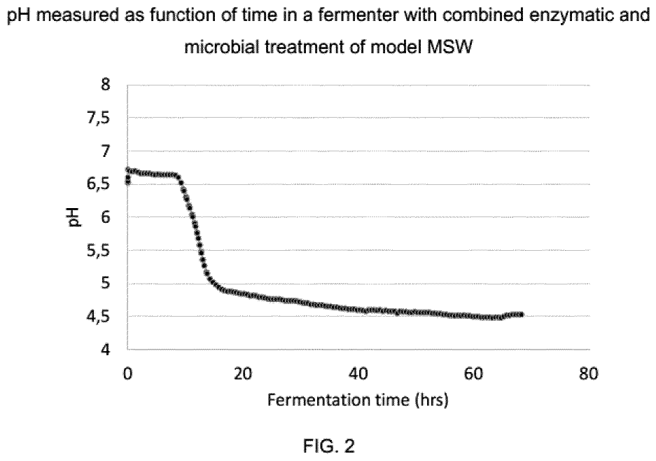

FIG. 2 shows pH measured in the fermenters as a function of time. There is a clear acidification during the first 24 hours which is mainly due to the formation of lactic acid. After about 24 hours pH has dropped to about 4.8 and the production rate of lactic acid had decreased significantly (1.9 g/L generated in 8 h (16-24) vs. 2.3 g/L generated in 24 h (24-48). After 48 h the production of lactate halts and the pH was 4.57. After 64 hours the pH reached 4.49 and the concentrations of glucose and lactic acid were 13.1 g/L and 8.3 g/L, respectively. We decided to investigate if it was possible to increase the production of lactic acid by continuously neutralizing the formed lactic acid using reject water (cf. (B) and (C) below) i.e. increasing the pH in the bioreactor by adding alkaline reject water.

### Example 2: Effect of Adding Reject Water to the Bioreactor with and without Prior pH Adjustment

The same experimental set-up and conditions as in Example 1 was applied. However, in order to determine the effect of reject water with a pH about 8.3 (prepared as described in the introductory section of the examples) on the fermentation of MSW model substrate, a series of experiments using reject water instead of de-ionized water with neutral pH were performed. One fermenter was run using reject water (1 L), MSW model substrate (166 g) and 4 g Cellic® Ctec3. In three other fermenters, the reject water was titrated prior to entry into the fermenter to pH 7, pH 6, or pH 5, respectively using acetic anhydride, which is assumed to be hydrolyzed in the solution to acetic acid.

TABLE 5
Data obtained using 4 g Cellic® Ctec3 and reject water (all in g/L).

| Time (h) | Glucose | Xylose | Lactate | Acetate | pH |
|---|---|---|---|---|---|
| 0.5 hr | 1.8 | 1.2 | 0.1 | 0.1 | 7.29 |
| 16.5 | 0.9 | 1.1 | 5.1 | 0.7 | 6.67 |
| 24.5 | 1.4 | 0.3 | 3.0 | 0.5 | 6.31 |
| 41.5 | 2.0 | 0.5 | 4.3 | 0.7 | 5.99 |
| 48.5 | 4.4 | 1.0 | 5.9 | 1.2 | 5.80 |
| 64.5 | 3.7 | 1.2 | 7.3 | 1.3 | 5.48 |
| 72.5 | 3.6 | 1.2 | 7.4 | 1.3 | 5.41 |
| 88.5 | 3.0 | 1.3 | 8.3 | 1.5 | 5.28 |
| 161.5 | 0.2 | 1.1 | 12.4 | 1.1 | 5.00 |

TABLE 6
Data obtained using 4 g Cellic® Ctec3 and
reject water pH adjusted to 7.0 (all in g/L).

| Time (h) | Glucose | Xylose | Lactate | Acetate | pH |
|---|---|---|---|---|---|
| 0.5 | 4.3 | 2.0 | 0.1 | 0.6 | 7.03 |
| 16.5 | 4.3 | 1.3 | 2.5 | 1.8 | 6.67 |
| 24.5 | 2.1 | 0.5 | 2.2 | 1.0 | 6.07 |
| 41.5 | 2.8 | 1.0 | 11.2 | 2.1 | 5.23 |
| 48.5 | 2.2 | 1.1 | 12.0 | 2.1 | 5.11 |
| 64.5 | 1.0 | 1.3 | 13.9 | 2.1 | 4.90 |
| 72.5 | 0.2 | 1.3 | 14.0 | 2.0 | 4.89 |
| 88.5 | 0.2 | 1.4 | 14.7 | 2.0 | 4.84 |
| 161.5 | 1.0 | 1.6 | 15.5 | 2.4 | 4.85 |

TABLE 7
Data obtained using 4 g Cellic® Ctec3 and reject water pH adjusted to 6.0 (all in g/L).

| Time (h) | Glucose | Xylose | Lactate | Acetate | pH |
|---|---|---|---|---|---|
| 0.5 | 8.7 | 3.0 | 0.1 | 3.5 | 6.14 |
| 16.5 | 12.2 | 2.1 | 6.3 | 3.8 | 5.64 |
| 24.5 | 6.3 | 1.2 | 5.6 | 2.2 | 4.95 |
| 41.5 | 10.8 | 2.4 | 12.1 | 3.9 | 4.64 |
| 48.5 | 10.9 | 2.4 | 12.1 | 3.9 | 4.62 |
| 64.5 | 11.1 | 2.5 | 11.9 | 4.0 | 4.64 |
| 72.5 | 11.0 | 2.5 | 11.9 | 3.7 | 4.65 |
| 88.5 | 10.8 | 2.5 | 12.0 | 3.8 | 4.65 |

TABLE 8
Data obtained using 4 g Cellic® Ctec3 and
reject water pH adjusted to 5.0 (all in g/L).

| Time (h) | Glucose | Xylose | Lactate | Acetate | pH |
|---|---|---|---|---|---|
| 0.5 hr | 10.1 | 3.3 | 0.1 | 6.1 | 5.48 |
| 16.5 | 17.3 | 4.3 | 0.3 | 6.8 | 5.59 |
| 24.5 | 8.1 | 1.9 | 2.2 | 3.6 | 5.15 |
| 41.5 | 14.8 | 2.8 | 8.1 | 7.0 | 4.86 |
| 48.5 | 14.6 | 2.9 | 8.2 | 7.1 | 4.86 |
| 64.5 | 14.5 | 3.0 | 8.1 | 7.3 | 4.87 |
| 72.5 | 14.1 | 2.9 | 7.7 | 6.6 | 4.90 |
| 88.5 | 14.2 | 2.9 | 7.7 | 6.7 | 4.94 |

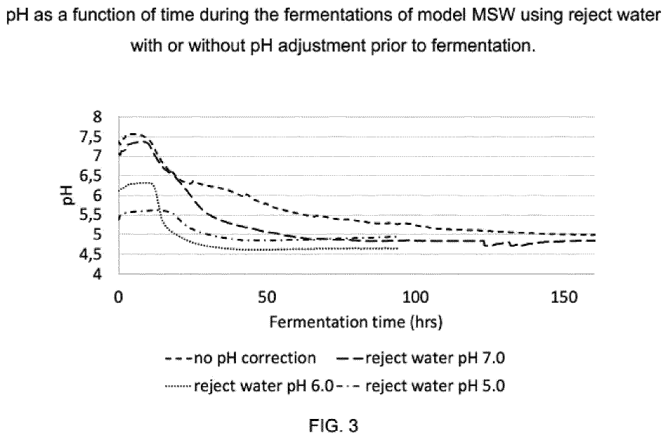

FIG. 3 shows the pH during the fermentations of MSW model substrate using reject water with or without pH adjustment prior to fermentation.

When using reject water without pH adjusting the production of lactic acid is slow and it takes about 60 hours before reaching pH 5.5. This is believed to be caused by a lower enzymatic activity at higher pH which in turn may generate less glucose for microbial growth, thus delaying the production of lactic acid. By pH adjusting the reject water the process is accelerated although in all cases it is slower than with tap water (neutral pH) cf. Example 1.

### Example 3: Effect of pH Upon Addition of Reject Water

Reject water (prepared as described in the above introductory section to the Examples) was added portion-wise to the bioreactor.

The fermentation was started using 250 g of reject water, 1.0 g Cellic® Ctec3 and 41 g MSW model substrate. The initial pH in the 1L Sartorius™ fermentor was >7. After 26 hours pH had decreased below 5.0 (this is termed time=0 hours). HPLC analysis showed both glucose (5.2 g/L) and lactate (6.7 g/L) present at time=0 hours. Reject water, Cellic® Ctec3 and MSW was added at various time points (indicated as the number of hours after time=0 hours) as described in Table 9 below. At time=15 hours the concentration of lactate was 13.1 g/L and glucose 4.1 g/L, respectively. At time=39 hours the concentration of lactic acid was 14.3 g/L and glucose 4.2 g/L, respectively.

TABLE 9
outline of MSW, reject water and CTec3 addition at time 0, 15 and 39
hours and corresponding pH values measured in the fermenter

| Time (hours after | pH before | Amount of MSW model | pH after |
|---|---|---|---|
| time = 0) | addition* | substrate, reject water | addition ** |
| | | and CTec3 | |
| 0 | < 5 | 41 g MSW model substrate | > 7 |
| | | 250 ml reject water | |
| | | 1 g Cellic Ctec3™ | |
| 15 | < 5 | 41 g MSW model substrate | > 7 |
| | | 250 ml reject water | |
| | | 1 g Cellic Ctec3™ | |
| 39 | < 5 | | |

*pH measured at the indicated time just before addition of MSW model substrate, reject water and CTec3TM
**pH measured at the indicated time just after addition of MSW model substrate, reject water and CTec3TM

The experiment shows that several smaller additions of reject water could be a faster way to achieve the acidification compared to a single addition of a large volume of reject water. We believe the faster acidification was achieved by adding smaller additions of reject water and is the result of mainly two factors: 1) there is already an established soluble producing community when the reject water is added. 2) the presence of bioliquid with low pH limits the pH increase due to the addition of the reject water, which in turn allows the enzymes to function more efficiently in the conversion of the added MSW. Accordingly, repetitive pH adjustments of the fermenter after appropriate conditions have been established are beneficial for the ability of the system to return to a state with low pH and a microbial community capable of producing desired solubles.

### Example 4: Addition of Reject Water with pH 8.3

The fermentation was started using 250 g of reject water, 1.0 g Cellic® Ctec3 and 41 g MSW model substrate. The initial pH in the 1 L Sartorius™ fermenter was >7. After 26 hours, the pH was below 5.0. Then pH control was set to pH=6.0 and reject water with a pH of 8.3 that was obtained as described in the introductory section to the Examples was automatically pumped into the system to continuously keep pH at 6.0. After 24 hours, the addition of reject water automatically ceased because the pH did not drop below 6, assumingly because there was no more sugar available for the microbial conversion. A total of 433 mL of reject water had been added during the first 24 h of this experiment. Then 1.0 g Cellic® Ctec3 and 41 g MSW model substrate were added. After 30 h an additional 464 mL of reject water had been added automatically in order to keep the pH constant.

The experiment shows that continuous addition of reject water provides the benefit of maintaining pH of the reaction mixture in the optimal range (pH 4.0-6.0) for both enzymatic degradation and production of solubles.

From the amount of MSW model substrate (41 g) about 6 g of solubles is expected to be produced which corresponds to 0.070 moles when the soluble is lactic acid. For the reject water, a titration indicated a concentration of about 0.1 M which corresponds to 700 mL. In this experiment, we used a total of 897 mL reject water. This indicates that there is a direct correlation between the amount of MSW processed in the reaction and the volume of reject water added. Obviously, this correlation is dependent both on the content of available sugar in the MSW (i.e. food waste and cellulosic material) as well as the alkalinity of the reject water used.

### Example 5: Modelling a Continuous Process by Sequential Removal of Bioliquid and Waste and Addition of Aliquots of Reject Water, MSW and Enzyme

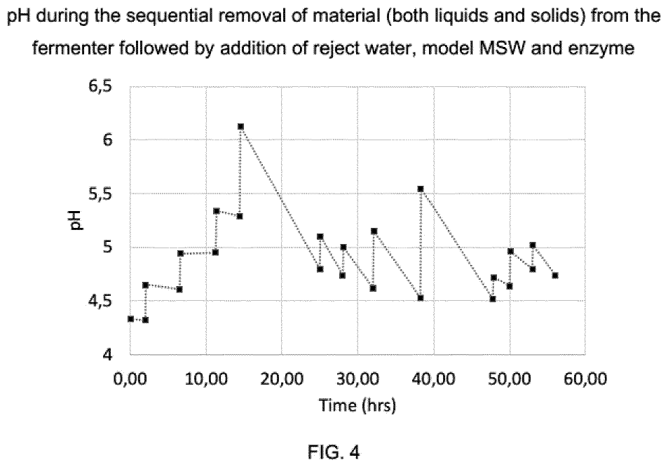

The fermentation was started in a 5 Liter fermenter with 3 Liter de-ionized water, 500 g MSW model substrate and 12 g Cellic Ctec3™. The next day pH had dropped to 4.3 and the concentration of glucose was 8.0 g/L and lactate 8.8 g/L, respectively. This is indicated as time=0 hours (cf. FIG. 4). Material (both liquids and solids) was removed from the fermenter at various time points after time=0 and replaced with MSW model substrate, reject water and Cellic® Ctec3 as listed in Table 10 below.

TABLE 10
outline of MSW/glucose, reject water and CTec3 addition at various time points and
corresponding pH values measured in the fermenter.

| | | Amount of material | Amount of model | |
|---|---|---|---|---|
| Time (hours after | pH before | removed from the | MSW/glucose, reject | pH after |
| time = 0) | addition* | fermentor (g) | water and CTec3 | addition** |
| 2 | 4.3 | 750 | 83 g MSW model substrate | 4.6 |
| | | | 500 ml reject water | |
| | | | 2 g Cellic Ctec3™ | |
| 6.5 | 4.6 | 500 | 83 g MSW model substrate | 4.9 |
| | | | 500 ml reject water | |
| | | | 2 g Cellic Ctec3™ | |
| 11.25 | 4.9 | 500 | 83 g MSW model substrate | 5.34 |
| | | | 500 ml reject water | |
| | | | 2 g Cellic Ctec3™ | |
| 14.5 | 5.29 | 1000 | 166 g MSW model | 6.1 |
| | | | substrate | |
| | | | 500 ml reject water | |
| | | | 4 g Cellic Ctec3™ | |
| 24.5 | 4.8 | 500 | 83 g MSW model substrate | 5.1 |
| | | | 500 ml reject water | |
| | | | 2 g Cellic Ctec3™ | |
| 27.5 | 4.74 | 500 | 83 g MSW model substrate | 4.81 |
| | | | 500 ml reject water | |
| | | | 2 g Cellic Ctec3™ | |
| 31.5 | 4.62 | 500 | 166 g MSW model | 5.15 |
| | | | substrate | |
| | | | 1000 ml reject water | |
| | | | 4 g Cellic Ctec3™ | |
| 37.5 | 4.53 | 1500 | 250 g | 5.55 |
| | | | MSW model | |
| | | | substrate | |
| | | | 1500 ml reject water | |
| | | | 4 g Cellic Ctec3™ | |
| 47.5 | 4.52 | 500 | 83 g MSW model substrate | 4.72 |
| | | | 500 ml reject water | |
| | | | 2 g Cellic Ctec3™ | |
| 49.5 | 4.68 | 500 | 83 g MSW model substrate | 4.96 |
| | | | 500 ml reject water | |
| | | | 2 g Cellic Ctec3™ | |
| 52.5 | 4.8 | 0 | 83 g glucose | 5.02 |
| | | | 500 ml reject water | |
| | | | 2 g Cellic Ctec3™ | |
| 55.5 | 4.74 | | | |

*pH measured at the indicated time just before addition of MSW model substrate, reject water and CTec3TM
**pH measured at the indicated time just after addition of MSW model substrate, reject water and CTec3TM

The fact that pH continued to increase until time=14.5 hours without a significant pH drop between the new additions of reject water shows that the microbial conversion of glucose to inter alia lactic acid was very slow, which in turn suggest that the soluble producing microbial population has not been established.

The pH value at 47.5 hours indicates that at such low pH (4.72) the population of soluble producing bacteria again has diminished and therefore the expected decrease in pH is very slow.

The data point at 52.5 hours and the following rapid decrease in pH shows that the soluble producing microbial community has now increased in size again and the system is capable of neutralizing the reject water rapidly.

We surmised that the MSW model substrate could be replaced by a more direct source of glucose. This could be important in cases where the amount of reject water is large but the amount of waste that can be added to the reactor is limited or the waste has a low content of organics. At time=52.5 at pH 4.80 we tested addition of 20 g of glucose together with 500 mL reject water. After three hours the pH valued had dropped to 4.74.

### Example 6: Fermentation of MSW Model Substrate in a Rotating Horizontal Reactor with Addition of Reject Water

An enzyme composition having similar enzymatic activities to Cellic®CTec3 was purchased from Novozymes A/S and stored at −20° C. The enzymes were thawed prior to use. Superfloc C498HMW was purchased from Kemira. MSW model substrate was prepared as described in the introductory section to the Examples. Reject water was obtained from a large-scale waste-treatment plant comprising 2500 m³ intake tank, four 4500 m³ AD digesters, one 2500 m³ post storage tank at the Northwich Renescience plant on Nov. 16, 2017. The supernatant of the reject water obtained after anaerobic digestion of food waste (naturally pre-hydrolyzed, approx. 25% dry matter, 90% of the dry matter was convertible) followed by flocculation using a 0.3% solution of Superfloc C498HMW polymer (polymer flow 1220 L/h with 23 m³/h feed) and decantation using decanter centrifuges without any additional heat treatment at the anaerobic digestion system.

A stainless-steel rotating horizontal reactor (total volume 63 L, length 2 m) was filled with MSW model substrate (2 kg), tap water (5 L) and an enzyme composition having similar enzymatic activities to Cellic®CTec3 purchased from Novozymes A/S (32 g) in tap water (1 L). The mixture was mixed at 50° C. under constant rotation (4 rpm). After 48 h, tap water (3 L), MSW model substrate (1 kg) and a solution of an enzyme composition having similar enzymatic activities to Cellic®CTec3 purchased from Novozymes A/S (16 g) in tap water (400 ml) were added and the mixing was continued for 24 h. MSW model substrate (1 kg), reject water (3 L) and a solution of an enzyme composition having similar enzymatic activities to Cellic®CTec3 purchased from Novozymes A/S (16 g) in tap water (400 mL) were subsequently added and the mixing was continued for 24 h. Then, 10 kg of the reactor content were removed through the outfeeder (located opposite to the infeed end of the reactor). Thereafter, MSW model substrate (1.5 kg), reject water (4 L) and a solution of an enzyme composition having similar enzymatic activities to Cellic®CTec3 purchased from Novozymes A/S (24 g) in tap water (400 mL) were added to the reactor and the mixing was continued for 93 h. The progress of the fermentation was monitored by inline pH measurements and HPLC analysis to determine the concentration of glucose, xylose, arabinose, lactate, acetate and ethanol in the samples taken from the outfeeder at the time-points shown in the below Table 11.

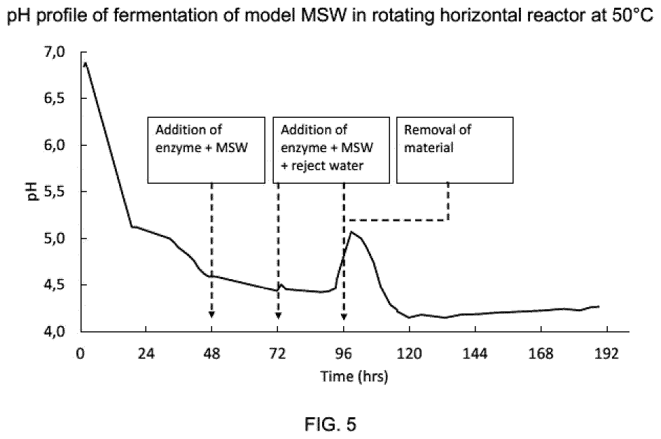

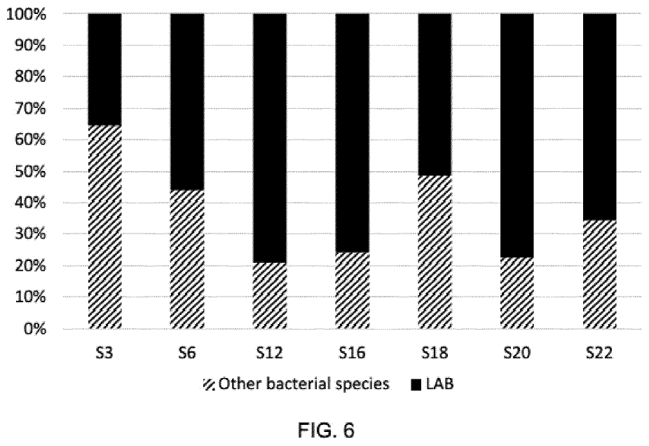

FIG. 5 shows the pH profile of the fermentation of MSW model substrate in the rotating horizontal reactor at 50° C. (pH probe was mounted approx. 1.75 m away from the infeed end of the reactor).

TABLE 11
Concentration (in g per kg of dry matter) of selected
compounds formed during the fermentation of MSW model
substrate in rotating horizontal reactor at 50° C.

| Sample | | | | | | |
|---|---|---|---|---|---|---|
| ID | Time (h) | Glucose | Xylose | Arabinose | Lactate | Acetate |
| S1 | 0.67 | 39.80 | 4.60 | 0.00 | 3.72 | 2.57 |
| S2 | 1.25 | 39.52 | 4.65 | 0.00 | 3.65 | 2.52 |
| S3 | 1.75 | 39.89 | 35.65 | 0.00 | 3.66 | 2.54 |
| S4 | 2.75 | 38.86 | 33.70 | 0.00 | 3.53 | 2.42 |
| S5 | 18.75 | 23.86 | 25.74 | 0.00 | 34.62 | 7.54 |
| S6 | 20.25 | 23.85 | 25.90 | 0.00 | 41.27 | 8.15 |
| S7 | 24.25 | 22.74 | 24.55 | 0.00 | 51.83 | 9.94 |
| S8 | 43.25 | 25.77 | 22.70 | 0.00 | 92.33 | 16.94 |
| S9 | 44.00 | 30.89 | 23.34 | 0.00 | 94.56 | 13.58 |
| S10 | 45.75 | 37.03 | 24.35 | 0.00 | 96.78 | 14.23 |
| S11* | 48.00 | 45.98 | 27.73 | 0.00 | 108.21 | 15.62 |
| S12 | 49.75 | 48.65 | 27.74 | 0.00 | 106.77 | 15.65 |
| S13 | 50.50 | 51.19 | 28.68 | 0.00 | 109.44 | 15.57 |
| S14 | 66.25 | 64.03 | 26.14 | 0.00 | 113.91 | 15.91 |
| S15 | 69.92 | 66.17 | 26.95 | 0.00 | 119.39 | 16.70 |
| S16** | 72.50 | 65.99 | 26.65 | 0.00 | 117.50 | 16.86 |
| S17 | 74.50 | 66.97 | 26.81 | 0.00 | 116.45 | 16.34 |
| S18*** | 90.50 | 78.59 | 32.53 | 1.46 | 128.12 | 16.47 |
| S19 | 98.75 | 61.83 | 35.09 | 1.51 | 159.26 | 14.54 |
| S20 | 162.75 | 28.48 | 30.70 | 1.34 | 218.21 | 16.68 |
| S21 | 169.58 | 32.76 | 31.09 | 1.37 | 220.66 | 17.23 |
| S22 | 189.25 | | | | | |

*After 48 h, tap water (3 L), MSW model substrate (1 kg) and a solution of an enzyme composition having similar enzymatic activities to Cellic ®CTec3 purchased from Novozymes A/S (16 g) in tap water (400 mL) were added
**After 72 h, MSW model substrate (1 kg), reject water (3 L) and a solution of an enzyme composition having similar enzymatic activities to Cellic ®CTec3 purchased from Novozymes A/S (16 g) in tap water (400 mL) were added
***After 96 h, 10 kg of the reactor content were removed and MSW model substrate (1.5 kg), reject water (4 L) and a solution of an enzyme composition having similar enzymatic activities to Cellic ®CTec3 purchased from Novozymes A/S (24 g) in tap water (400 mL) were added.

The addition of reject water (up to 56 vol. %) did not have a negative influence on the fermentation process that had been started using tap water. This is demonstrated by the continuous decrease of pH and the increase of lactate and sugars concentration after the addition of reject water.

### Example 7: Determination of Microflora

The samples listed in the table 12 below were the samples that were obtained from the mini reactor in Example 6. The samples were analyzed using the DNeasy® PowerSoil® Kit purchased from QIAGEN. The Quick-Start Protocol from June 2016 provided by the manufacturer QIAGEN was followed.

TABLE 12

| | | Duration | Conc. of | | Conc. of |
|---|---|---|---|---|---|
| | | after | | | purified |
| | | start of | purified | Type of | DNA |
| Sample | Date of | experiment | DNA 1st | index | 2nd PCR |
| ID | sample | [h] | PCR [ng/ul] | used | [ng/pl] |
| S3 | 17-11-2017 | 1.75 | 2 | S505/727 | 8.60 |
| S6 | 28-11-2017 | 20.25 | 3.4 | S506/727 | 10.00 |
| S12* | 29-11-2017 | 49.75 | 1.5 | S507/728 | 10.60 |
| S16** | 30-11-2017 | 72.5 | 2.4 | S508/728 | 12.70 |
| S18*** | 01-12-2017 | 90.5 | 4.7 | S510/728 | 8.50 |
| S20 | 04-12-2017 | 162.75 | 4 | S511/728 | 9.22 |
| S22 | 05-12-2017 | 189.25 | 2 | | 4.52 |

DNA purification, 1^{st} PCR, and 2^{nd} PCR conducted on 12-12-2017, 13-12-2017, and 14-12-2017, respectively.
*After 48 h, tap water (3 L), MSW model substrate (1 kg) and a solution of an enzyme composition having similar enzymatic activities to Cellic®CTec3 purchased from Novozymes A/S (16 g) in tap water (400 mL) were added
**After 72 h, MSW model substrate (1 kg), reject water (3 L) and a solution of an enzyme composition having similar enzymatic activities to Cellic®CTec3 purchased from Novozymes A/S (16 g) in tap water (400 mL) were added
*** After 96 h, 10 kg of the reactor content were removed and MSW model substrate (1.5 kg), reject water (4 L) and a solution of an enzyme composition having similar enzymatic activities to Cellic®CTec3 purchased from Novozymes A/S (24 g) in tap water (400 mL) were added.

### DNA Purification:

0.25 g of sample was added to a PowerBead Tube (QIAGEN). The tube was gently vortexed and mixed. A volume of 60 μl of solution C1 was added and inverted several times or vortexed briefly. The PowerBead Tubes were secured horizontally using a vortex Adapter tube holder. The tubes were vortexed at maximum speed for 10 min. Tubes were centrifuged at 10,000×g for 30 s. The supernatant was transferred to a clean 2 ml collection tube. 250 μl of solution C2 was added and vortexed for 5 s. Incubation was done at 4° C. for 5 min. The tubes were centrifuged for 1 min at 10,000×g. Avoiding the pellet, up to 600 μl of supernatant was transferred to a clean 2 ml collection tube. 200 μl of Solution C3 was subsequently added and vortexed briefly. Incubation was done at 4° C. for 5 min. The tubes were centrifuged for 1 min at 10,000×g. Avoiding the pellet, up to 750 μl of supernatant was added to a clean 2 ml collection tube. The solution of C4 was shaken to be mixed and 1200 μl was added to the supernatant. The solution was vortexed for 5 s. 675 μl was loaded onto an MB Spin Column and centrifuged at 10,000 g for 1 min. Flow through was discarded. The last step was repeated twice. 500 μl of solution C5 was added. Centrifugation was done for 30 s at 10,000×g. Flow through was discarded. Centrifugation was done again for 1 min at 10,000×g. The MB Spin Column was spaced into a clean 2 ml collection tube. 50 μl of Solution C6 was added to the centre of the white filter membrane. Centrifugation was done at room temperature for 30 s at 10,000×g. The MB Spin Column was discarded. At this point the DNA was ready for downstream applications.

### Preparation of DNA for Sequencing:

After the DNA purification, further preparative steps were conducted before sequencing on the Illumina MiSeq system™. The procedure provided by the manufacturer Illumina was followed: (https://support.illumina.com/downloads/16s_metagenomic_sequencing_library_preparation.ht ml accessed Nov. 1, 2018, 16S Metagenomic Sequencing Library Preparation, Preparing 16S Ribosomal RNA Gene Amplicons for the Illumina MiSeq System, Part # 15044223 Rev. B.)

The 16S library preparation workflow was as follows: 1) 1st Stage of PCR, 2) PCR Clean-Up, 3) 2nd Stage PCR, 4) PCR Clean-Up 2, 5) Library Quantification and Normalization, and 6) Library Denaturing an MiSeq Sample Loading.

The purified DNA samples were prepared using the 16S PCR step described in the procedure. Primers were added to the solution and PCR was performed. The solution was subsequently indexed according to the Index PCR procedure using index primers. After index PCR the solutions were purified according to the PCR Clean-Up 2 procedure. The solution was subsequently purified by removing any free primers and primer dimer species in the PCR Clean-Up 2 step. The DNA library was quantified by using fluorometric quantification method using dsDNA binding dyes. The DNA concentrations were calculated based on analysis made with a Qibit 3.0™. The library was normalized and pooled. The pooled libraries were denatured and loaded onto a MiSeq system. After the loading of samples, the MiSeq system provided an on-instrument secondary analysis using 16S metagenomics database. As known in the art, the determination of a specific species may depend on the specific database applied and may in fact include more than one species or may refer to a species that can/will/may be classified differently in another database. However, regardless of the database applied and the possible specific species identification applied by various databases, for the present purpose, the distinction between lactic acid producing bacteria and non-lactic acid producing bacteria should be the same.

### Conclusions

FIG. 6 describes the % of lactic acid producing bacteria (comprising bacteria of the lactic acid bacteria order “LAB” where the currently accepted taxonomy is based on the List of Prokaryotic names with Standing in Nomenclature (LPSN)—an online database that maintains information on the naming and taxonomy of prokaryotes, following the taxonomy requirements and rulings of the International Code of Nomenclature of Bacteria. The phylogeny of the order is based on 16S rRNA-based LTP release 106 by ‘The All-Species Living Tree’ Project. The lactic acid producing bacteria referred to here also comprises bacteria that do not belong to the LAB order, but that are nevertheless capable of producing lactic acid) compared to all other bacterial species present in the samples at seven different timepoints in the experiment (termed S3, S6, S12, S16, S18, S20 and S22 and defined in Table 12).

1.75 hours after waste, de-ionized water and enzymes were added to the mini reactor (S3) 33% of the bacterial population in the reactor was comprised of lactic acid producing bacteria. While all other bacterial species made up the remaining 67%.

After 20.25 hours (S6), the amount of LAB had increased to 55% of the population while other bacterial species had decreased to 45%.

At 49.75 hours (S12) and 72.5 hours (S16) lactic acid producing bacteria dominated the population with 79% and 76%, respectively, compared to 21% and 24% of other bacterial species, respectively. After 72.5 hours (S16) reject water was added. At 91 hours (S18), the total amount of lactic acid producing bacteria had decreased to 51%, while other bacterial species had increased to 49%.

Interestingly, after 162.75 hours (S20) and 189.25 hours (S22), the presence of lactic acid producing bacteria had increased again to 77% and 65%, respectively. Other bacterial species had decreased to 23% and 35%, respectively.

Thus, even after the introduction of many other bacterial species and higher pH via reject water and a decrease in lactic acid producing bacteria population size after 91 hours, lactic acid producing bacteria were surprisingly still able to regain the lead in terms of population size within the bioreactor compared to other bacterial species. Even after significant change of the environment in the bioreactor lactic acid producing bacteria were surprisingly still the main bacterial contributor.

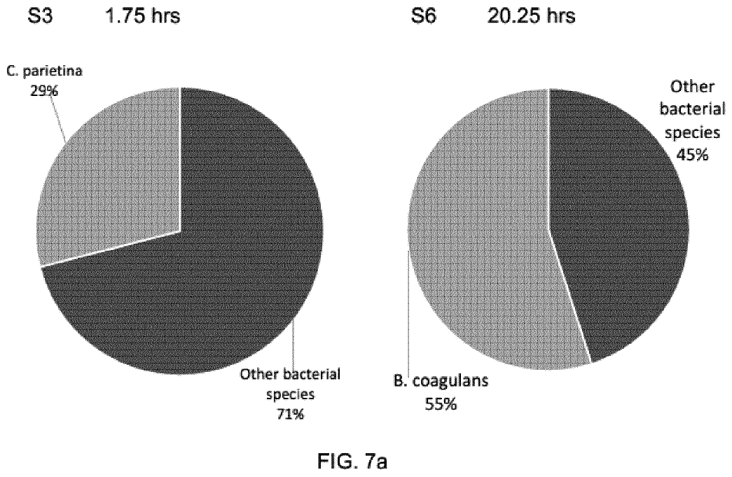

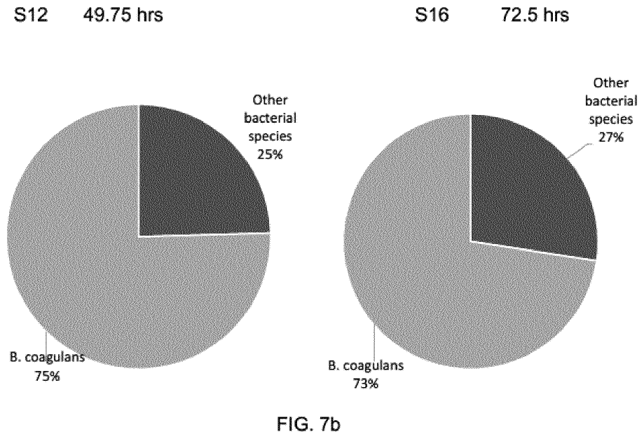

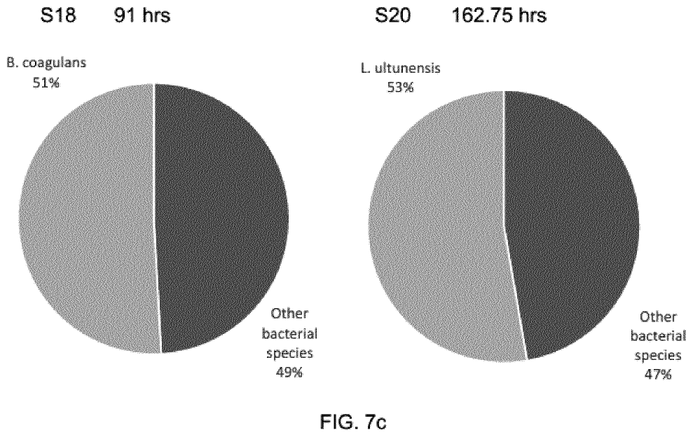

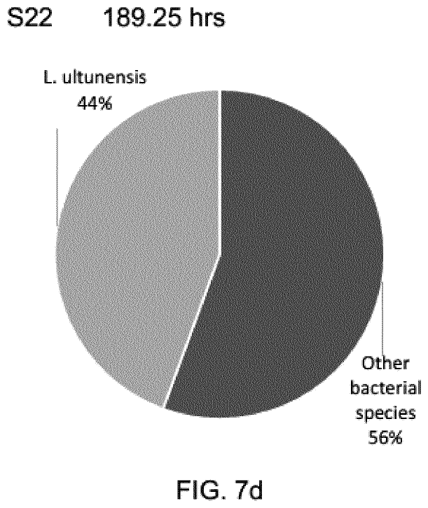

FIGS. 7a-7d describe the bacterial species that dominate the population compared to all other bacteria present in the samples at seven different timepoints in the experiment (termed S3, S6, S12, S16, S18, S20 and S22 and defined in Table 12). FIGS. 7a to g are described below.

7a) 1.75 hours after waste, de-ionized water and enzymes were added to the mini reactor (S3), Calothrix parietina dominated the bacterial population with 29% compared to all other bacterial species (71%).

After 20.25 hours (S6), the bacterial population was dominated by Bacillus coagulans with 55% compared to 45% or other bacterial species. Note that this was equal to the entire amount of lactic acid producing bacteria (FIG. 6) in this sample. B. coagulans is a well-known producer of lactic acid bacteria (T. Michelson et al., 2006, Enzyme and Microbial Technology).

7b) At 49.75 hours (S12) the population of B. coagulans had increased to 75% compared to 25% of other bacterial species. Note again that B. coagulans represented almost the entire lactic acid producing bacteria population (FIG. 6)

At 72.5 hours (S16) the population of B. coagulans was stable at 73% again representing the vast majority of the entire lactic acid producing bacteria population. Reject water was added after this sample.

7c) Reject water was added at 91 hours (S18). The population of B. coagulans decreased to 51% making up the majority of the entire lactic acid producing bacteria population. This shows that, B. coagulans was struggling with the addition of reject water.

Indeed, after 162.75 hours (S20) the bacterial population was dominated by Lactobacillus ultunensis with 53% Note that, apart from L. ultunensis the LAB comprised further 24% of other lactic acid producing bacteria species, suggesting that other LAB species than L. ultunensis can thrive in the bioreactor environment after addition of reject water.

7d) After 189.25 hours (S22), L. ultunensis was still the dominating species at 44%.

It is highly surprising that lactic acid producing bacteria can survive an environment comprising reject water. Surprisingly the bacterial population changed from one dominant lactic acid producing bacteria species to another as a consequence of the change of the bioreactor environment caused by the addition of reject water.

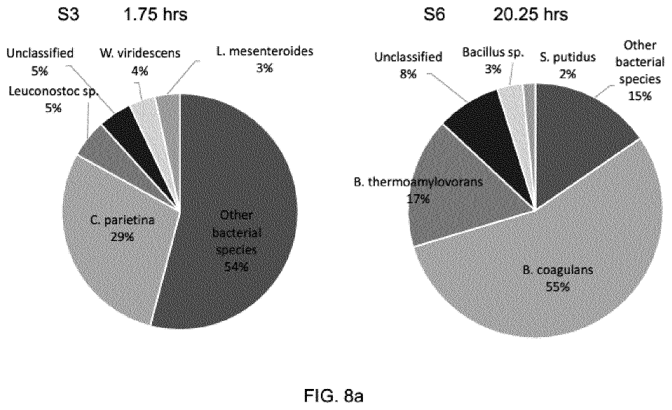

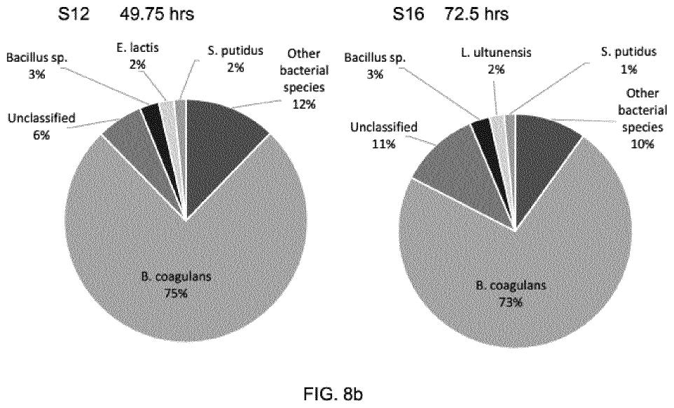

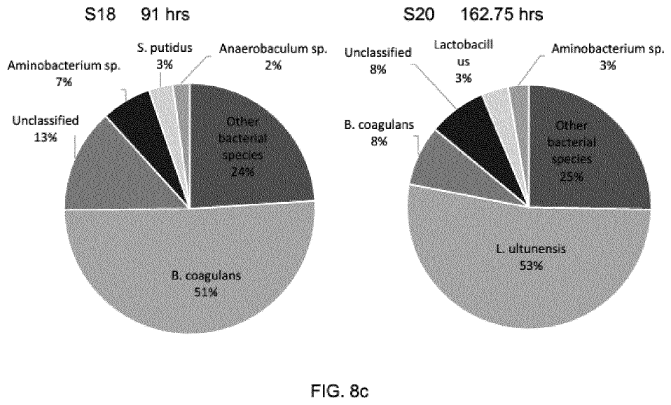

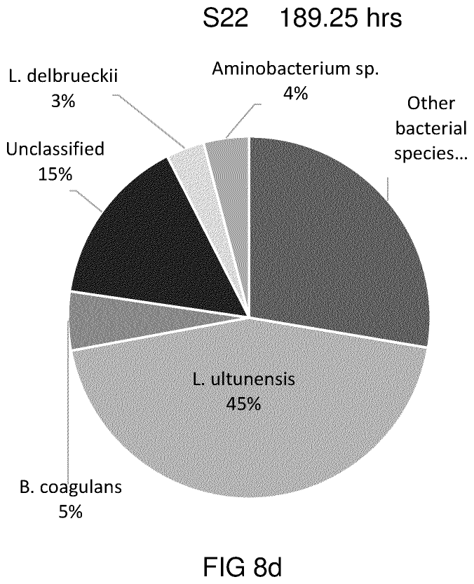

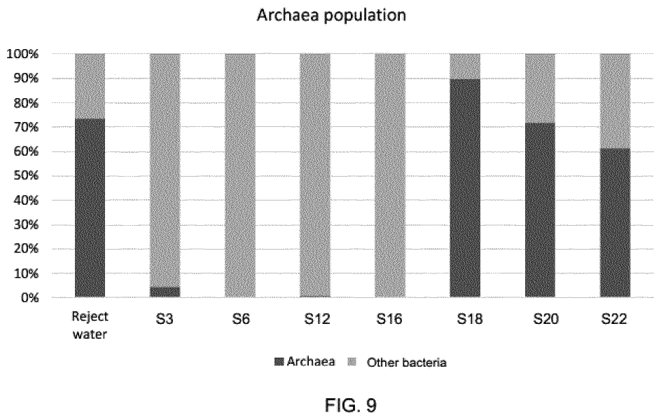

FIGS. 8a to 8d describe the five most dominating species in the population compared to all other bacterial species present in the samples at the same seven timepoints in the experiment (termed S3, S6, S12, S16, S18, S20 and S22 as defined in Table 12). “Unclassified” denotes a bacterial species the methodology is unable to classify, possibly a novel species not present in any database. FIGS. 8a to 8d are described below.

8a) 1.75 hours after waste, de-ionized water and enzymes were added to the mini reactor (S3), Calothrix parietina dominated the bacterial population with 29%, followed by 5% of Leuconostoc sp. and 5% unclassified bacteria. Weissella viridescens and Leuconostoc mesenteriodes were present at 4% and 3% respectively. Other bacterial species comprised 54% of the total bacteria. Leuconostoc sp., W. viridescens and L. mesenteriodes are all lactic acid producing bacteria. None of these remained as a dominant species of the population over time (see below).

After 20.25 hours (S6), the bacterial population was dominated by B. coagulans with 55% and Bacillus thermoamylovorans at 17%. Unclassified bacteria, Bacillus sp. and Sporolactobacillus putidus were present in the amount of 8%, 3% and 2%, respectively. Other bacterial species comprised 15% of the total bacteria. There was a clear bacterial population shifts compared to FIG. 7a. All top species had changed i.e. bacteria able to survive in the bioreactor environment increased in population size. The bioreactor population was dominated by lactic acid producing bacteria. Note that S. putidus is a lactic acid producing bacteria.

8b) At 49.75 hours (S12) the population of B. coagulans had increased to 75%. This was followed by “Unclassified bacteria” (6%), Bacillus sp. (3%), S. putidus and Enterococcus lactis (2%) and other bacterial species at 12%. Note that several of the top species from FIG. 8a are still present showing that the population is stabilizing. Note that E. lactis is a lactic acid producing bacteria.

At 72.5 hours (S16) the population of B. coagulans was stable at 73% again representing the vast majority of the entire lactic acid producing bacteria population. This was followed by “Unclassified bacteria” (11%), Bacillus sp. (3%), Lactobacillus ultunensis (2%), S. putidus (1%) and other bacterial species at 11%. Note that L. ultenensis is an lactic acid producing bacteria. This showed that the bioreactor population was stable. Reject water was added after this sample.

8c) At 91 hours (S18) the population of B. coagulans decreased to 51%. The stable conditions were interrupted by the reject water and this affected the bacterial population significantly. “Unclassified bacteria” (13%), Aminobacterium sp. (7%), S. putidus (3%), Anaerobaculum sp. (2%) and other bacterial species at 24% were also present. Except for B. coagulans and “Unclassified bacteria” the other dominant species changed compared to FIG. 8b due to the changing environment in the bioreactor. Other bacterial species increased from 10% to 24% suggesting a shift in the entire population.

Indeed, after 162.75 hours (S20) the entire bacterial population was dominated by another lactic acid producing bacteria species, Lactobacillus ultunensis with 53% B. coagulans had decreased to 8%, again suggesting that the new environment in the bioreactor was not favoring this species. “Unclassified bacteria” (8%), Lactobacillus sp. (3%), Aminobacterium sp. (3%), and other bacterial species at 25% were also present. The entire population made a shift towards becoming stable again with new dominating species.

8d) After 189.25 hours (S22), L. ultunensis was still the dominating species at 45% followed by “Unclassified” bacteria (15%), B. coagulans (5%), Aminobacterium sp. (4%), Lactobacillus delbrueckii (3%) and other bacterial species at 28%. Note that L. delbrueckii is a lactic acid producing bacteria.

It is highly surprising that lactic acid producing bacteria can survive an environment comprising reject water. Surprisingly the bacteria population changed from one dominating LAB species to another as a consequence of the change of the bioreactor environment caused by the addition of reject water.

### Example 8: Comparison of Anaerobic Digestion of Open and Closed Loop Bioliquid

As mentioned in the introductory section to the Examples, the AD-effluent obtained from anaerobic digestion was obtained using bioliquid produced from Municipal Solid Waste in the Renescience demonstration scale at the Amager Resource Center, Denmark. This Renescience demonstration plant did not comprise bioliquid utilization means and water make-up units and is accordingly a plant wherein no recirculation of water is applied. For the purposes of this example, this is termed an “open loop” plant. Consequently, the resulting concentrations of salts and ammonia in the bioliquid obtained in this demonstration plant (which may be mentioned as “Renescience bioliquid” for the purpose of this example, being said term not limited to the scope of the present example) and further used for anaerobic digestion were lower than those expected in bioliquid obtained from a plant wherein water other than tap water is added to the bioreactor. A “closed-loop” plant is accordingly a waste treating plant wherein the combined enzymatic and microbial treatment of waste comprises recirculation of water.

Both modelling and experimental results within the field of anaerobic digestion show that the conversion rates and biomethane yields are negatively affected by sodium concentration (Hierholtzer, A et al 2012; Modelling sodium inhibition on the anaerobic digestion process; Water Science and Technology; 1565-1573). In Fact, the cited study shows that there can be perceived inhibitory effects on anaerobic digestion already after addition of 0.083 mol/L (1.91 g/L) of sodium. In analogous manner, the increase of ammonia concentrations usually results in a loss of the methanogenic activity, as well as decrease in the biomass growth (Chen, Y et al .2008; Inhibition of anaerobic digestion process: a review. Bioresource Technology, 99(10), 4044-64).

Since the soluble salt and ammonia concentrations have great potential to negatively affect the convertibility of the substrates within anaerobic digestion, experiments were performed to compare the anaerobic digestion of bioliquid with different concentrations of sodium, ammonia and calcium.

### Experimental Description:

In this study, conventional continuous stirred tank reactors (CSTR) for biogas production were operated with Renescience bioliquid and with Renescience bioliquid supplemented with sodium, calcium, chlorine, and ammonia; respectively, to compare AD from open-loop bioliquid with AD of closed-loop bioliquid in agreement with predicted mass balance wherein the water is re-circulated. Continuous tests were performed for at least 4 full retentions at a hydraulic retention time (HRT) of 20 days, which can be the nominal flow rate expected for operation of full-scale anaerobic digesters treating the bioliquid downstream of a process according to step a) of the present invention.

### Materials:

1. The initial seed (inoculum) for the anaerobic digestion was from Foulum Biogas, a plant in Denmark for converting manure and fibre rich residues from agricultural straw into biogas by anaerobic digestion.

2. Renescience bioliquid obtained from combined enzymatic and microbial treatment of Dutch Municipal Solid Waste from 2016, produced in a demonstration facility in Amager, Denmark. The bioliquid was screened through a 2 mm screen mesh to reduce clogging in the lab scale CSTRSs.

3. Two 10 litre biogas reactors: a CSTR to treat Renescience bioliquid with enhanced salts and ammonia concentration (closed loop) and the second with Renescience bioliquid comprising lower concentration of salts and ammonia (open loop) as positive control.

4. Tedlar® gas sampling bags US atmospheric gas methods and GC quantification of methane production.

5. Gas Flow measuring device. Bioprocess Control, Sweden.

### Methods:

The experiment was conducted through continuous feeding of the two 10 litre CSTR reactors which were previously seeded with inoculum and spiked for a week with bioliquid to maintain active microorganisms. The agitation of the active volume content was achieved through active recirculation through a peristaltic pump. The process of the rectors was held in the mesophilic temperature range at 38° C. achieved with heating jacket in each reactor. Samples were taken periodically inside the reactor through a sampling port.

The closed-Loop CSTR digester was used to convert bioliquid supplemented with sodium chloride, calcium bicarbonate and ammonia to resemble the expected concentration of the high salts AD feed from the mass balance calculations. The substrate was also screened through a 2 mm kitchen mesh sieve to remove larger particles and reduce the risk of clogging of the recirculation of the lab-scale pumps. Characterization of the substrate was based on the following expected salt and ammonia concentrations being in accordance with the NREL (National Renewable Energy Laboratory, US) guidelines.

The salt and ammonia concentrations were adjusted to meet the expected salt and ammonia concentrations of a bioliquid substrate from a closed-loop system:

Na: 2.3 g/l ; Cl: 2.3 g/L ; TAN (Total Ammonia Nitrogen): 2.5 g/L ; Ca: 5.1 g/L.

The ramp up for all the reactors started at 50 days HRT and the feed rate was increased until achieving 20 days HRT in a period of 5 days. When the target HRT was achieved, the reactors were operated for at least 6 total retention times. Operation of the reactors for different entire retentions ensures that the digesting media of the biomethane reactors have been replaced completely. After having started the second retention of the experiment, corresponding with day 25 of operation, the collected effluent was stored as representative effluent of the process to quantify the salt and ammonia concentrations of the reactor. The obtained yields in the reactor fed with bioliquid resembling “closed loop” bioliquid were compared to the yields obtained in the control reactor fed with bioliquid resembling “open loop” bioliquid, i.e. bioliquid without the addition of salts and ammonia.

Biogas produced during the anaerobic digestion process was quantitatively monitored by a gas flow device obtained from Bioprocess Control AB (Lund, Sweden). Gas composition was determined via gas chromatography, (model GC82 Mikrolab Aarhus A/S, Denmark. Chemical oxygen demand (COD) and volatile fatty acids (VFAs) in the digestate were quantified with Hach LCK514 COD and LCK365 Organic Acid cuvette test using a DR 3900 spectrophotometer (Hach, Düsseldorf, Germany).

### Results:

A continuous biogas test was performed to estimate the biogas yield of the Renescience bioliquid with increased salt and ammonia concentrations to simulate a full-scale Renescience AD process comprising a closed loop. As control, the Renescience bioliquid was produced in the open loop demo scale Renescience pilot plant in Amager, without salt addition was also tried out at the same process conditions (“Digester A”).

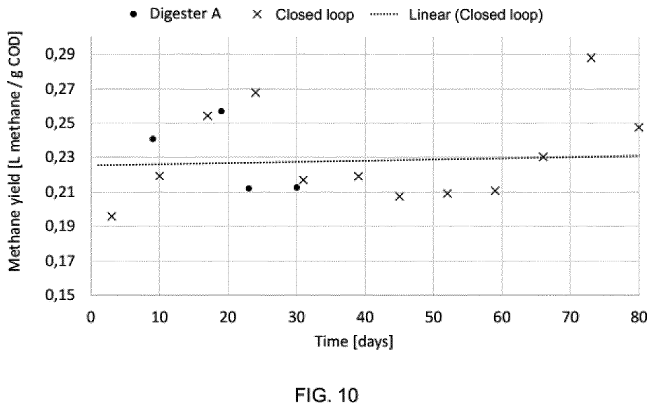

The production of methane from the CSTR reactors during the four retention times of 20 HRT is shown in FIG. 10. The data shows that it was possible to produce methane using the concentrated closed-loop bioliquid as substrate for anaerobic digestion. The trend of the methane production during 20 days HRT indicated that the process remained stable during the whole operation of the reactor. This experiment shows that increased concentration of Na, Cl, Ca and ammonia corresponding to the expected salt and ammonia concentrations in bioliquid obtained from a closed-loop plant surprisingly did not have a detrimental effect of the anaerobic digestion of the Renescience bioliquid at the studied conditions.

### Example 9: Fermentation of MSW Model Substrate in a Fermenter at pH Above 6

Ammonium bicarbonate and ammonia solution used in the experiment were obtained from Sigma Aldrich.

A 1-L Sartorius fermenter was filled with MSW model substrate (166 g) and tap water (900 mL). NH₄HCO₃ (13 g) and ammonia (aqueous, 25%, 2 mL) were dissolved in tap water (100 mL) and the solution was added into the fermenter. The mixture was brought to 50° C.under constant stirring (500 rpm). After the mixture had reached 50° C., an enzyme composition having similar enzymatic activities to Cellic®CTec3 purchased from Novozymes A/S (4 g) was added into the fermenter and the fermentation was conducted at 50° C. under constant stirring (500 rpm).

TABLE 13
Concentration (in g/L) of selected compounds formed during the fermentation of
MSW model substrate in a fermenter with the addition of NH₄HCO₃ and ammonia

| Time (h) | Glucose | Xylose | Lactate | Acetate | Propionate | Butyrate | Formate | pH |
|---|---|---|---|---|---|---|---|---|
| 1.5 | 0.69 | 0.00 | 1.28 | 0.53 | 0.00 | 0.00 | 0.00 | 7.80 |
| 3.4 | 0.77 | 0.00 | 1.31 | 0.59 | 0.00 | 0.00 | 0.00 | 7.88 |
| 5.2 | 0.81 | 0.00 | 1.30 | 0.58 | 0.00 | 0.00 | 0.00 | 7.95 |
| 22.0 | 0.18 | 0.00 | 2.75 | 0.86 | 0.00 | 0.00 | 0.29 | 7.94 |
| 24.1 | 0.19 | 0.00 | 3.11 | 0.97 | 0.00 | 0.00 | 0.45 | 7.90 |
| 29.2 | 0.14 | 0.13 | 3.56 | 1.16 | 0.00 | 0.00 | 0.75 | 7.68 |
| 45.2 | 0.12 | 0.62 | 5.78 | 2.29 | 0.00 | 0.09 | 2.48 | 6.98 |
| 51.7 | 0.00 | 0.88 | 5.77 | 2.49 | 0.00 | 0.19 | 2.81 | 6.57 |
| 68.2 | 0.00 | 1.07 | 5.60 | 3.23 | 0.10 | 0.80 | 3.34 | 6.15 |
| 75.7 | 0.00 | 0.94 | 4.82 | 3.17 | 0.00 | 1.48 | 3.38 | 6.17 |
| 92.2 | 0.00 | 0.16 | 1.57 | 2.60 | 0.00 | 4.35 | 3.50 | 6.45 |
| 100.2 | 0.00 | 0.00 | 0.23 | 2.53 | 0.11 | 5.68 | 3.55 | 6.66 |
| 165.4 | 0.00 | 0.00 | 0.00 | 3.99 | 0.24 | 6.03 | 3.29 | 6.46 |
| 171.2 | 0.00 | 0.00 | 0.00 | 3.93 | 0.20 | 5.82 | 3.26 | 6.49 |
| 189.4 | 0.00 | 0.00 | 0.00 | 4.35 | 0.27 | 5.86 | 2.94 | 6.49 |

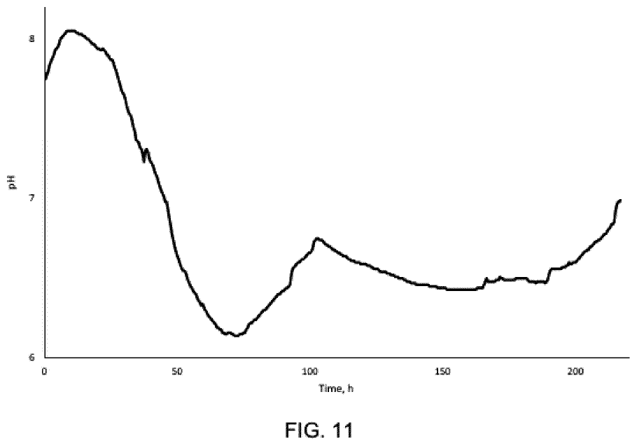

Conclusion. As can be seen from FIG. 11 and Table 13, pH during the experiment was always above 6 which led to the disappearance of lactic acid and to the production of some other organic acids (formic, propionic and butyric). These newly formed acids are undesirable in the bioliquid because they might create difficulties for the AD process. Thus, this experiment demonstrated that the pH of the fermentations should not be above pH 6.

### Example 10: Fermentation of MSW Model Substrate in a Fermenter at Constant pH 3.5

HCl (aqueous, 4 M) used in the experiment were obtained from Sigma Aldrich.

A 1-L Sartorius fermenter was filled with MSW model substrate (166 g) and distilled water (1 L). pH of the mixture was adjusted to 3.5 with a 4 M aqueous solution of HCl. The mixture was brought to 50° C. under constant stirring (600 rpm). After the mixture had reached 50° C., an enzyme composition having similar enzymatic activities to Cellic®CTec3 purchased from Novozymes A/S (4 g) was added into the fermenter and the fermentation was conducted at 50° C. under constant stirring (600 rpm) at constant pH of 3.5 (which was maintained automatically by the fermenter by adding a 4 M aqueous solution of HCl).

TABLE 14
Concentration (in g/L) of selected compounds formed during the
fermentation of MSW model substrate at constant pH of 3.5

| Time (h) | Glucose | Xylose | Lactate | Acetate | Propionate | Butyrate | Formate | pH |
|---|---|---|---|---|---|---|---|---|
| 0 | 1.52 | 0.00 | 0.18 | 0.23 | 0.00 | 0.00 | 0.00 | 3.50 |
| 1.8 | 8.86 | 2.06 | 0.21 | 0.25 | 0.00 | 0.00 | 0.00 | 3.50 |
| 20.8 | 15.74 | 3.50 | 0.28 | 0.27 | 0.00 | 0.00 | 0.00 | 3.50 |
| 45.6 | 17.77 | 3.68 | 0.33 | 0.22 | 0.00 | 0.00 | 0.00 | 3.50 |
| 139.6 | 20.35 | 3.49 | 0.37 | 0.27 | 0.00 | 0.00 | 0.00 | 3.50 |

Conclusion. The experiment showed that at pH 3.5 there was almost no lactate, acetate and other carboxylates produced that is an indication the preferred bacterial activity is still present at pH 3.5 but is reduced compared to the bacterial activity at a pH between 3.5 and 6.

### Example 11: Fermentation of MSW Model Substrate in a Rotating Horizontal Reactor with Addition of Reject Water and Glucose

TABLE 15
Composition of MSW model substrate used in the experiment

| Component | Weight (kg) |
|---|---|
| Rye bread | 0.8 |
| Apples | 0.6 |
| Potatoes | 2.8 |
| Spread cheese | 0.2 |
| Meat sausages | 1.6 |
| Newspapers | 1.8 |
| Magazines | 0.6 |
| Juice cartons | 1.6 |
| Saw dust | 0.8 |
| Viscose clothes | 1.2 |
| Plastic bag (LDPE) | 3.2 |
| Hard plastic | 4.8 |

The components were passed three times through a shredder (Frandsen Industri findeler type 5500) and the resulting mixture was passed once through a pulveriser (Retsch sm300 with a 6-disc rotor). Dry matter of the thus obtained MSW model substrate was 77%.

MSW model substrate (1 kg, Table X), tap water (3 L) and a solution of an enzyme composition having similar enzymatic activities to Cellic®CTec3 purchased from Novozymes A/S (23 g) in tap water (1 L) were added into a stainless-steel rotating horizontal reactor (total volume 63 L, length 2 m). The mixture was mixed at 50° C. under constant rotation (4 rpm). 24 h after the beginning of the experiment, reject water (4 L), MSW model substrate (1.2 kg) and an enzyme composition having similar enzymatic activities to Cellic®CTec3 purchased from Novozymes A/S (24 g) were added. 47 h after the beginning of the experiment, an enzyme composition having similar enzymatic activities to Cellic®CTec3 purchased from Novozymes A/S (20 g) was added. 49 h after the beginning of the experiment, MSW model substrate (1 kg), tap water (2 kg), reject water (1 kg) and an enzyme composition having similar enzymatic activities to Cellic®CTec3 purchased from Novozymes A/S (20 g) were added. 117 h after the beginning of the experiment, 5 kg of the reactor content were removed through the outfeeder. 121 h after the beginning of the experiment, glucose (200 g) was added into the reactor.

The progress of the fermentation was monitored by pH measurements and HPLC analysis to determine the concentration of sugars, organic acids and ethanol in the samples taken from the outfeeder at the time-points shown in Table 16.

TABLE 16
Concentration (in g per kg of dry matter) of selected compounds formed
during the fermentation of MSW model substrate with addition of reject
water and glucose in rotating horizontal reactor at 50° C.

| Sample | Time | | | | | | | | |
|---|---|---|---|---|---|---|---|---|---|
| ID | (h) | Glucose | Xylose | Lactate | Acetate | Butyrate | Formate | Ethanol | pH |
| S1 | 18.50 | 0.16 | 2.66 | 13.43 | 6.26 | 0.19 | 0.00 | 0.32 | 4.88 |
| S2 | 22.58 | 0.07 | 2.44 | 10.71 | 8.41 | 0.25 | 0.00 | 0.38 | 4.96 |
| S3* | 25.50 | 3.87 | 2.48 | 9.72 | 6.88 | 0.18 | 0.00 | 0.23 | 7.84 |
| S4 | 27.50 | 0.16 | 1.87 | 14.38 | 7.92 | 0.21 | 1.14 | 0.16 | 7.67 |
| S5 | 42.50 | 0.06 | 0.05 | 0.00 | 15.63 | 13.06 | 4.41 | 1.94 | 6.93 |
| S6 | 44.75 | 0.00 | 0.06 | 0.00 | 17.32 | 13.31 | 4.15 | 1.82 | 6.90 |
| S7** | 49.25 | 0.11 | 0.08 | 0.45 | 19.48 | 13.10 | 3.76 | 1.37 | 6.82 |
| S8 | 51.00 | 1.70 | 0.72 | 3.18 | 16.62 | 9.53 | 2.89 | 0.98 | 6.81 |
| S9 | 114.50 | 0.12 | 0.10 | 0.63 | 13.31 | 30.51 | 4.55 | 5.03 | 5.26 |
| S10*** | 122.25 | 61.15 | 0.00 | 0.55 | 14.60 | 31.40 | 3.75 | 4.74 | 5.25 |
| S11 | 123.00 | 52.31 | 0.00 | 0.64 | 13.56 | 28.24 | 3.37 | 4.33 | 5.25 |
| S12 | 138.50 | 36.64 | 0.38 | 10.82 | 19.05 | 26.71 | 2.83 | 2.90 | 5.00 |
| S13 | 145.50 | 29.09 | 0.36 | 17.62 | 20.46 | 26.91 | 3.00 | 2.87 | 4.85 |
| S14 | 163.58 | 23.36 | 0.40 | 28.22 | 22.66 | 29.08 | 3.16 | 3.33 | 4.64 |
| S15 | 194.00 | 22.83 | 1.92 | 30.84 | 23.65 | 29.27 | 4.60 | 3.45 | 4.88 |

*after 24 h, reject water (4 L), MSW model substrate (1.2 kg) and an enzyme composition having similar enzymatic activities to Cellic ®CTec3 purchased from Novozymes A/S (24 g) were added,
**after 47 h, an enzyme composition having similar enzymatic activities to Cellic ®CTec3 purchased from Novozymes A/S(20 g) were added. After 49 h, MSW model substrate (1 kg), tap water (2 kg), reject water (1 kg) and an enzyme composition having similar enzymatic activities to Cellic ®CTec3 purchased from Novozymes A/S (20 g) were added,
***after 117 h, 5 kg of the reactor content were removed from the outfeeder. After 121 h, glucose (200 g) was added.

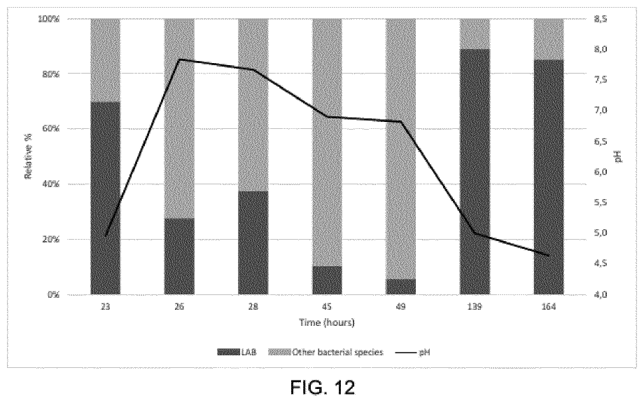

Also, the population of LAB relative to the presence of other bacterial species was measured as described in Example 7. As is shown in FIG. 12, the percentage of LAB relative to other bacterial species dropped severely, when pH was increased. At 26 hours, where pH had increased to approximately 7.84, the presence of LAB was reduced and remained low until after 49 hours where the pH was still close to pH 7. At 139 hours, where the pH had dropped to around pH 5, the percentage of LAB had increased to approximately 90% relative to other bacterial species.

### Conclusions:

The fermentation proceeded successfully with MSW model substrate that is different from the MSW model substrate used in the other examples. It is also shown that when the process operates at pH>6 for the prolonged amount of time, butyric acid is produced which is undesired for the AD process. Moreover, a shift in pH to above 6 changes the composition of the microflora wherein the relative % of the bacterial population producing valuable solubles for energy production is significantly reduced.

1. A method for continuous or batch processing of waste comprising:
a) subjecting waste to an enzymatic and/or microbial treatment in a bioreactor
b) subjecting the treated waste from step a) to one or more separation step(s), whereby a bioliquid and a solid fraction is provided;
c) subjecting said bioliquid and/or solid fraction to downstream processing providing process water;
d) adding the process water obtained from step c) and optionally water from an external water source to the bioreactor in step a), wherein the process water is added continuously or in batches, such that pH in the reactor is between pH 3.5-6 or wherein pH is adjusted to between 3.5 and 6 prior to adding the process water to the bioreactor in step a).

2. Method according to claim 1, wherein the downstream processing in step c) providing said process water is selected from one or more of an anaerobic digestion process, washing of a solid waste fraction, evapouration and collection of bioliquid.

3. Method according to the previous claims, wherein the downstream processing in step c) is an anaerobic digestion process providing reject water.

4. Method according to claim 3, wherein the pH of the reject water is adjusted to between 3.5 and 6 by addition of acid and/or by reducing the ammonium content.

5. Method according to claim 3 or 4, wherein the reject water obtained from said anaerobic digestion process is subject to hygienization before being subjected to step d).

6. Method according to the previous claims, wherein the external water in step d) is selected from water obtained from natural sources such as rivers, lakes and ponds; water reservoirs; tap water, and any combination thereof.

7. Method according to the previous claims, wherein the filling volume of the bioreactor in step a) is larger than 10, 50, 100, 150, 200, 250, 300, 350, 400, 450 or 500 m³ during operation and wherein it is adapted to process more than 5, 10, 15, 20, 25, 30, 35, 40, 45 or 50 tons of waste per hour.

8. Method according to previous claims wherein said waste is unsorted municipal solid waste, centrally sorted municipal solid waste, source sorted municipal solid waste from households, municipal solid waste processed by shredding or pulping, organic fractions and paper rich fractions, Refuse-Derived-Fuel fractions or municipal solid waste wherein the biodegradable material in said waste comprises a combination of one or more items selected from: food residues, paper, cardboard or fines.

9. Method according to the previous claims wherein said enzymatic treatment in step a) is performed by adding enzymes, supplied in either native form or in form of microbial organisms giving rise to the expression of such enzymes, or manipulated yeast, bacteria, or any other microorganism capable of producing the enzymes.

10. Method according to the previous claims wherein said microbial treatment is performed by adding microorganisms such as bacteria capable of producing e.g. biochemicals, ethanol, or biogas and/or by the microorganisms e.g. bacteria present in the waste.

11. Method according to the previous claims wherein the treatment in step a) comprises contacting the waste with a live lactic acid bacteria concentration of at least 1.0×10⁶, 1.0×10⁷, 1.0×10⁸ or 1.0×10⁹ CFU/L.

12. Method according to the previous claims, wherein the treatment in step a) comprises adding microorganisms to the waste at a concentration of 1.0×10⁶, 1.0×10⁷, 1.0×10⁸, 1.0×10⁹ or 1.0×10¹⁰ CFU/L.

13. Method according to the previous claims wherein treatment step a) is performed at a temperature between 20 and 75° C., 30° C. and 70° C., 40° C.and 60° C., 45 and 55° C., or around 50° C.

14. Method according to the previous claims wherein the flow rate of the addition of process water and optionally water from an external source in step d) into the bioreactor in step a) is essentially constant and/or essentially proportional, to the amount of waste, having between 1:1 and 3:1 of water:waste proportion.
